(19) United States
(12) Patent Application Publication
(10) Pub. No.: US 2013/0124265 A1
(43) Pub. Date: May 16, 2013

(54) Enterprise System/Process Modeling System and Method

(71) Applicants: Robert C. Whitehair, Beverly, MA (US); Igor A. Budiachevskii, Samara (RU); Francis S. McAdoo, Hamilton, MA (US); Alexander I. Zhezherun, Samara (RU); Eric M. Kelso, Wilsonville, OR (US); Joseph J. Buley, Lake Oswego, OR (US); Daniel E. Neiman, Rowley, MA (US); George J. Paganis, Ipswich, MA (US)

(72) Inventors: Robert C. Whitehair, Beverly, MA (US); Igor A. Budiachevskii, Samara (RU); Francis S. McAdoo, Hamilton, MA (US); Alexander I. Zhezherun, Samara (RU); Eric M. Kelso, Wilsonville, OR (US); Joseph J. Buley, Lake Oswego, OR (US); Daniel E. Neiman, Rowley, MA (US); George J. Paganis, Ipswich, MA (US)

(73) Assignee: River Logic, Inc.

(21) Appl. No.: 13/428,363

(22) Filed: Mar. 23, 2012

Related U.S. Application Data
(60) Provisional application No. 61/559,976, filed on Nov. 15, 2011.

(51) Int. Cl. G06Q 10/06

(52) U.S. Cl. 705/7.36

(57) ABSTRACT

An enterprise system/process modeling (ESPO) system and method that permits efficient representation of enterprise systems/processes (ESP) and calculation of global solutions to models associated with these ESPs is disclosed. The system/method incorporates an enterprise system/process modeling definition subsystem (ESPD) in which an interconnected processes, resources, constraints, and objectives may be defined to describe a global enterprise system/process model (ESPO). This ESPO describes the enterprise to be modeled and the various boundaries within which enterprise modeling is to take place. This ESPO is translated and transformed into an intermediate indexed format by an enterprise global modeling subsystem (EGMS) for use in generating the coefficients of an equation matrix. The equation matrix is solved for a solution state space conforming to desired enterprise objectives and the results are presented for review by an enterprise model reporting subsystem (FSPR).

### CROSS REFERENCE TO RELATED APPLICATIONS

Applicants claim benefit pursuant to 35 U.S.C. §119 and hereby incorporates by reference Provisional Patent Application for “ENTERPRISE SYSTEM/PROCESS OPTIMIZATION SYSTEM AND METHOD”, Ser. No. 61/559,976, docket ARIVE.0101, filed electronically with the USPTO on Nov. 15, 2011 with EFS ID 11412375, confirmation number 9907.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to systems and methods for modeling and/or optimizing systems and/or processes over large enterprises, and specifically systems/methods that are tailored to model and/or optimize complex business and/or manufacturing systems and/or processes.

### PRIOR ART AND BACKGROUND OF THE INVENTION

### Overview

A common issue regarding the operation of large enterprises is the difficulty in analyzing the systems/processes associated with the enterprise because of the following:
The systems/processes generally have a large number of resources that must be properly managed to optimize overall enterprise performance;
The system/process resources incorporate constraints that limit the flexibility of operation to a finite (but often very large) set of possibilities that are generally not computationally tractable (or in some cases even understandable) by application of raw human effort;
System/process resources and/or constraints are often configured in an interconnected network in which constraints between and within the resources are related in a large number of dependencies that are often difficult to extract and transform into a mathematical representation that correctly expresses the interacting constraints among the various system/process components;
The methods currently used to transform the representation of the enterprise system/process into a mathematical representation are known to be computationally intractable for many types of constraint relationships that commonly exist in real-world enterprise systems/processes. For example, it is known that transformation processes that can formally be categorized as “context-sensitive” are members of a class of processes that are known to be computationally intractable. Real-world enterprise systems/processes include numerous forms of constraint relationships that are context-sensitive;
The mathematical representations required for enterprise system/process optimization are difficult and counter-intuitive to formulate properly. For example, the mathematical expression of many pervasive, real-world constraint relationships require mathematical ratios. Conventional digital computers, and the optimization solvers that run on them, provide no support for such mathematical expressions and are limited to mathematical expressions involving strictly linear terms (i.e., “+”, “−”, and “*”). Properly formulating mathematical expressions of real-world constraint relationships that require mathematical ratios using only linear terms requires extensive experience and knowledge;
Modeling and/or optimizing enterprise systems/processes requires extensive domain knowledge of numerous financial topics such as a “Chart of Accounts” that includes a Net Income Statement, a Balance Sheet, and a Cash Flow Statement. The domain knowledge is required in order to understand common real-world constraints and properly transform them into correct mathematical expressions. For example, in the context of a Balance Sheet, many common, real-world constraints are expressed in terms of the “flow” into or out of Balance Sheet accounts. The mathematical expression of such constraints is counter-intuitive and computationally difficult;
Solutions to resulting equation matrices formulated from various resources and their related constraints may be computationally intractable due to the large number of variables and parameters that must be evaluated to achieve an optimal global enterprise solution;
Use of conventional contribution margin/marginal value goal-seeking objectives in traditional enterprise optimization systems may fail in many cases to properly achieve a globally optimal enterprise solution;

As a result of these difficulties, conventional computer-based enterprise modeling and optimization techniques are based on problem simplification methods. Numerous problem simplification methods are in use but all of them share a common characteristic—the analytical results they produce are incorrect in the sense that they do not identify the decisions that will optimize the financial performance of the enterprise system/process. In many instances, problem simplification methods produce analytical results that, while purporting to indicate decisions that will optimize financial performance, actually have consequences that are exactly opposite of the desired result.

In addition, conventional enterprise modeling and optimization techniques have utilized database schemas tied to specific database constructions created with information from system/process flows within an enterprise environment.

This technique generally requires database construction (and associated analysis tools) to be directly tied to the format of the database. This integration of database view along with the large amount of data associated with enterprise optimization generally limits the scope or view from which an optimization of an enterprise may be attempted. At a minimum, integration of the analysis tools with the enterprise information data storage makes reformulation of enterprise system/process models very difficult, as it generally requires restructuring of the information database in order to achieve new analysis views on the data.

These two problems—problem oversimplification and solution inflexibility—are well-known in industry and are widely considered to be the primary obstacles to widespread adoption of effective solutions supporting enterprise system/process modeling and optimization. Many attempts have been made to address one or both problems but, to this point, these efforts have failed.

For example, efforts to “delink” the enterprise information database from the optimization process have suffered in that attempts to linearly “chain” resources with inter-link constraints, while simplifying the creation of equation matrices for large order matrix solution, have resulted in an oversimplification of the inter-resource constraints that are a reality in any large enterprise system/process. Simply stated, serial dependency constraints on resources within a large enterprise system/process are insufficient to fully describe the system/process because there are inter-resource dependencies that are not sequential, and possibly not even linear, or spatially/temporally static in nature. Thus, while sequentially linked resources and their associated constraint vectors may make for relatively easy generation and evaluation of resulting equation matrices to achieve solution state spaces, this approach suffers from the inherent deficiency that the serial chained-constraint model is structurally flawed and does not represent the real-world enterprise system/process environment.

However, it should be noted that incorporation of all inter-resource constraint vectors within the framework of existing enterprise system/process analysis software has proven to be computationally intractable in that the large order of the matrices generated by the equation matrix generators in these systems prohibits the inter-resource constraints from being implemented as it increases computational complexity as to the SQUARE order of the resulting equation matrix. Generally speaking, the possible interactions between N resource objects is of order N!, and thus the difficulty lies not in solving the matrix of order N, but rather generating the matrix of order N with sufficient efficiency and speed while incorporating the multitude of inter-resource interactions that exist in real-world enterprise environments.

### DEFICIENCIES IN THE PRIOR ART

The prior art as detailed above suffers from the following deficiencies:
Current enterprise optimization methodologies rely on serial chained-resource constraint models that do not accurately reflect real-world dependencies among enterprise systems/processes.
Current enterprise optimization methodologies fail to permit inter-resource constraints from properly being factored into the optimization analysis.
Current enterprise optimization methodologies are unable to account for inter-resource dependencies in equation matrices used to optimize enterprise systems/processes due to the intractable nature of accounting for and generating inter-resource constraints in the formation of the equation matrices.
Current enterprise optimization methodologies tie the optimization methodology to the database construction used to contain enterprise information, making modification of enterprise system/process models difficult or impossible.
Current enterprise optimization methodologies are difficult to port/transport to other computing platforms due to their integration with database schemas associated with enterprise information storage.
Current enterprise optimization methodologies are generally constrained to the use of contribution margin/marginal value in their computation of optimal system/process performance in a business context. This approach to optimization of business processes overlooks global enterprise optimal solutions. As defined herein, the correct approach to finding solutions that are globally optimal requires the use of “Opportunity Values” associated with decision variables. Analyses based on the use of Opportunity Values will identify enterprise system/process optimization solutions that exceed the performance of traditional contribution margin/marginal value solutions taught as globally optimal by the prior art.

While some of the prior art may teach some solutions to several of these problems, the core issue of overcoming computational complexity and achieving a truly globally optimal enterprise solution within this optimization environment has not been addressed.

### OBJECTIVES OF THE INVENTION

Accordingly, the objectives of the present invention are (among others) to circumvent the deficiencies in the prior art and affect the following objectives:
(1) Provide for an enterprise system/process modeling (ESPO) system and method that permits easy creation and modification of enterprise system/process models.
(2) Provide for an enterprise system/process modeling system and method that permits easy porting of enterprise models from one platform to another via traditional communication systems such as e-mail, etc.
(3) Provide for an enterprise system/process modeling system and method that permits incorporation of inter-resource constraints without incurring the intractable computational extremes present in the prior art.
(4) Provide for an enterprise system/process modeling system and method that permits decoupling of the enterprise optimization model from the information database associated with the enterprise.
(5) Provide for an enterprise system/process modeling system and method that permits “what if?” and iterative goal-seeking methodologies to be applied to the optimization of enterprise systems/processes.
(6) Provide for an enterprise system/process modeling system and method that permits easy calculation of Opportunity Value as compared to the use of contribution margin/marginal value as taught by the prior art.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### System Overview (0100)

The present invention and typical system application as applied to an enterprise system/process modeling (ESPO) system may take many forms, but a preferred exemplary embodiment may be utilized to optimize business and/or manufacturing systems and/or processes. The system/method may be broadly described as incorporating an enterprise system/process modeling definition subsystem in which an interconnected network of resources, constraints, and objectives may be defined to describe an enterprise system/process model. This enterprise system/process model defines resources, constraints, and objectives to describe the enterprise to be modeled and/or optimized and the various boundaries within which enterprise optimization is to take place. This enterprise system/process model is transformed into an intermediate representation by a translation subsystem for use in generating one or more a mathematical representations. One such representation generated is a set of simultaneous equations, commonly referred to as an “equation matrix” or simply “matrix.” “Solving” an equation matrix is a process in which the values of variables in the equations are assigned values in such a way that all the equations in the matrix are mathematically correct or “satisfied.” “Optimizing” an equation matrix means assigning values to the variables such that all the equations in the matrix are satisfied in such a way that the value defined by one equation, designated the “objective function,” is optimized. In the preferred exemplary embodiment, the equation matrix is solved to determine an optimal result conforming to desired enterprise objectives and the results presented for review by an enterprise reporting system.

Structurally, the system overview above may be more generally described by the diagram illustrated in FIG. 1 (0100), wherein the enterprise model definition subsystem (0101), enterprise model processing subsystem (0102), and enterprise model reporting system (0103) typically operate within the context of one or more computer systems (0111) running software read from a computer readable medium (0112).

As generally depicted in FIG. 1 (0100), the system may be trifurcated into three basic components (0101, 0102, 0103) and these components may be integrated within a single computer system platform or diversely separated among separate computer systems operating independently or within a networked environment. Furthermore, it should be noted that the I/O characteristics of the enterprise model definition subsystem (0101) and/or enterprise model reporting system (0103) may vary widely based on desired mechanisms for interfacing to information driving resource characteristics and constraint information, as well as providing for interpretation of optimized enterprise parameters and application of same within the enterprise or possibly as feedback parameters (0104) for further optimization analysis.

### Method Overview (0200)

As generally illustrated by the flowchart in FIG. 2 (0200), the present invention method can be generally described as incorporating the following steps:
(1) Generating, defining, or modifying an enterprise system/process model that functionally describes the operation of the enterprise system/process (0201);
(2) Integrating constraints within the model equation matrix to define relationships between resources contained within the enterprise system/model (0202);
(3) Solving the enterprise model equation matrix to generate an optimal enterprise solution state space (0203);
(4) Generating reports based on the optimal enterprise solution (0204);
(5) Determining if user and/or enterprise optimization objectives have been met, and if not, proceeding to step (1) (0205); and
(6) Terminating the enterprise system/process modeling method (0206).
   This general method may be modified heavily depending on a number of application-specific factors well known to those skilled in the art.

### BRIEF DESCRIPTION OF THE DRAWINGS

For a fuller understanding of the advantages provided by the invention, reference should be made to the following detailed description together with the accompanying drawings wherein:

FIG. 1 illustrates a generalized system overview of a preferred exemplary embodiment of the present invention;

FIG. 2 illustrates a generalized method overview of a preferred exemplary embodiment of the present invention;

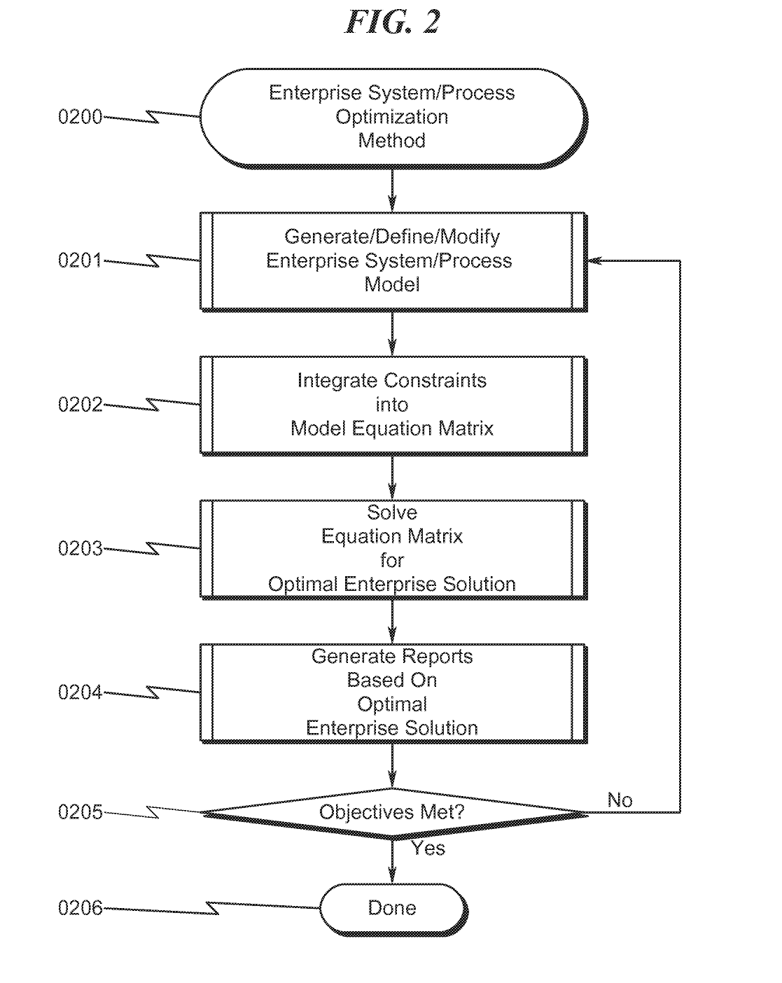

FIG. 3 illustrates a generalized system architecture of a preferred exemplary embodiment of the present invention;

FIG. 4 illustrates a generalized method architecture flowchart of a preferred exemplary embodiment of the present invention;

FIG. 5 illustrates a generalized distributed system architecture of a preferred exemplary embodiment of the present invention;

FIG. 6 illustrates a detailed method architecture flowchart of a preferred exemplary embodiment of the present invention;

FIG. 7 illustrates a generalized system architecture of a preferred exemplary embodiment of the present invention delineating the modeling, analysis, and reporting functions within the present invention;

FIG. 8 illustrates a generalized system architecture of a preferred exemplary embodiment of the present invention illustrating the integration of knowledge databases into the enterprise model definition;

FIG. 9 illustrates a general overview of a PICIS (purchasing/inventory/conversion/inventory/sales) model useful in defining enterprise system/process models in some preferred embodiments of the present invention;

FIG. 10 illustrates a generalized method architecture of a preferred exemplary embodiment of the present invention illustrating the integration of a PICIS modeling paradigm into the enterprise model;

FIG. 11 illustrates a generalized method architecture of a preferred exemplary embodiment of the present invention illustrating capture of a PICIS model using a graphical user interface;

FIG. 12 illustrates a generalized system architecture of a preferred exemplary embodiment of the present invention illustrating integration of a PICIS model into an equation matrix for solution of optimal enterprise functionality;

FIG. 13 illustrates an exemplary list of general report type definitions that may be obtained from some preferred embodiments of the present invention enterprise model reporting subsystem;

FIG. 14 illustrates an exemplary BALANCE SHEET financial reporting summary that may be obtained from the present invention enterprise model reporting subsystem;

FIG. 15 illustrates an exemplary INCOME STATEMENT financial reporting summary that may be obtained from the present invention enterprise model reporting subsystem;

FIG. 16 illustrates an exemplary CASH FLOW financial reporting summary that may be obtained from the present invention enterprise model reporting subsystem;

FIG. 17 illustrates an exemplary list of account type definitions that may be utilized within some preferred embodiments of the present invention enterprise model reporting subsystem;

FIG. 18 illustrates a generalized system architecture of a preferred exemplary embodiment of the present invention illustrating transformation of business process accounting information into an equation matrix for generation of optimal enterprise solution results;

FIG. 19 illustrates a generalized system architecture of a preferred exemplary embodiment of the present invention illustrating transformation of chart of accounts (COA) information into an equation matrix for generation of optimal enterprise solution results;

FIG. 20 illustrates a generalized system architecture of a preferred exemplary embodiment of the present invention illustrating transformation of chart of accounts (COA) information into an intermediate representation and later an equation matrix for generation of optimal enterprise solution results;

FIG. 21 illustrates a generalized system architecture of a preferred exemplary embodiment of the present invention illustrating transformation of chart of accounts (COA) and business operational activity information into an equation matrix for generation of optimal enterprise solution results;

FIG. 22 illustrates a generalized method architecture of a preferred exemplary embodiment of the present invention illustrating integration of business information into an intermediate representation for later transformation into an equation matrix for generation of optimal enterprise solution results;

FIG. 23 illustrates a process flow architecture of a preferred exemplary embodiment of the present invention illustrating generation of optimized enterprise system/process product-by-process configurations utilizing exemplary method embodiments of the present invention;

FIG. 24 illustrates a flowchart describing a preferred exemplary embodiment of an enterprise model definition subsystem overview method useful in some preferred embodiments of the present invention;

FIG. 25 illustrates a flowchart describing a preferred exemplary embodiment of an enterprise model definition subsystem method useful in some preferred embodiments of the present invention;

FIG. 26 illustrates a flowchart describing a preferred exemplary embodiment of a model definition subsystem initialization method useful in some preferred embodiments of the present invention;

FIG. 27 illustrates a flowchart describing a preferred exemplary embodiment of a business model component element selection method useful in some preferred embodiments of the present invention;

FIG. 28 illustrates a flowchart describing a preferred exemplary embodiment of a business model icon placement method useful in some preferred embodiments of the present invention;

FIG. 29 illustrates a graphical representation of a dimensioned data structure useful in representing the description of the enterprise system/process within some preferred embodiments of the present invention;

FIG. 30 illustrates a flowchart describing a preferred exemplary embodiment of a process flow connection method useful in some preferred embodiments of the present invention;

FIG. 31 illustrates a flowchart describing a preferred exemplary embodiment of knowledge base data generation method useful in some preferred embodiments of the present invention;

FIG. 32 illustrates a flowchart describing a preferred exemplary embodiment of model processing subsystem overview method useful in some preferred embodiments of the present invention;

FIG. 33 illustrates a flowchart describing a preferred exemplary embodiment of model processing subsystem method useful in some preferred embodiments of the present invention;

FIG. 34 illustrates a flowchart describing a preferred exemplary embodiment of a parsing method useful in some preferred embodiments of the present invention;

FIG. 35 illustrates a flowchart describing a preferred exemplary embodiment of a chart of accounts (COA) rule application method useful in some preferred embodiments of the present invention;

FIG. 36 illustrates a flowchart describing a preferred exemplary embodiment of a multiple time period financial aging method useful in some preferred embodiments of the present invention;

FIG. 37 illustrates a flowchart describing a preferred exemplary embodiment of a set of equations matrix generation method useful in some preferred embodiments of the present invention;

FIG. 38 illustrates a flowchart describing a preferred exemplary embodiment of an activity equation generation method useful in some preferred embodiments of the present invention;

FIG. 39 illustrates a flowchart describing a preferred exemplary embodiment of a chart of accounts (COA) equations generation method useful in some preferred embodiments of the present invention;

FIG. 40 illustrates a flowchart describing a preferred exemplary embodiment of an attribute equation generation method useful in some preferred embodiments of the present invention;

FIG. 41 illustrates pseudocode describing a preferred exemplary embodiment of an account aging method useful in some preferred embodiments of the present invention;

FIG. 42 illustrates pseudocode describing a preferred exemplary embodiment of an account aging and intra-period aging method useful in some preferred embodiments of the present invention;

FIG. 43 illustrates pseudocode describing a preferred exemplary embodiment of an account aging and intra-period aging method useful in some preferred embodiments of the present invention;

FIG. 44 illustrates a flowchart describing a preferred exemplary embodiment of a chart of accounts (COA) summary equation generation method useful in some preferred embodiments of the present invention;

FIG. 45 illustrates a flowchart describing a preferred exemplary embodiment of a financial ratio constraint generation method useful in some preferred embodiments of the present invention;

FIG. 46 illustrates a flowchart describing a preferred exemplary embodiment of a hard/hard ratio constraint generation method useful in some preferred embodiments of the present invention;

FIG. 47 illustrates a flowchart describing a preferred exemplary embodiment of a hard/soft ratio constraint generation method useful in some preferred embodiments of the present invention;

FIG. 48 illustrates a flowchart describing a preferred exemplary embodiment of a soft/hard ratio constraint generation method useful in some preferred embodiments of the present invention;

FIG. 49 illustrates a flowchart describing a preferred exemplary embodiment of a soft/soft ratio constraint generation method useful in some preferred embodiments of the present invention;

FIG. 50 illustrates a flowchart describing a preferred exemplary embodiment of a hard ratio constraint generation with toss method useful in some preferred embodiments of the present invention;

FIG. 51 illustrates an exemplary matrix representation of an account summary useful in some preferred embodiments of the present invention;

FIG. 52 illustrates a flowchart describing a preferred exemplary embodiment of an accounting equation add/modify matrix terms method useful in some preferred embodiments of the present invention;

FIG. 53 illustrates a flowchart describing a preferred exemplary embodiment of matrix credit function method useful in some preferred embodiments of the present invention;

FIG. 54 illustrates a flowchart describing a preferred exemplary embodiment of matrix debit function method useful in some preferred embodiments of the present invention;

FIG. 55 illustrates a flowchart describing a preferred exemplary embodiment of an accounting equation add/modify matrix cell function method useful in some preferred embodiments of the present invention;

FIG. 56 illustrates an exemplary embodiment of a FromAccount/ToAccount matrix representation useful for representing account aging in some preferred embodiments of the present invention;

FIG. 57 illustrates an exemplary embodiment of a FromAccount[+L]/ToAccount[+A] matrix representation useful for representing account aging in some preferred embodiments of the present invention;

FIG. 58 illustrates an exemplary embodiment of a FromAccount[−L]/ToAccount[−A] matrix representation useful for representing account aging in some preferred embodiments of the present invention;

FIG. 59 illustrates an exemplary embodiment of a FromAccount[L+A]/ToAccount[E] matrix representation useful for representing account aging in some preferred embodiments of the present invention;

FIG. 60 illustrates an exemplary embodiment of a FromAccount[L+A]/ToAccount[R] matrix representation useful for representing account aging in some preferred embodiments of the present invention;

FIG. 61 illustrates a prior art data flow methodology associated with matrix population;

FIG. 62 illustrates a prior art method flowchart associated with matrix population;

FIG. 63 illustrates a matrix population data flow used in some preferred embodiments of the present invention;

FIG. 64 illustrates a matrix population method flowchart used in some preferred embodiments of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an ENTERPRISE SYSTEM/PROCESS MODELING SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Enterprise Not Limitive

The present invention has as an objective the optimization of a wide variety of enterprise configurations. Within this context, the term “enterprise” should be given its broadest possible meaning. Generally speaking, the term “enterprise” encompasses larger systems and/or processes, with preferred embodiments specifically targeting complex systems and/or processes with a number of interdependencies within resources, constraints, and overall optimization objectives. For example, a corporate enterprise might include optimization for power consumption across the entire global corporate infrastructure, including optimizations for manufacturing shift modifications to obtain optimal electrical power rates. Or, conversely, it might include optimizations for a given manufacturing flow, accounting for a plethora of resource availability restrictions and other manufacturing limitations. Thus, the term “enterprise” should be given its broadest possible meaning when referring to the target application context of the overall optimization system/method described herein.

However, it should be noted that the teachings of the present invention may be equally applied to non-enterprise environments that are not necessarily “large” by conventional enterprise standards. Thus, while the teachings of the present invention may be suitable for enterprise optimization tasks, this does not limit the scope of the present invention teaching to this group of large system/process optimization.

### System/Process Not Limitive

The present invention has as its target objective the optimization of enterprise systems and/or processes. Within this context, the term “system/process” should be given its broadest possible interpretation to include systems and/or processes. Within the context of implementing global optimization within an enterprise environment, the line between a “system” and a “process” may become blurred, as many complex enterprise environments incorporate a wide variety of systems and/or processes in an interconnected network of linked resources and constraints. These linked resources and constraints may include physical systems (physical hardware and other physical resources, etc.) as well as processes (manufacturing flows and process parameters, etc.). Thus, the term “system/process” may be used within a specific enterprise context to incorporate tangible as well as intangible resources that are related in an arbitrary interconnected network of constraints. Thus, the term “system/process” within the context of this document is deemed to encompass the breadth of both “systems” and “processes” with respect to global enterprise optimization.

### Optimization Process Not Limitive

The present invention has as an objective the optimization of a wide variety of enterprise configurations, including but not limited to business processes and/or manufacturing methods. While many preferred embodiments of the present invention are specifically tailored to the optimization of business processes and/or manufacturing methods, the present invention is not limited to this preferred application scope and may be applied to any enterprise (or complex) system/process optimization in which the system/process may be described or modeled in terms of resources, constraints, and/or objectives to generate a mathematical dependency graph wherein the resource, constraints, and/or objectives form an interconnected network.

### Resource Not Limitive

The present invention generally permits “resources” to be related to and constrain one another. The term “resource” should be given its broadest meaning in this context, as it could mean any quantity that is finite in amount. For example, it could in some contexts mean a physical resource (such as raw material for product production, manpower, etc.) or intangible items (such as energy, capital, debt load, cash flow, etc.). Within this context resources may be considered fixed or variable, and if variable, may be temporal in nature or even have dependencies on other resources or variables within the global enterprise optimization framework. Thus, the term “resource” should be given its broadest possible meaning within the context of a globally optimized “enterprise” system/process solution.

### Constraint Not Limitive

The present invention generally permits “constraints” to be placed on resources that are related to one another. The term “constraint” should be given its broadest meaning in this context, as it could mean any number of mathematical functions that place constraints on a given resource or the relationship between resources. For example, it could in some contexts mean limitations on physical resource (such as amount of raw material available for product production, cost of manpower, etc.) or intangible items (such as energy costs, capital, debt load maximum, cash flow minimums, etc.). Within this context constraints may be considered fixed or variable, and if variable, may be temporal in nature or even have dependencies on other constraints, resources, or variables within the global enterprise optimization framework. Thus, the term “constraint” should be given its broadest possible meaning within the context of a globally optimized “enterprise” system/process solution.

### Objective Not Limitive

The present invention generally permits “objectives” to be utilized within the framework of the global enterprise optimization analysis to direct the optimization process towards specific global objectives for the enterprise within the framework of provide constraints on enterprise resources. While in many contexts the objective may be maximization of overall enterprise profit, the present invention makes no limitation on the form, formula, or metric associated with the objective(s) associated with overall enterprise optimization. Within this context, a wide variety of objectives may be possible, some may be used on combination, and in some cases these objectives may be selected from predefined objectives (and their associated mathematical models) integrated within the analysis framework of the present invention. Thus, the term “objective” should be given its broadest possible meaning within the context of providing a goal-seeking metric associated with the analysis of optimal enterprise solutions.

### Objective Terminal Solution Not Limitive

The present invention generally permits “objectives” to be utilized within the framework of the global enterprise optimization analysis to direct the optimization process towards specific global objectives for the enterprise within the framework of provide constraints on enterprise resources. While in many contexts the objective may be considered a “terminal” objective with respect to the overall enterprise optimization system/method, in many circumstances the objective is part of a series of “what if?” modifications to resources, constraints, and/or objectives where the modifications are attempted in a variety of configurations to achieve an optimal solution with respect to the enterprise system/process as a whole.

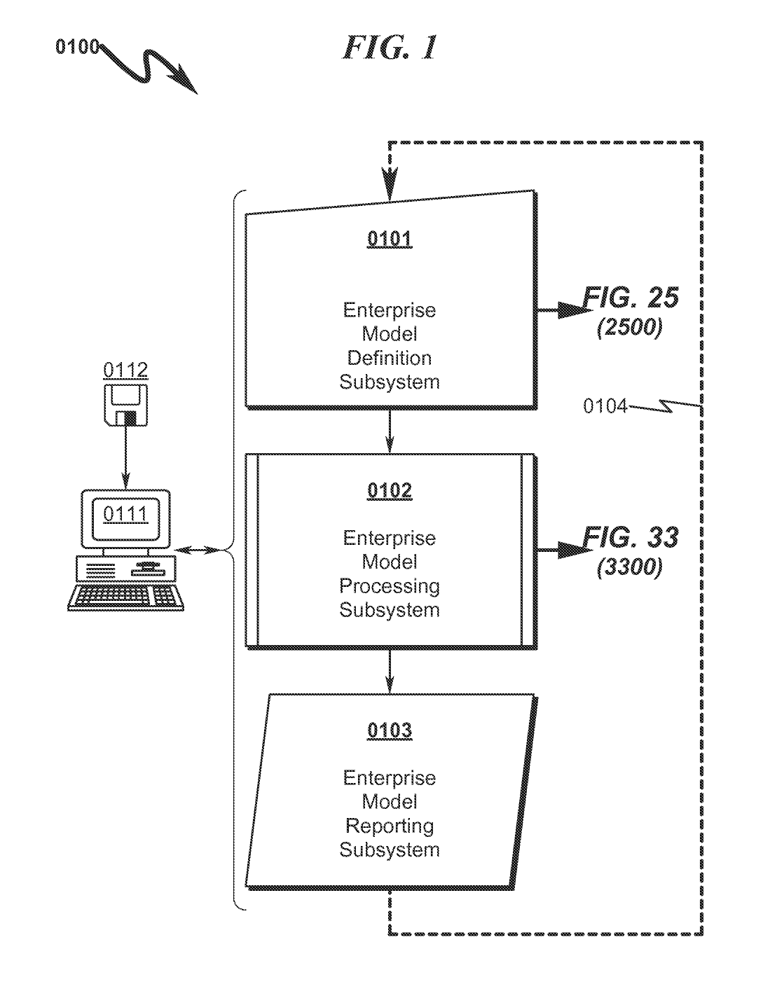

Within this context, a single “terminal” objective may be achieved as a solution that is optimal to given resources and constraints, and then the overall global enterprise optimization system/method may be iterated (as indicated in FIG. 1 (0104)) with modifications to resources, constraints, and/or objectives to achieve other desirable (and possibly more optimal) solutions to the overall enterprise system/process. Thus, the present invention specifically anticipates that the system/method presented herein may be utilized in an interactive and iterative manner to “probe” and analyze a wide variety of optimal solutions for a given enterprise system/process.

Note that some preferred exemplary embodiments of the present invention permit the “terminal solution” of the enterprise system/process to be fixed and the enterprise configuration to be determined from this terminal objective.

### Equation Matrix Solution Not Limitive

The present invention in many preferred embodiments makes use of an equation matrix solution subsystem that has as its objective the solution of large order systems of simultaneous equations, with many instances of these matrices being of the “sparse matrix” character. While many methodologies are known within the mathematical arts to perform this matrix solution function, the present invention makes no limitation on how this functionality is to be performed.

Additionally, many matrix solvers utilize a variety of notations to represent the structure of the underlying equations associated with the matrix, with corresponding syntaxes utilized to “load” the matrix for solution by the matrix solver. The present invention anticipates a wide variety of matrix equation syntaxes will be suitable for use with the teachings of the present invention and makes no limitation on the specific matrix equation representation syntax used to actually define the equation matrix for input to the matrix solver.

### Matrix Solver Not Limitive

The present invention in many preferred embodiments makes use of an equation matrix solution subsystem (matrix solver) that has as its objective the solution of large order systems of simultaneous equations, with many instances of these matrices being of the “sparse matrix” character. While many methodologies are known within the mathematical arts to perform this matrix solution function, the present invention makes no limitation on how this functionality is to be performed.

Specific matrix solution methodologies anticipated to be useful in some preferred exemplary embodiments include using one or more matrix solvers selected from a group consisting of linear programming (LP), non-linear programming (NLP), mixed integer problem (MIP), mixed integer linear programming (MILP (quadratic solver)), simulation, network analysis, constraint propagation, and scenario analysis.

### Data Structure Not Limitive

The present invention in many preferred embodiments may utilize a variety of data structures to optimally represent the enterprise model being generated and evaluated by the disclosed system/method. While these data structures are currently thought to be optimally hierarchical object-oriented data structures or (multi) dimensional data structures, the present invention scope is not limited by these preferred embodiment variants, and the term “data structure” in this context should be given its broadest possible interpretation consistent with the teachings of the disclosed invention.

### Analysis of Data Structure Not Limitive

The internal analysis of the data structures detailed above may take many forms within the present invention, with some preferred embodiments utilizing parsing or other techniques to perform this analysis. However, a wide variety of other “analysis” techniques are possible with regard to the evaluation of the model data structure. Within this context, the term “analysis” of the “data structure” should be given its broadest possible interpretation consistent with the teachings of the disclosed invention. While many preferred embodiments of the present invention may utilize “parsing” to implement certain analysis functions within the scope of the disclosed invention, the present invention is not strictly limited to the use of “parsing” to accomplish these functions.

### Method Steps Not Limitive

The method flowcharts generally illustrated and described herein may be modified heavily depending on a number of factors, with rearrangement and/or addition/deletion of steps anticipated by the scope of the present invention. Integration of the disclosed method flowchart and other preferred exemplary embodiment methods in conjunction with a variety of preferred exemplary embodiment systems described herein is anticipated by the overall scope of the present invention.

### Internet Not Limitive

The various preferred embodiments illustrated herein may make reference to the Internet as a communication mechanism between various system components and/or method steps. The use of the term Internet in this context is to be given its broadest possible meaning to include any communication network or media suitable for the transfer of information between the various system components or method steps.

### Ratio Constraint Attributes Not Limitive

The present invention in some embodiments incorporates the capability of enterprise modeling using ratio constraints, such that constraints between various enterprise model component elements may be specified as ratios and then constrained within certain limits. While the present invention discusses HARD and SOFT types of constraints, the present invention is by no means limited to these particular types of constraint limits.

### Chart of Accounts (COA) Not Limitive

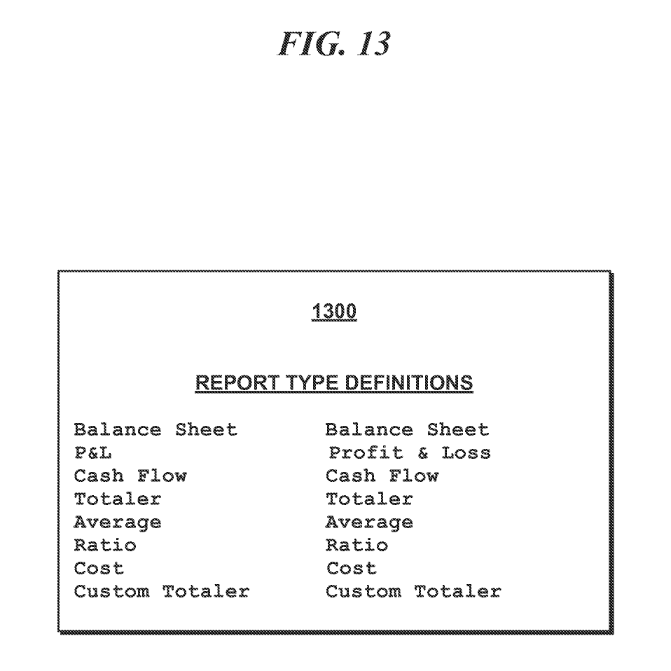

Several preferred embodiments of the present invention are detailed herein and describe the implementation of a Chart of Accounts (COA) embodiment of the present invention. Within this context the term “Chart of Accounts (COA)” should be broadly construed to include any financial analysis report depicted in FIG. 13 (1300), as the present invention scope is not strictly limited to Chart of Accounts (COA) analysis functions.

In addition, the invention as detailed herein is applicable to other aspects of enterprise modeling that are not typically considered financial modeling. These include all forms of enterprise activity including purchasing, sales, and manufacturing activities but they are especially relevant to inventory activity and attribute activity.

### Time Period Not Limitive

The present invention in some embodiments incorporates the capability of enterprise modeling across one or more time periods. The term “time period” in this context is to be given its broadest possible context, and includes fixed time periods, variable time periods, or combinations of fixed/variable time periods. For example a fixed time period might be 12 1-month periods, 7 1-day periods, or similar configurations. Variable time periods might include 1 week, 4 weeks, 52 weeks, etc. Combinations of these types of periods might include Q1, Q2, Q3, Q4, Y2, Y3, Y4, Y5, Y6-Y10, Y11-Y20, representing respective quarter (Q) and year (Y) time periods. Thus, within the context of the present invention, the term “time period” can in some embodiments mean independently varying the number of time periods and the length of each time period.

### Marginal Analysis/Marginal Value vs. Opportunity Value Target

The present invention may target a wide variety of objectives in the global analysis and optimization of an enterprise system/process. Within the context of the present invention, however, it should be noted that new classes of objective functions are introduced and promoted as providing optimal enterprise system/process functionality as compared to conventional objective functions.

### Marginal Analysis/Marginal Value

It should be noted in this context that conventional business planning and optimization software utilizes marginal value analysis, which defines “marginal value” as:
A value that holds true given particular constraints;
The change in a value associated with a specific change in some independent variable, whether it be of that variable or of a dependent; or
When underlying values are quantified, the ratio of the change of a dependent variable to that of the independent variable. This third case is actual a special case of the second.
   In the case of differentiability, at the limit, a marginal change is a mathematical differential or the corresponding mathematical derivative.

These uses of the term “marginal” are especially common in business and economics, and result from conceptualizing constraints as borders or as margins. The sorts of marginal values most common to economic analysis are those associated with unit changes of resources and, in mainstream economics, those associated with instantaneous changes. Marginal values associated with units are considered because many decisions are made by unit, and marginal analysis explains unit price in terms of such marginal values. Mainstream economics uses instantaneous values in much of its analysis for reasons of mathematical tractability.

Enterprise/process analysis and optimization requires the use of “Opportunity Value.” Opportunity Value is defined in terms of an activity, A, as well as all activities B and C where A's impact on B results in a decrease in benefit and where A's impact on C results in an increase in benefit. For action A, the Opportunity Value, “OppVal_{A}”, is calculated as:

OppVal_{A}=OPT_{obj}((marginal benefit of A)−(marginal cost of A)

−(Sum(OppVal_{B} for all actions B displaced by action A)

+Sum(OppVal_{c} for all actions C enabled by action A))
Where OPT_{obj} is a mathematical optimization function subject to the objective function “obj”.
   In other words, the Opportunity Value of activity A is the optimal, net economic impact of A, taking into consideration all the systemic implications A has on every other possible activity in the enterprise.

### Opportunity Value

In contrast to the predominant use of marginal analysis/marginal value in conventional business planning software, the present invention permits the use of “Opportunity Value” as part of the optimization process.

The Law of Universal Marginal Value addresses problems in conventional economic analysis by defining Opportunity Value as the optimal, net economic impact of an action or decision. Opportunity Value is essential because it is the only way to understand the interacting effects of decisions and actions. Economic decisions based on metrics other than Opportunity Value are often inaccurate when used as the basis for any form of business management solution. To be explicitly clear, any “planning solution” or decision analysis that uses Marginal Value and/or Contribution Value based on conventional economic definitions will not necessarily be correct in a global optimization environment. Similarly, using any form of cost analysis for planning decisions will also produce incorrect optimization results. Thus, optimal enterprise system/process modeling requires the calculation and use of Opportunity Value in the analysis.

The following should provide further clarification as to the benefits of using Opportunity Value in enterprise system/process modeling. First, it is important to resolve misunderstandings regarding how Opportunity Values are calculated. Opportunity Values are not merely the “shadow prices” or “reduced costs” from a linear optimization. If the representation used is not suitable for analysis—e.g., if the representation is not driver-based, causal analysis, shadow prices/reduced costs do not correspond to Opportunity Values. Similarly, if the representation does not include “Balance Sheet constraints” or relevant domain specific constraints, shadow prices and reduced costs do not correspond to Opportunity Values.

It is not the case that all linear optimization solutions are capable of generating Opportunity Values. Thus, very few linear programming model representations are suitable for analyzing Opportunity Values, resulting in a need for suitable custom-built representations for this analysis. Furthermore, it should be noted that shadow prices/reduced costs are accurate for only the next infinitesimal quantity. To illustrate, for any given activity, the shadow price/reduced cost associated with that decision is only accurate for the next very tiny amount of that activity.

In order to properly calculate Opportunity Values, the enterprise model *MUST* be constrained in such a way that Opportunity Values are calculated in terms that are appropriate for the units of activity. Thus, in order for a “planning solution” to be a legitimate enterprise solution, it must incorporate an extensive amount of domain specific knowledge.

### Opportunity Cost

Ancillary to the use of Opportunity Value within the context of the present invention is the use of opportunity cost, as generally defined in the literature as the cost of any activity measured in terms of the value of the best alternative that is not chosen (i.e., that is foregone). It is the sacrifice related to the second best choice available to someone who has picked among several mutually exclusive choices. Opportunity cost is a key concept in economics, and has been described as expressing “the basic relationship between scarcity and choice.” The notion of opportunity cost plays a crucial part in ensuring that scarce resources are used efficiently. Thus, opportunity costs are not restricted to monetary or financial costs: the real cost of output forgone, lost time, pleasure or any other benefit that provides utility should also be considered opportunity costs.

Thus, Opportunity Value and opportunity cost are related in that they both incorporate all forward and feedback relationships associated with a given decision. The integration of these feedback relationships within the framework of an enterprise system/process modeling system/method is anticipated by the claimed invention and operates to permit the claimed invention to optimize enterprise system/process problems not possible with prior art configurations that do not incorporate Opportunity Value/cost in their modeling and optimization capability.

### Generalized System/Method Embodiment Overview

The present invention and typical system application as applied to an enterprise system/process modeling (ESPO) system may take many forms, but a preferred exemplary embodiment may be utilized to optimize large business and/or manufacturing systems and/or processes. The system/method may be broadly described as incorporating an enterprise system/process modeling definition subsystem in which an interconnected network of resources, constraints, and objectives may be defined to describe a global enterprise system/process model. The enterprise system/process model defines resources, constraints, and objectives to describe the enterprise to be modeled and/or optimized and the various boundaries within which enterprise optimization is to take place. The enterprise system/process model is translated into an intermediate format by an enterprise global optimization subsystem for use in generating one or more mathematical representations such as a set of simultaneous equations, commonly referred to as an equation matrix. The equation matrix is solved for an optimal solution conforming to desired enterprise objectives and the results presented for review by an enterprise optimized process reporting system.

### System Context Overview (0300)

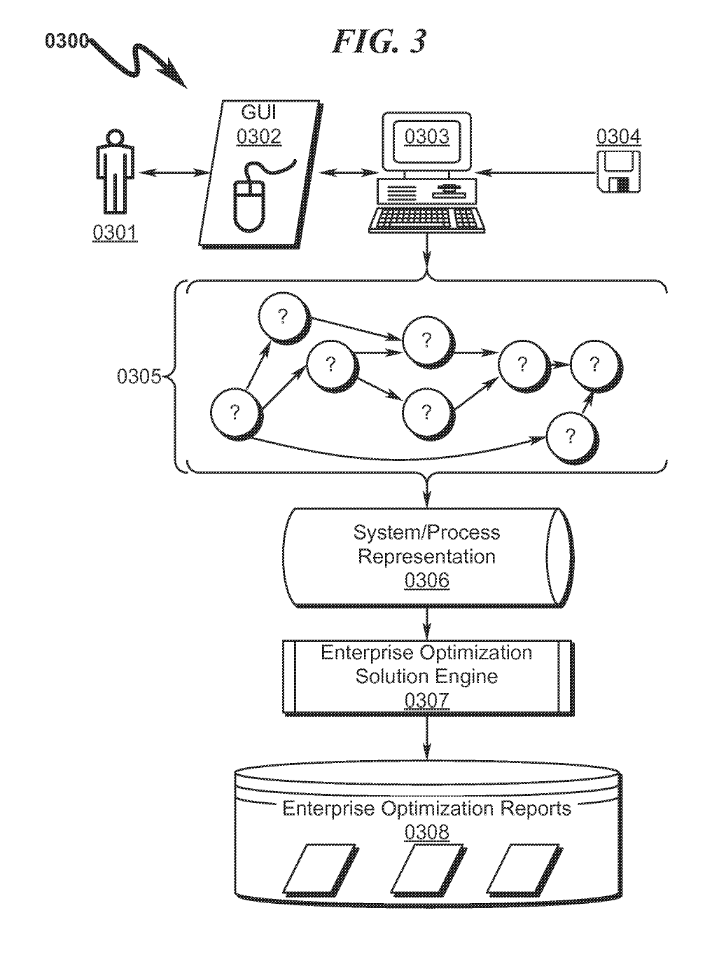

Referring to FIG. 3 (0300), the present system context may be described generally as depicted wherein a user (0301) defines an enterprise system/process description via a graphical user interface (GUI) (0302) using a computer system (0303) running under control of computer instructions retrieved from a computer readable medium (0304). This computer system (0303) under control of application software (0304) permits an intuitive system/process representation (0305) of the enterprise system/process to be created using graphical images representing enterprise resources and associated connecting lines representing constraints between these resources.

Within this context, the graphical user interface (0302) creates a database (0306) from the graphical system/process representation (0305) of the enterprise system/process that includes resources, constraints, and objectives for enterprise optimization. This system/process representation (0306) is then analyzed by an enterprise optimization solution engine (0307) to generate an optimal enterprise state space solution that is then reported via enterprise optimization reports (0308) to the user.

### Method Context Overview (0400)

The method associated with many preferred embodiments of the present invention incorporates an integration of “knowledge” within the “application” environment such that within the context of an enterprise system/process modeling design tool the description of the enterprise system/process incorporates embedded information about the system/process being modeled. This technique, termed “constraint oriented reasoning (COR)” provides the ability to leverage captured “domain expert knowledge (DOE)” about the enterprise system/process and embed it in applications such that modeling users can leverage that knowledge.

The manner in which the DOE is captured insures self-consistency within and across the aggregated knowledge databases associated with the modeling application environment. This is accomplished by decomposing DOE into primitive components analogous to atoms and molecules. These atoms and molecules of knowledge may have properties associated with them such that they can be organized into a multi-dimensional structure akin to a Periodic Table of Elements. This approach to capturing and leveraging the knowledge required for enterprise system/process modeling and optimization possible by enabling the integration of knowledge from multiple sources in a manner that is self-consistent.

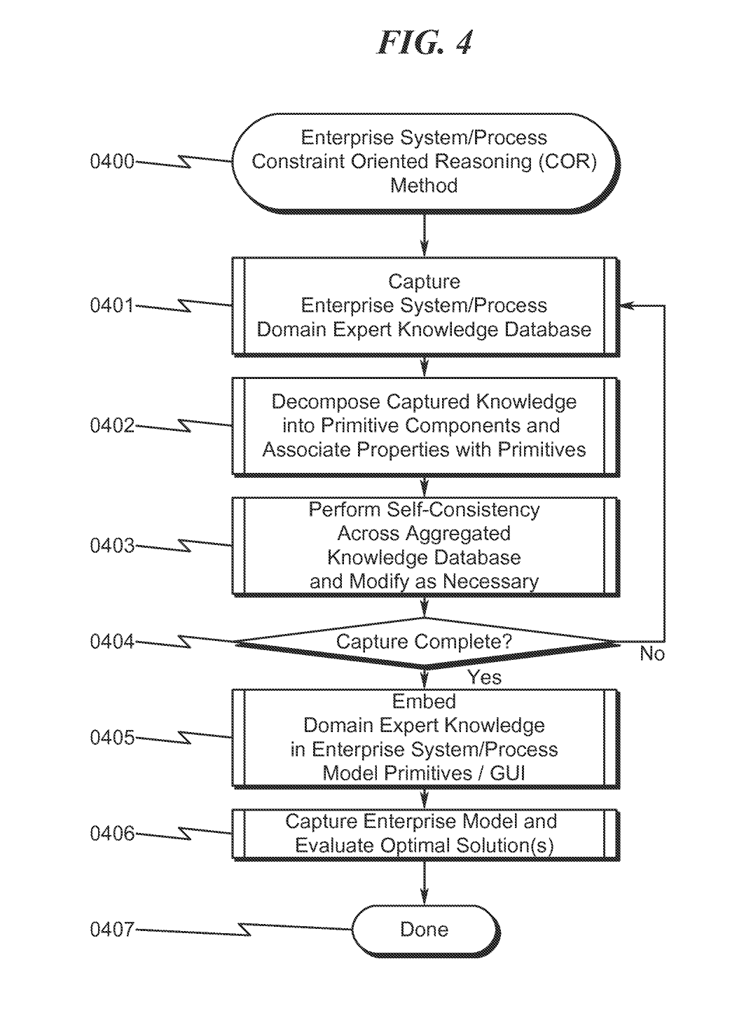

Within this context, the present invention in some preferred embodiments incorporates a COR method as generally depicted in FIG. 4 (0400), with the method comprising the following steps:
(1) Capturing the enterprise system/process domain expert knowledge database, which contains information on the functionality and relationships within and across elements of the enterprise system/process (0401);
(2) Decompose the captured knowledge within the domain expert knowledge database into primitive components, and associate properties with these primitive elements (0402);
(3) Perform a self-consistency check across aggregated knowledge database and modify as necessary to validate the knowledge database (0403);
(4) Determining if domain expert knowledge database capture is complete, and if not, proceeding to step (1) (0404);
(5) Embedding the collected domain expert knowledge database into the enterprise system/process model primitives (0405);
(6) Capturing the enterprise system/process model via a GUI and evaluating optimal solutions for the captured enterprise system/process model (0406); and
(7) Terminating the enterprise system/process constraint oriented reasoning method (0407).
   This general method may be modified heavily depending on a number of application-specific factors well known to those skilled in the art.

### Distributed System Context Overview (0500)

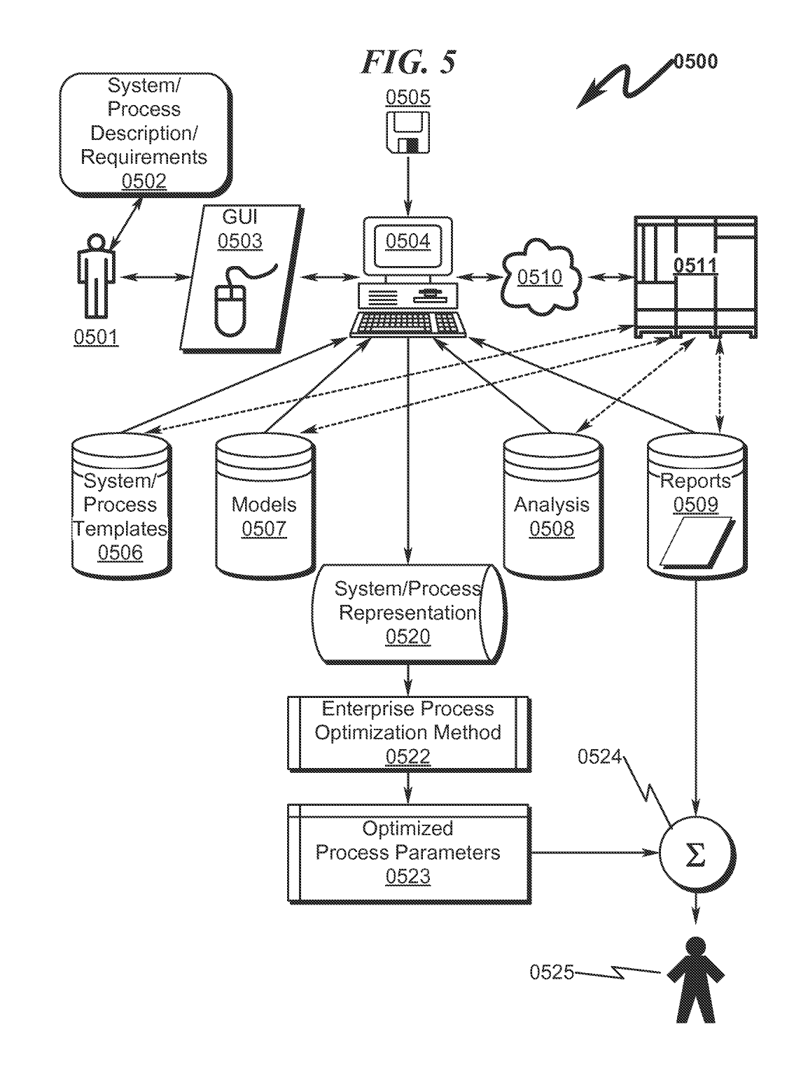

Referring to FIG. 5 (0500), the present system context may also be described generally in a distributed fashion as depicted wherein a user (0501) defines an enterprise system/process description and/or requirements (0502) using a graphical user interface (GUI) using a computer system (0504) running under control of computer instructions retrieved from a computer readable medium (0505). This computer system (0504) under control of application software (0503) permits a system/process representation (0520) of the enterprise system/process given by the enterprise system/process description and/or requirements (0502) to be created using graphical images representing enterprise resources and associated connecting lines representing constraints between these resources.

Within this context, the graphical user interface (0503) may incorporate a number of databases, including but not limited to a system/process template database (0506) that describe a number of known enterprise systems/processes that may be used as a starting point for a specific enterprise system/process analysis; a system/process model database (0507) representing known types of models associated with various types of enterprise configurations; an analysis definition database (0508) describing known types of analysis to be performed on various enterprise performance metrics; and a reports database (0509) that permits a variety of known report types to be associated with the overall enterprise optimization solution. As indicated in FIG. 5 (0500), these databases (0506, 0507, 0508, 0509) may be located locally to the computer system (0504) and/or remotely accessed via a network/Internet (0510) via a remote file server (0511).

Once the system/process representation (0520) is generated from the graphical user interface (0503) entered by the user (0501), an enterprise system/process modeling method (0522) is applied to the resulting representation to apply specified resources, constraints, and objectives to the enterprise system/process representation and produce an optimized set of enterprise configuration parameters (0523) that when integrated (0524) with a report structure (0509) selected by the user (0501) results in optimized enterprise configuration results being presented (0525) for review, further analysis, and/or implementation.

### General Invention Method Architecture (0600)

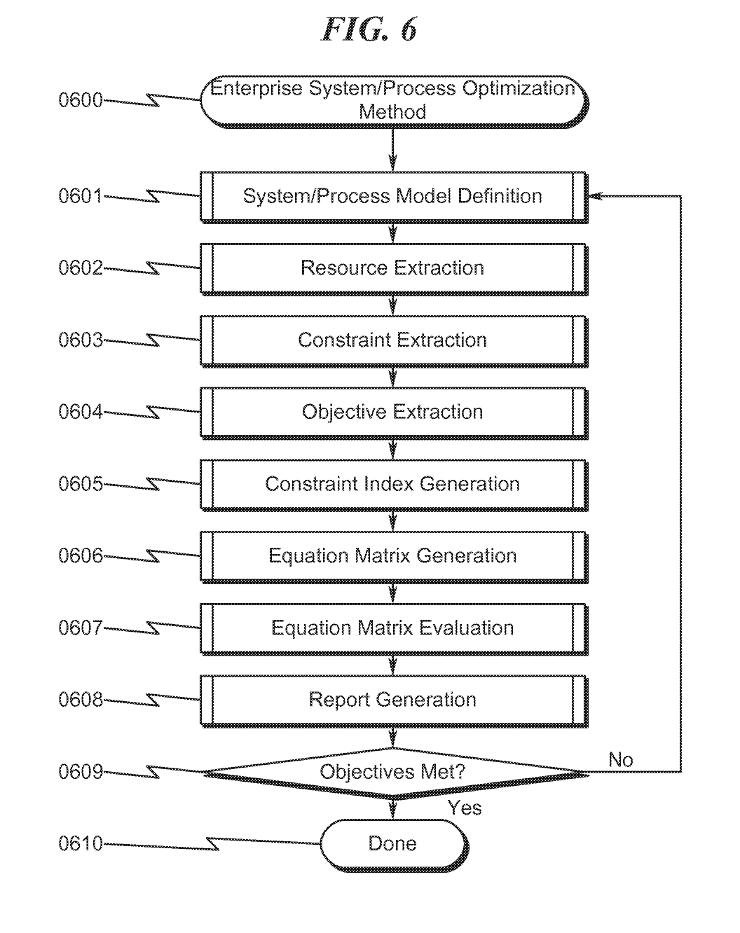

The general method architecture of the present invention is generally illustrated in FIG. 6 (0600). In this exemplary architecture the method is illustrated as applied to an optimization of an enterprise system/process. The method steps generally comprise the following:
(1) Defining the enterprise system/process using a graphical user interface (0601);
(2) Extracting the required enterprise resources from the enterprise system/process definition (0602);
(3) Extracting the required enterprise constraints from the enterprise system/process definition (0603);
(4) Extracting the required enterprise objectives from the enterprise system/process definition (0604);
(5) Generating an intermediate form of the enterprise system/process definition and applying the enterprise constraints to the resulting intermediate data structure (0605);
(6) Generating an equation matrix from the intermediate data structure that integrates the enterprise system/process definition with the enterprise constraints (0606);
(7) Evaluating the equation matrix with a matrix solver to generate an optimal solution state space for the enterprise system/process definition (0607);
(8) Generating any requested reports from the optimal solution state space (0608);
(9) Determining if user and/or enterprise optimization objectives have been met, and if not, proceeding to step (1) (0609); and
(10) Terminating the enterprise system/process modeling (0610).
   This general method may be modified heavily depending on a number of application-specific factors well known to those skilled in the art.

### Detailed Invention System Architecture (0700)

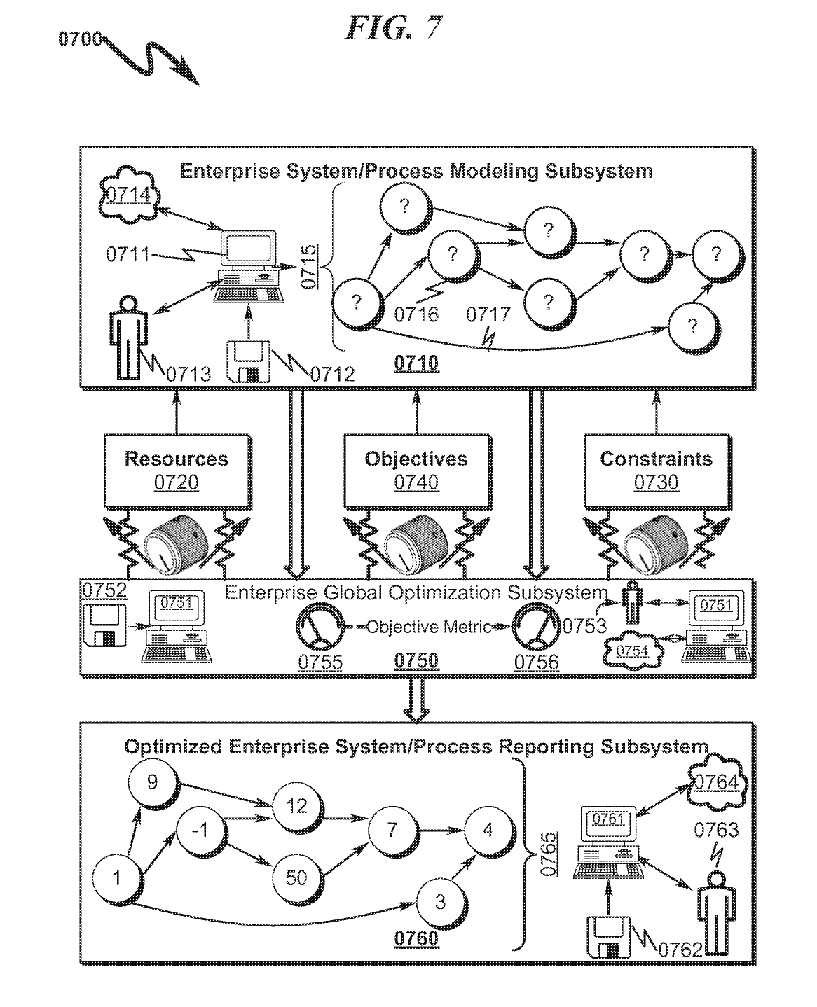

The general system architecture of the present invention is generally illustrated in FIG. 7 (0700). The system as generally described comprises an enterprise system/process modeling definition subsystem (ESPD) (0710) in which resources (0720), constraints (0730), and objectives (0740) are defined; a modeling processing subsystem (EGOS) (0750) that translates the enterprise system/process model created by the enterprise system/process modeling system (0710) into a mathematical representation and optimizes this representation based on desired enterprise objectives (0740); and an enterprise optimized system/process reporting subsystem (ESPR) (0760) that presents the optimized enterprise system/process configuration in a form suitable for human inspection, analysis, review, and/or implementation.

### Enterprise System/Process Modeling Definition Subsystem (0710)

In this exemplary architecture the system is illustrated as incorporating an enterprise system/process modeling definition subsystem (0710) herein depicted incorporating a computer system (0711) running under software retrieved from a computer readable medium (0712). This computer system (0711) generally interfaces with a user (0713) and/or a network (0714) to control the construction of a mathematical representation (0715) comprising a number of enterprise resources (0716) and/or constraints (0717). The purpose of the enterprise system/process modeling subsystem is to generate a mathematical description of the enterprise system/process to be optimized. Many preferred exemplary embodiments of the present invention utilized a graphical editor in which icons are used to represent resources (0716) and connecting lines are utilized to represent constraints (0717) between the resources (0716).

### Resources (0720), Constraints (0730), and Objectives (0740)

As stated previously, the mathematical representation (0715) and associated interconnected resource (0716) network of constraints (0717) may have associated with it a plethora of resources (0720), constraints (0730), and/or optimization objectives (0740). These resources (0720), constraints (0730), and/or optimization objectives (0740) are the tools by which the enterprise global optimization subsystem (0750) uses to modify the configuration of the parameters associated with the process model created by the enterprise system/process modeling subsystem (0710) in order to achieve an “optimal” result. Generally speaking, within the context of business process modeling, “optimal” results generally requires maximization of overall system/process profit, but one skilled in the art will recognize that other objectives may dictate other definitions of “optimal” results.

### Enterprise Global Optimization Subsystem (0750)

The enterprise global optimization subsystem (0750) generally operates under control of a computer system (0751) running under software retrieved from a computer readable medium (0752). This computer system (0751) may interface with a user (0753) and/or a network (0754) to control the modification of parameters within the enterprise system/process model to achieve migration of objective metrics from a nominal value (0755) to an optimal value (0756). The optimization process within the enterprise global optimization subsystem generally involves transformation of the mathematical model(s) associated with the enterprise system/process model created by the enterprise system/process modeling subsystem (0710) into an indexed data structure (IDS) suitable for application of constraints (0730) associated with the resources (0720). Once all constraints (0730) have been applied to the IDS, an optimization equation matrix (OEM) is generated for solution by one of a number of possible matrix solver solution engines. Application of a matrix solver to the OEM provides a solution based on application of optimization objectives (0740).

### Enterprise Optimized System/Process Reporting Subsystem (0760)

The enterprise optimized system/process reporting subsystem (ESPR) (0760) generally operates under control of a computer system (0761) running under software retrieved from a computer readable medium (0762). This computer system (0761) may interface with a user (0763) and/or a network (0764) to permit reporting and/or possible further modification of enterprise system/process parameters, resources, constraints, and/or objectives. The enterprise optimized process reporting subsystem (0760) generally operates as a “backend” presentation subsystem to emit the optimized results (0765) obtained by the enterprise global optimization subsystem (0750).

### Information Data Flow Overview (0800)

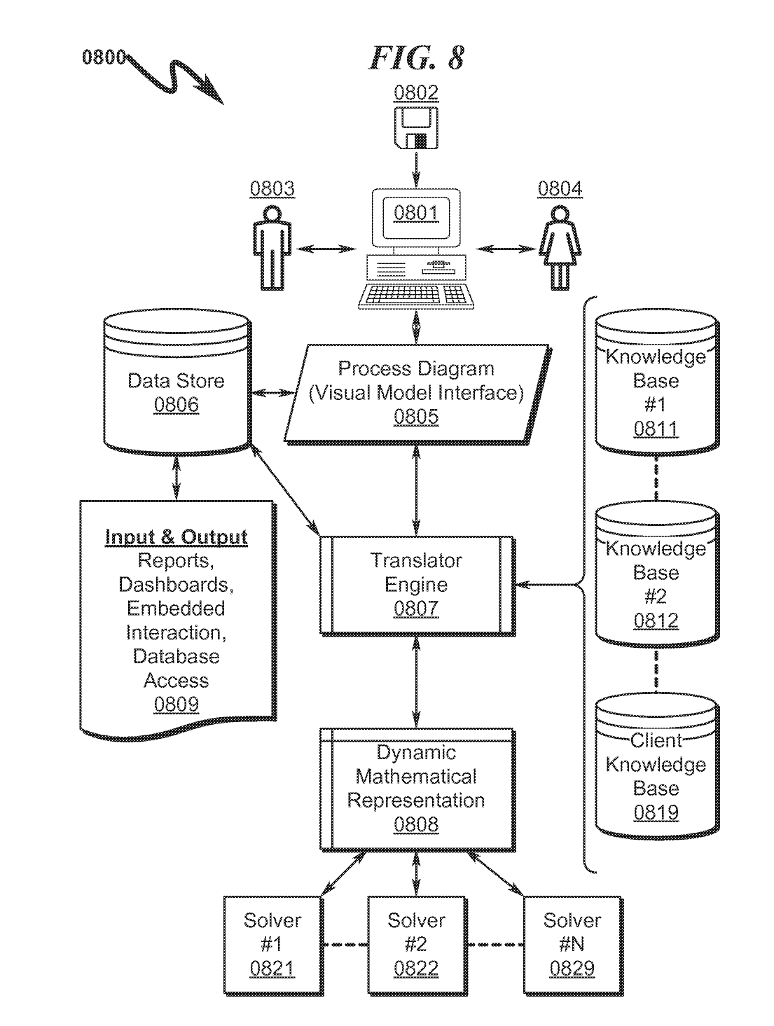

The present invention information data flow can be generally described as depicted in FIG. 8 (0800), wherein a computer system (0801) operating under control of software retrieved from a computer readable medium (0802) is used to interface with one or more individuals (0803, 0804) to affect a system/process diagram visual model interface via (optimally) a graphical user interface (GUI) (0805). The results of this GUI model definition is a database (0806) describing the enterprise system/process that is operated on by a translation engine (0807) that translates the graphical components and their associated resources, constraints, and/or objectives into a dynamic mathematical representation (0808). This dynamic mathematical representation has the advantage of being automatically updated in response to interactions between the individuals (0803, 0804) and the system/process modeling interface (0805).

The translator engine (0807) may integrate a number of knowledge databases (0811, 0812, 0819) to incorporate a variety of context sensitive information into the modeling and analysis of the enterprise system/process, including but not limited to business rules, process rules, and mathematical rules. These rules can incorporate a variety of knowledge sources, including but not limited to general, industry, process, and functional knowledge. This information flow anticipates the use of client-specific attributes and knowledge bases (0819) that may be dynamically created and maintained by the users (0803, 0804) of the system.

Once enterprise optimization analysis is performed on the dynamic mathematical representation (0808) by one or more equation matrix solvers or other types of solvers (0821, 0822, 0829), the results may be presented to the users (0803, 0804) in a variety of formats (0809), including but not limited to reports, dashboards, modal dialog boxes, embedded application interaction, or custom database access. This reporting facility may include bi-directional database access and/or updating facilities.

### Enterprise System/Process “PICIS” Modeling Overview (0900)

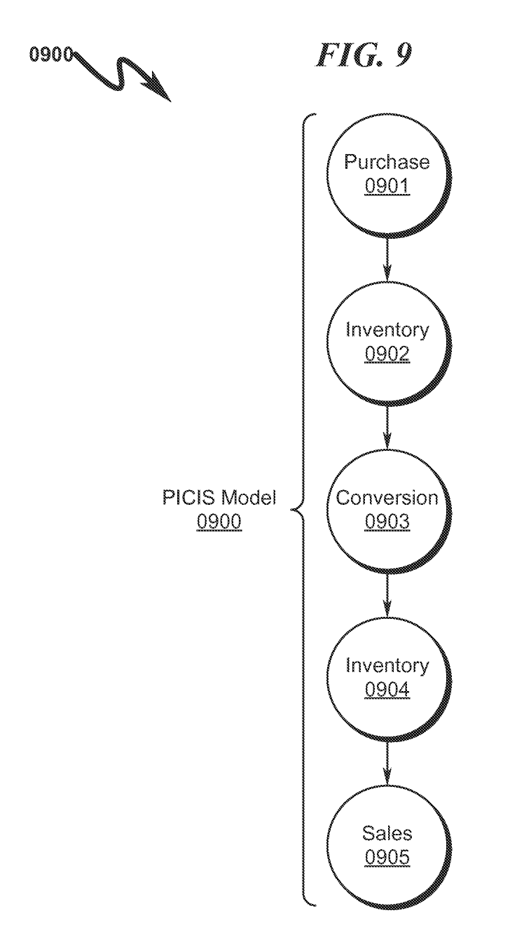

While many methodologies may be utilized to model enterprise system/process behavior, the preferred methodology to accomplish this uses a “PICIS” (purchasing/inventory/conversion/inventory/sales) model as generally illustrated in FIG. 9 (0900). Here the basic enterprise system/process model (0900) utilizes discrete nodes incorporating a purchasing node (0901), followed by an inventory node (0902), followed by a conversion node (0903), followed by another inventory node (0904), followed by a sales node (0905). Generally speaking, the inventory nodes (0902, 0904) represent way-points within the enterprise system/process, while the purchase node (0901) represents material or sourcing acquisition activity, the conversion node (0903) represents a transformation within the enterprise system/process, and the sales node (0905) represents a disposition activity of the product/service defined or produced by the enterprise system/process.

The model as generally illustrated may incorporate a plethora of nodes at each individual stage, as well as additional full or partial PICIS trees flowing from each node in the model diagram. The tree structure generated using this general model paradigm can be arbitrarily wide and arbitrarily deep, with feedback within the model permitted, as there may be relationships and/or constraints between the PICIS nodes and other nodes in the model diagram.

While the present invention may incorporate other enterprise system/process modeling paradigms, the PICIS model is preferred in many embodiments. However, it must be noted that the PICIS model is not the only modeling paradigm anticipated by the scope of the present invention.

### Generalized System Architecture Using PICIS Modeling (1000)

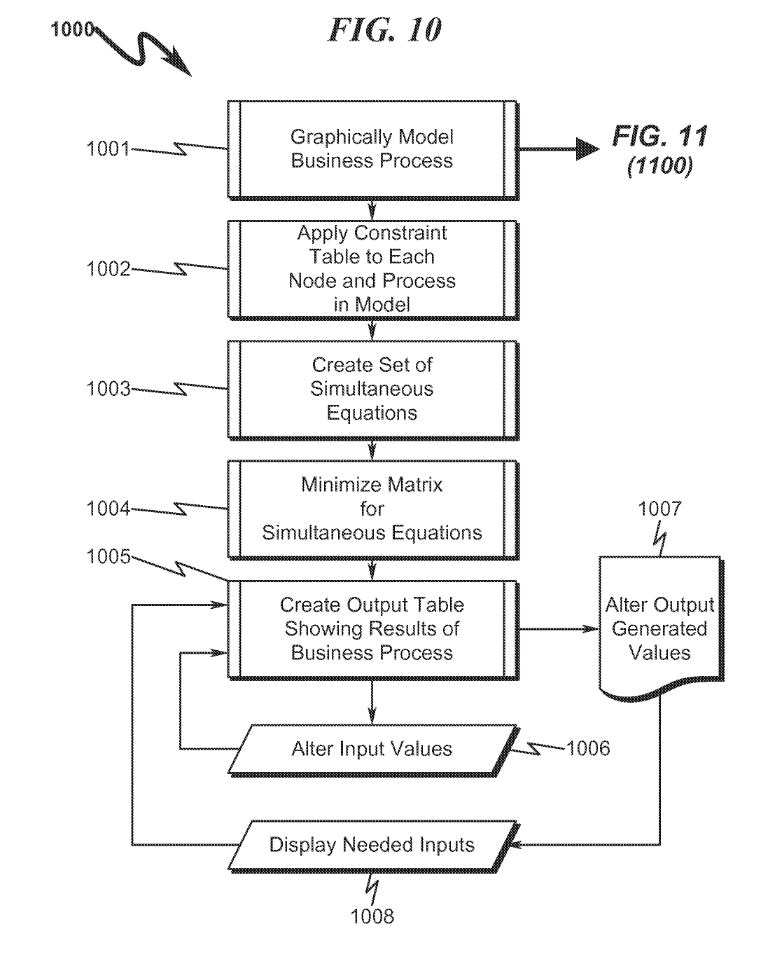

The PICIS modeling paradigm generally illustrated in FIG. 9 (0900) may be implemented in some preferred embodiments of the present invention as generally illustrated in FIG. 10 (1000), wherein a graphical interface is used to model a business process using the PICIS modeling paradigm (1001). This PICIS model is then used as a basis for extracting relationships to determine and apply constraints to the process model (1002). From this enterprise system/process network of PICIS nodes a set of simultaneous equations is created (1003). This set of simultaneous equations is solved to optimize the objective function of the resulting equation matrix (1004). Once a solution is obtained, an output table is created showing the results of the business process with the optimized enterprise system/process variable values (1005). At this point the input values associated with the optimization may be modified (1006) and the process restarted to regenerate the output enterprise state (1005) and/or the output values can be modified (1007) and the optimization system can be instructed to backsolve for the needed enterprise input values to achieve these desired outputs (1008).

The present invention permits both input values (relationships, constraints, objectives) to the optimization to be modified (1006), but also permits the resulting outputs of resulting enterprise state to be modified (1007) and then the required inputs to achieve these enterprise outputs are then determined and displayed (1008). Thus, the present invention permits both “forward” enterprise optimization (“feed-forward optimization”) and “retrospective” (“feedback optimization”) types of enterprise optimization to be performed with the same enterprise system/process model.

### Generalized GUI Data Entry Method Using PICIS Model (1100)

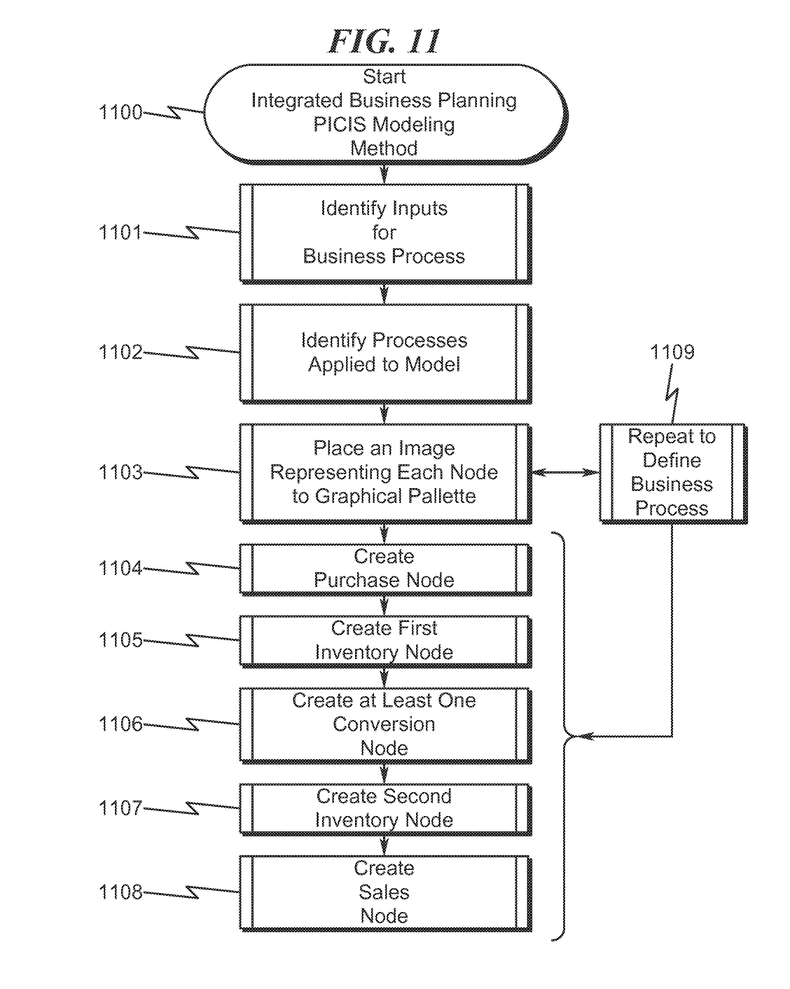

The PICIS modeling paradigm generally illustrated in FIG. 9 (0900) may be utilized within a graphical user interface having a data entry method as generally illustrated in FIG. 11 (1100) in some preferred embodiments of the present invention. Here the model definition method (1100) starts with identification of the inputs for the business process (1101). Processes applied to the model are then identified (1102). An image representing each node in the business process PICIS model is then placed on a graphical palette (1103). A purchasing node is first created (1104), followed by a first inventory node (1105), at least one conversion node (1106), a second inventory node (1107), and finally a sales node (1108). This sequence is representative only. It should be understood that the process of specifying a PICIS model can start at any point in the representation and may include any number of interconnected, or independent, full or partial submodels.

The method as illustrated may incorporate repetitive feedback (1109) with any of the node placements (1104, 1105, 1106, 1107, 1108) to permit any degree of network width, depth, and/or feedback/feedforward to be accommodated within the network connected enterprise model. Generally speaking, as the model is updated graphically, the optimal system configuration automatically updates the underlying intermediate mathematical representation of the model and via this intermediate form the underlying equation matrix that is used to solve for the optimal enterprise solution(s).

### Generalized GUI Data Entry System Using PICIS Model (1200)

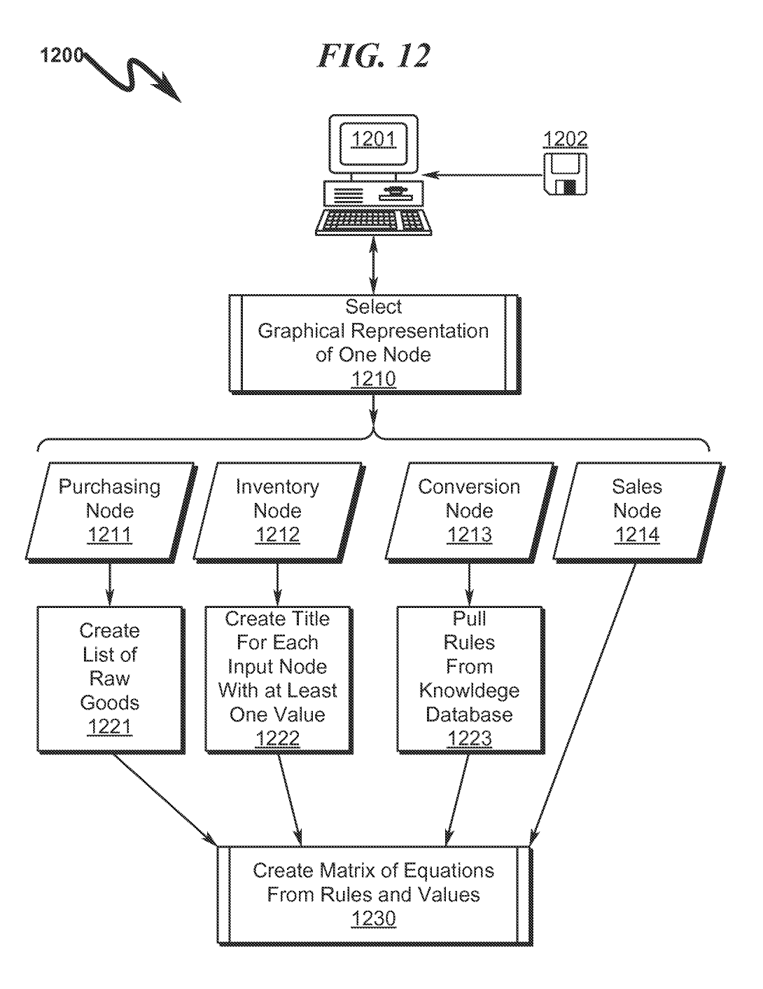

The PICIS modeling paradigm generally illustrated in FIG. 9 (0900) may be utilized within a graphical user interface having a data entry system as generally illustrated in FIG. 12 (1200) in some preferred embodiments of the present invention. Here the model definition method application runs on a computer system (1201) under control of software read from a computer readable medium (1202). Using the PICIS modeling paradigm, a graphical user interface permits selection of a graphical representation of one node (1210).

This GUI interface permits selection, placement, and connection of purchasing (1211), inventory (1212), conversion (1213), and sales (1214) nodes on a graphical palette. Purchasing nodes (1211) may incorporate the creation of a list of raw goods (1221) needed for the enterprise system/process. Inventory nodes may create titles for each input node with at least one value (1222). Conversion nodes may incorporate integration of rules from knowledge databases (1223) that determine the exact nature of the conversion on the enterprise purchasing/inventory inputs. Finally, sales nodes (1214) may integrate outflow and demand requirements associated with the output of the enterprise system/process. All of this information is integrated into a matrix of equations generated from rules and values entered with the GUI PICIS model definition (1230). This equation matrix is then solved for optimal enterprise operation based on entered relationships, constraints, and objectives.

### Exemplary Report Type Definitions (1300)

While the present invention enterprise model reporting subsystem is capable of generating a wide variety of accounting and financial reports, an exemplary and non-exclusive list of possible report types is generally illustrated in FIG. 13 (1300).

### Exemplary Report Type Formats (1400, 1500, 1600)

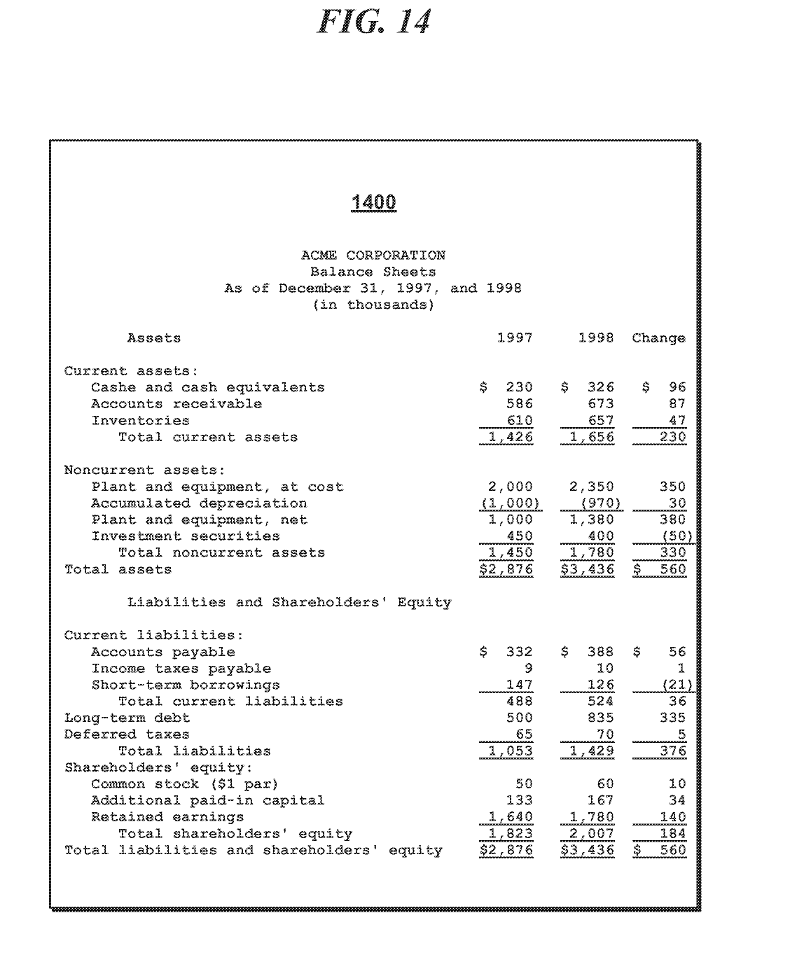

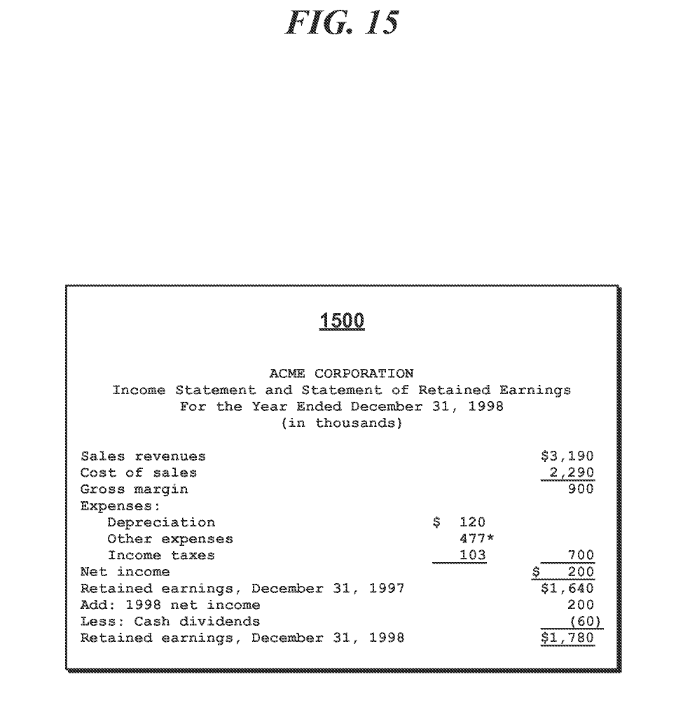

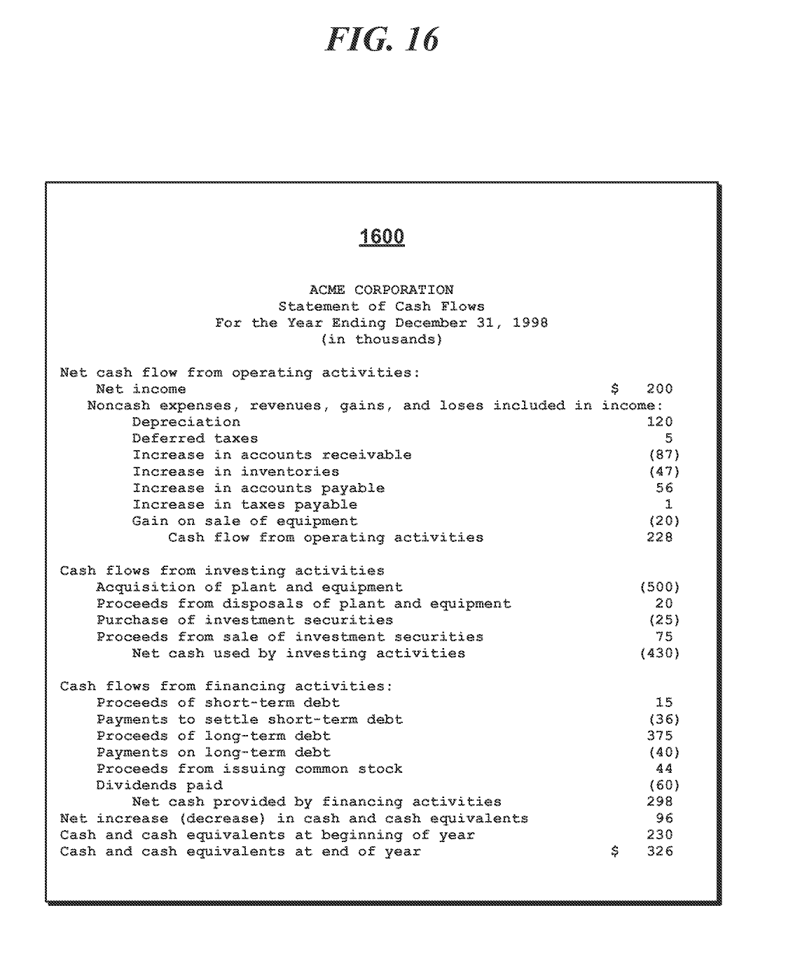

Exemplary formats associated with the exemplary report types detailed in FIG. 13 (1300) may be generally seen in the BALANCE SHEET REPORT of FIG. 14 (1400), the INCOME STATEMENT REPORT of FIG. 15 (1500), and the CASH FLOW REPORT of FIG. 16 (1600). These exemplary financial reports represent the backbone of any business process model analysis generated by many preferred embodiments of the present invention, and are presented here as an exemplary and non-exclusive list of possible report outputs that are possible by the present invention.

These reports may be referenced generically in following sections that detail the methodologies utilized to create these reports within the enterprise financial modeling system disclosed herein.

### Exemplary Account Type Definitions (1700)

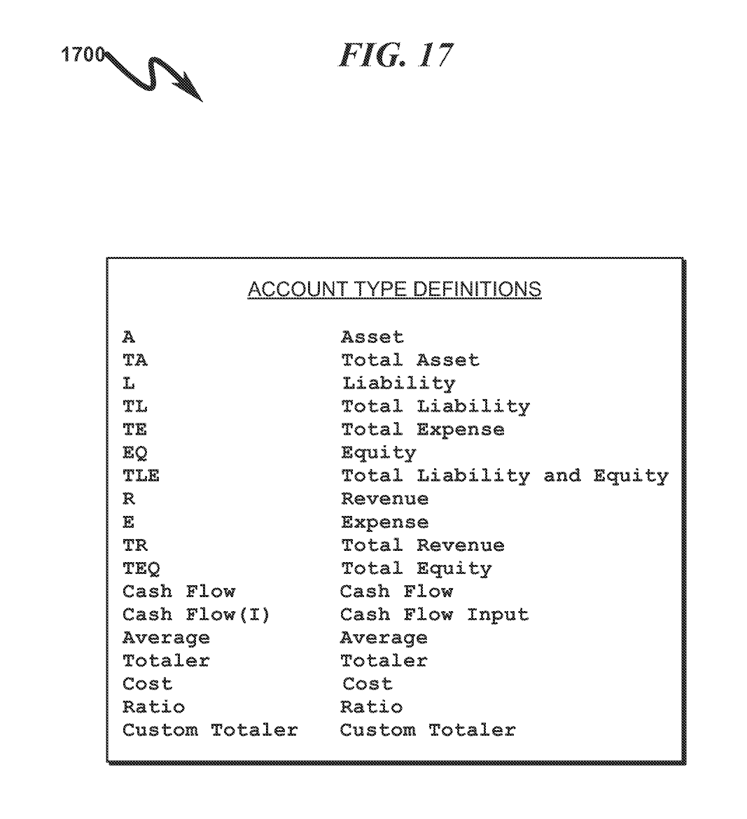

While the present invention may be applied to a wide variety of financial analysis applications, an exemplary non-exhaustive sample of the types of accounts to which the present invention may be applied is detailed in FIG. 17 (1700) along with their nominal identifiers.

### Business Information to Matrix Transformation (1800)

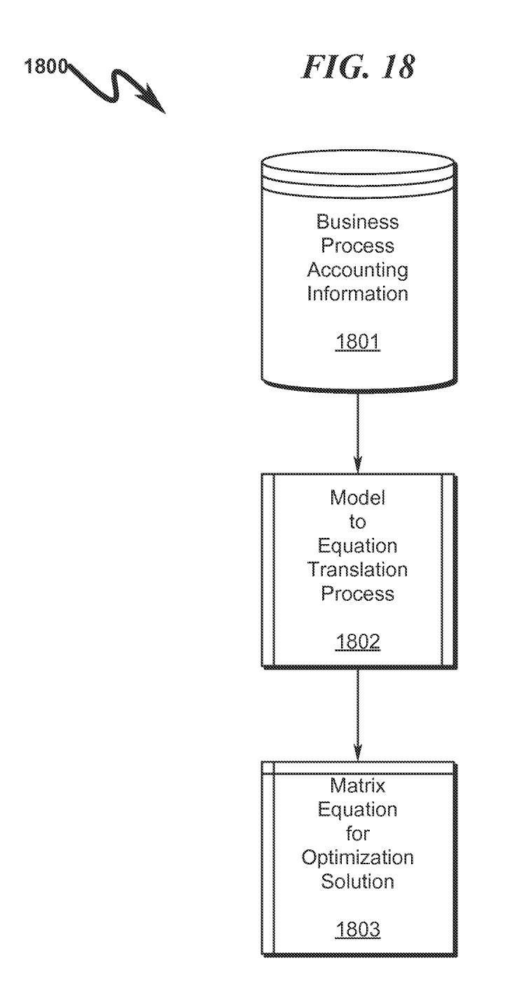

The present invention as generally illustrated in FIG. 18 (1800) has in many preferred embodiments as an internal framework the transformation of business process accounting information (1801) by a model-to-equation translator (1802) to an equation matrix (1803) that is solved for an optimal enterprise system/process solution. This generalized framework has a variety of configurations, some of which are described below.

### Chart of Accounts to Equation Matrix Transformation (1900)

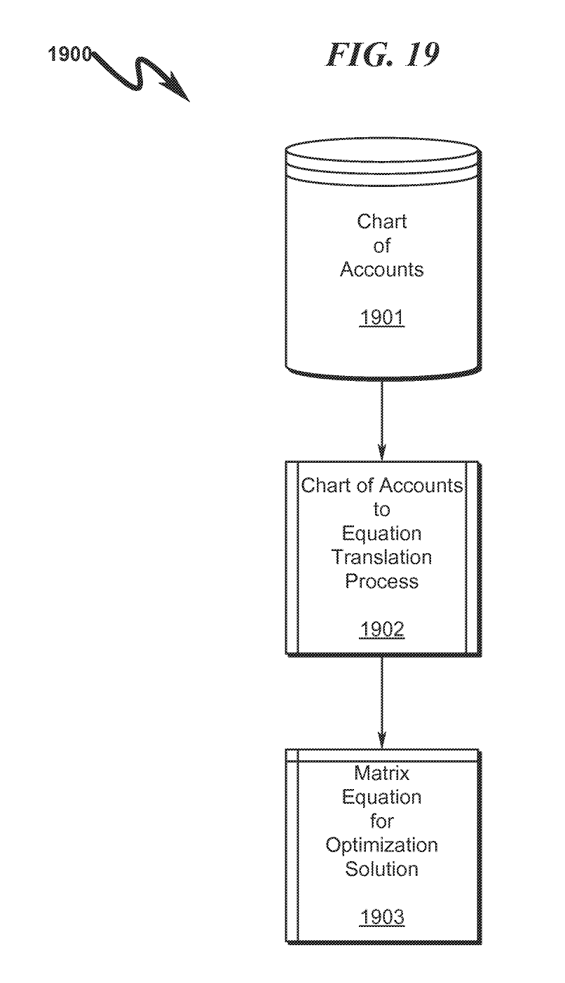

One preferred embodiment of the present invention as generally illustrated in FIG. 19 (1900) permits translation of a financial chart of accounts (COA) (1901) by a chart-of-accounts-to-equation translator (1902) to an equation matrix (1903) that is solved for an optimal enterprise system/process solution. This architecture implements a method for translating a financial chart of accounts (COA) into a linear programming representation that can then be solved to determine optimal enterprise configuration(s).

### Chart of Accounts to Intermediate Matrix Transformation (2000)

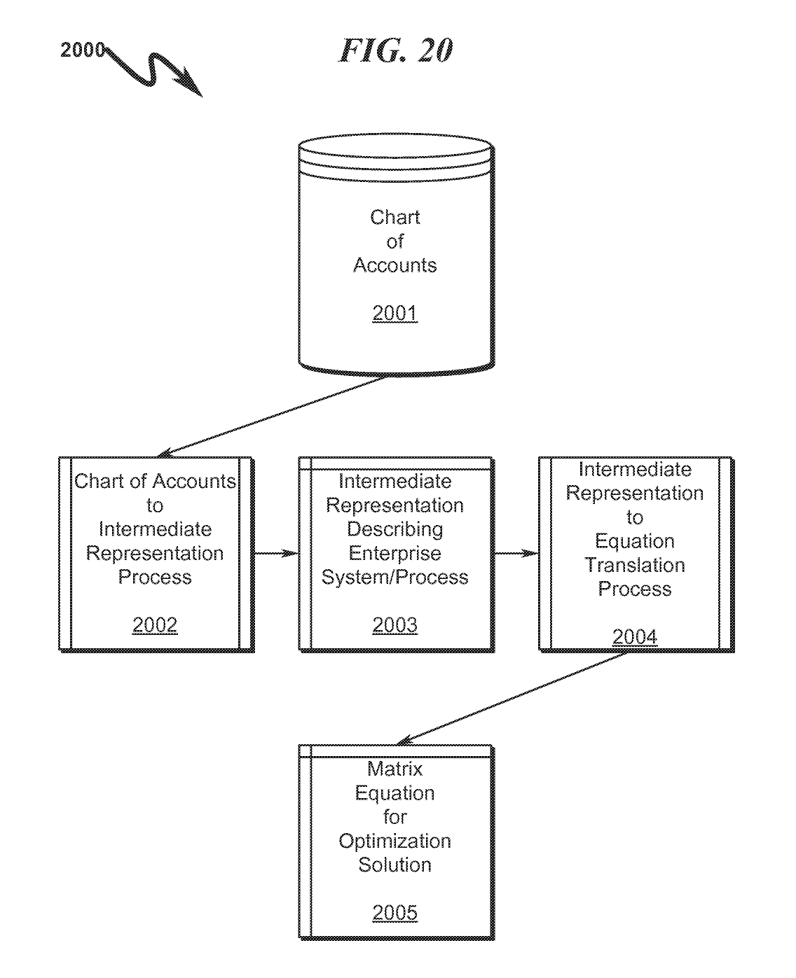

One preferred embodiment of the present invention as generally illustrated in FIG. 20 (2000) permits translation of a financial chart of accounts (COA) (2001) by a chart-of-accounts-to-intermediate-representation translator (2002) to an intermediate representation (2003) that is subsequently translated by an intermediate-representation-to-equation translator (2004) to an equation matrix (2005) that is solved for an optimal enterprise system/process solution. This architecture implements a method for transforming a financial chart of accounts (COA) into a linear programming representation in a two-step process required to solve large industrial problems that can then be solved to determine optimal enterprise configuration(s).

### Chart of Accounts/Operational Activity to Equation Matrix (2100)

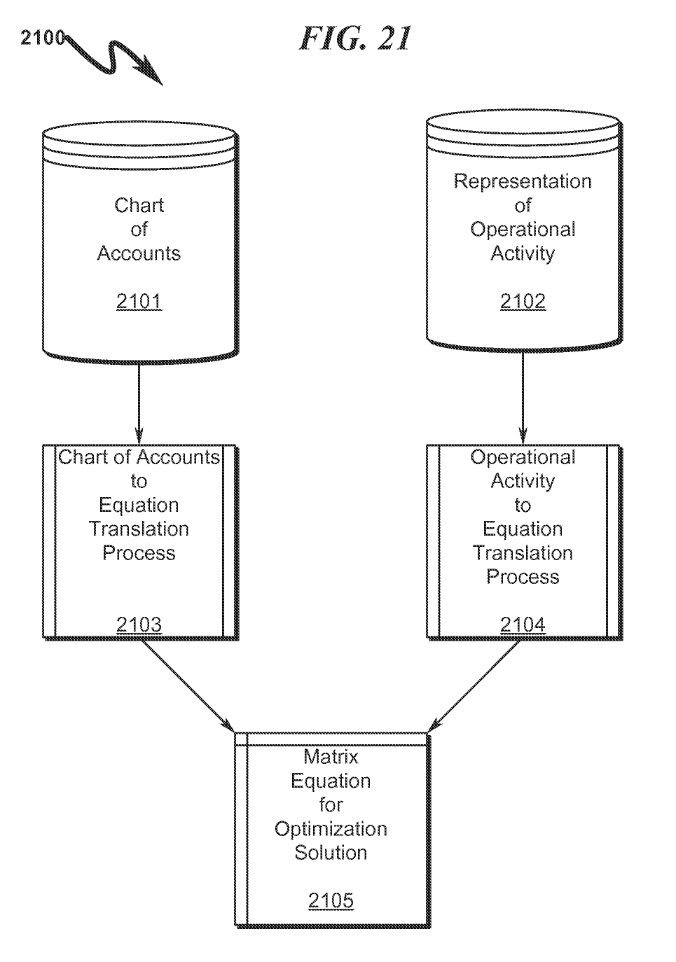

One preferred embodiment of the present invention as generally illustrated in FIG. 21 (2100) permits translation of a financial chart of accounts (COA) (2101) and operational activity information (2102) by a chart-of-accounts-to-equation-matrix translator (2103) and operational-activity-to-equation-matrix translator (2104) to an equation matrix (2105) that is solved for an optimal enterprise system/process state space. This architecture implements a method for translating a financial chart of accounts (COA) and a representation of operational activity into a linear programming representation that can then be solved to determine optimal enterprise configuration(s).

### Sparse Matrix Relationship Linkage Scope (2200)

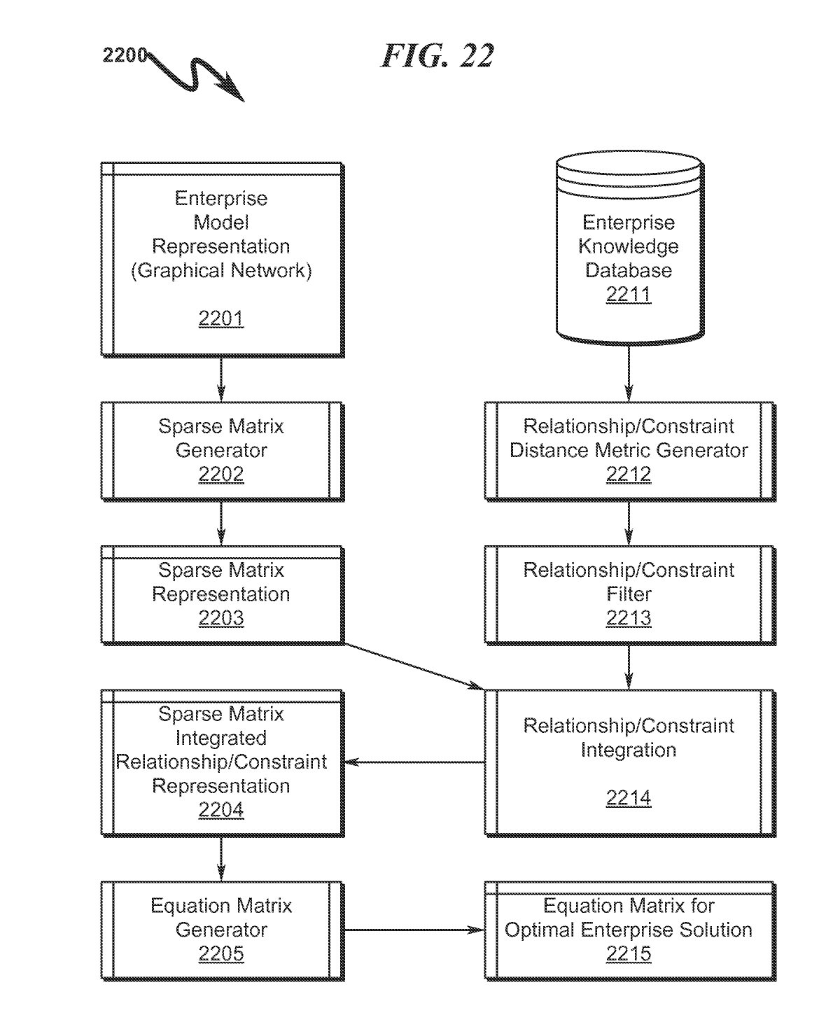

Several preferred embodiments of the present invention incorporate a method structure as generally illustrated in FIG. 22 (2200) to integrate enterprise business information into equation matrices for solution of optimal enterprise configurations. In this exemplary architecture the enterprise is modeled using a GUI graphical network (2201) and a sparse matrix generator (2202) generates a mathematical representation of the enterprise system/method in one of a number of sparse matrix forms (2203). This intermediate form generally contains the PICIS nodes and their relationships as defined previously.

However, there is additional enterprise system/process information that can be integrated into this framework to produce more optimal enterprise solution results. The present invention in some preferred embodiments utilizes an enterprise knowledge database (2211) to provide information specific to particular industries and other enterprise configurations to optimize enterprise solutions. The database (2211) accomplishes this by determining what relationships within the enterprise model are relevant and should be included and which relationships are irrelevant to a particular analysis. A relationship/constraint filter (2213) determines the relevance of each constraint relationship and determines if the relationship should be represented. If the relationship/constraint is relevant to the enterprise model (2203), the relationship/constraint is included in the mathematical representation (2204). This methodology used within the present invention permits the intermediate sparse matrix generation to incorporate relationships/constraints that are relevant (or deemed important by the enterprise knowledge database (2211)) and ignore many others that would drastically increase the computational complexity of generating the mathematical representation. Thus, by incorporating enterprise knowledge within the process that augments the intermediate form of the mathematical representation, the present invention is capable of incorporating information relevant to the overall enterprise optimization but at the same time reducing the incorporation of this information into the matrix in a computationally tractable manner.

### Optimized Enterprise Product-By-Process Result (2300)

The present invention includes the optimized enterprise product-by-process associated with the resulting enterprise system/process modeling (ESPO) methods described herein. It should be noted that the complexity and intractable nature of the feed-forward and feedback relationships within even a moderately complex enterprise model make analysis of these systems impossible using human effort. What further complicates this analysis by any form of manual methodology is the feed-forward and feedback relationship network of relationships, constraints, and/or objectives between the enterprise system/process resources cannot be deterministically defined to form a non-regressive solution state space. Since the prior art does not teach any methodology of achieving these optimal enterprise system/process configurations, the present invention in some embodiments encompasses these enterprise system/process solution state spaces as defined by the operation of the disclosed enterprise system/process modeling method running under operation of the disclosed enterprise system/process modeling system.

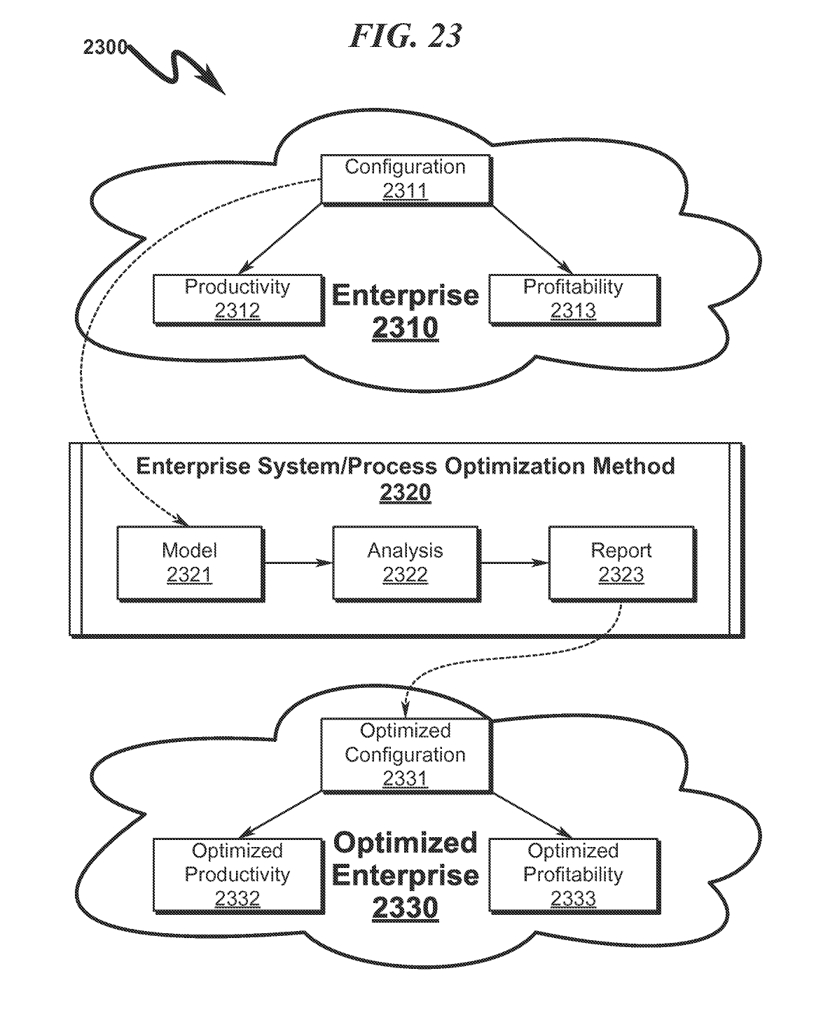

As generally illustrated in FIG. 23 (2300), the optimized enterprise product-by-process is generated by taking a conventional enterprise system/process (2310) having configuration parameters (2311) resulting in corresponding productivity (2312) and profitability (2313) and applying an enterprise system/process modeling method (2320) wherein the enterprise and its associated configuration (2311) is modeled (2321), analyzed/optimized (2322), and the resulting optimized analysis used to produce a report (2323) for user review. The reporting result (1823) of the optimization process (2322) is then used to reconfigure (2331) an optimized enterprise (2330) that results in optimized productivity (2332) and corresponding optimized profitability (2333).

In contrast to the prior art, the optimized enterprise (2330) may constitute a dynamic solution state space that may be further optimized in response to events external to the enterprise and/or may be dynamically modified based on events occurring within the enterprise state space. In this manner, the product-by-process is always optimal with respect to the objectives of enterprise optimization and results in an optimized configuration (2331), productivity (2332), and profitability (2333) that are not achievable using baseline enterprise (2310) configuration (2311) parameters.

### Optimized Enterprise Product-By-Process Configuration

Within the context of the present invention as applied to a product-by-process result system/process configuration result obtained as a result of enterprise modeling using the present invention system/method, the resulting system/process configuration will be optimal with respect to the constraints evaluated by the present invention. Within this context, the present invention discloses and anticipates an optimized enterprise system/process product-by-process configuration resulting from application of an enterprise system/process modeling method on a baseline enterprise system/process configuration, the method comprising:
(1) generating, defining, and/or modifying an enterprise system/process model that functionally describes the operation of the baseline enterprise system/process in terms of processes, resources, constraints, and objectives;
(2) integrating constraints within an enterprise model equation matrix to represent and define relationships between processes and resources contained within the enterprise system/model;
(3) solving the enterprise model equation matrix to generate an optimal enterprise solution;
(4) generating reports based on the optimal enterprise solution; and
(5) determining if user and/or enterprise optimization objectives have been met, and if not, proceeding to the step (1).

One skilled in the art will recognize that these method steps may be augmented or rearranged without limiting the teachings of the present invention.

### Optimized Enterprise Product-By-Process Configuration Via COR Method

The present invention also discloses a COR method that will result in an optimized enterprise configuration.

Within this context, the present invention discloses and anticipates an optimized enterprise system/process product-by-process configuration resulting from application of an enterprise system/process Constraint Oriented Reasoning (COR) optimization method on a baseline enterprise system/process configuration, the method comprising:
(1) capturing an enterprise system/process domain expert knowledge database, the database containing information on the functionality and relationships within and across elements of the enterprise system/process domain;
(2) decomposing the captured knowledge within the domain expert knowledge database into primitive component elements, and associating properties with the primitive elements;
(3) performing a self-consistency check across the knowledge database and modifying the database as necessary to validate the knowledge database contents;
(4) determining if the capture of the domain expert knowledge database is complete, and if not, proceeding to the step (1);
(5) embedding the collected domain expert knowledge database into the enterprise system/process model primitives associated with a graphical user interface (GUI) enterprise system/process modeling subsystem;
(6) capturing an enterprise system/process model (further comprising resources, relationships, constraints, and/or objectives) describing a baseline enterprise system/process configuration via the GUI and evaluating optimal solutions for the captured enterprise system/process model using an equation matrix generated from the captured enterprise system/process model; and
(7) terminating the enterprise system/process constraint oriented reasoning method.
   One skilled in the art will recognize that these method steps may be augmented or rearranged without limiting the teachings of the present invention.

### Enterprise Product-By-Process Configuration—Intermediate Form Method

The present invention also discloses a method utilizing intermediate form representation of the enterprise model that will result in an optimized enterprise configuration. Within this context, the present invention discloses and anticipates an optimized enterprise system/process product-by-process configuration resulting from application of an enterprise system/process modeling method on a baseline enterprise system/process configuration, the method comprising:
(1) defining the baseline enterprise system/process configuration using a graphical user interface;
(2) extracting required enterprise resources from the enterprise system/process definition;
(3) extracting the required enterprise constraints from the enterprise system/process definition;
(4) extracting required enterprise objectives from the enterprise system/process definition;
(5) generating an intermediate data structure form of the enterprise system/process definition and applying the enterprise constraints to the resulting intermediate data structure;
(6) generating an equation matrix from the intermediate data structure that integrates the enterprise system/process definition with the enterprise constraints;
(7) evaluating the equation matrix with a matrix solver to generate an optimal solution state space for the enterprise system/process definition;
(8) generating any requested reports from the optimal solution state space;
(9) determining if user and/or enterprise optimization objectives have been met, and if not, proceeding to the step (1);
(10) terminating the enterprise system/process modeling method.
   One skilled in the art will recognize that these method steps may be augmented or rearranged without limiting the teachings of the present invention.

### Enterprise Model Definition Subsystem Overview Method (2400)

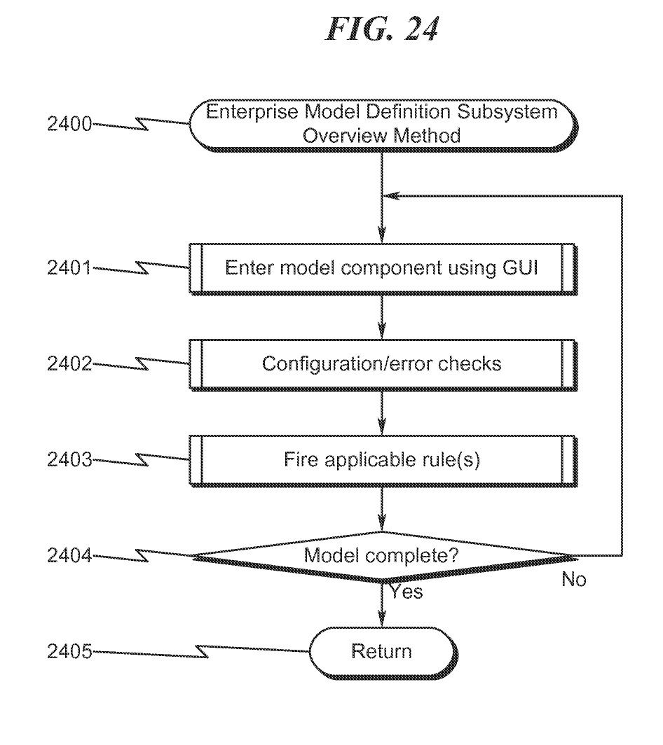

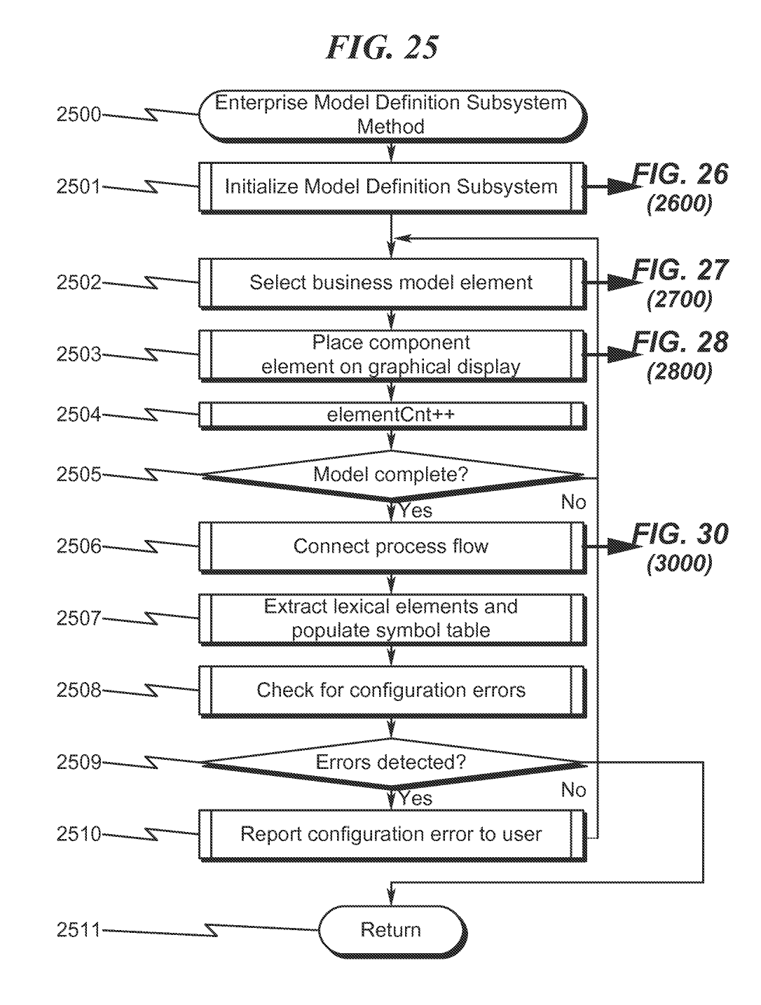

A broad overview of an exemplary enterprise model definition subsystem method as applicable to the enterprise definition subsystem (FIG. 1 (0100) (0101)) is generally illustrated in FIG. 24 (2400), wherein the method comprises the following steps:
(1) entering a model component element using a GUI (2401);
(2) performing configuration and error checks (2402);
(3) firing applicable rules associated with the model element component and its relationships between other model component elements (2403);
(4) determining if the enterprise model is complete, and if not, proceeding to step (1) (2404); and
(5) Terminating the method (2405).
   One skilled in the art will recognize that these method steps may be augmented or rearranged without limiting the teachings of the present invention. More detail associated with this method overview is provided in the method flowchart of FIG. 25 (2500).

### Enterprise Model Definition Subsystem Method (2500)

As generally illustrated in FIG. 25 (2500), a preferred exemplary implementation of the present invention enterprise model definition subsystem (FIG. 1 (0100) (0101)) may be implemented as a method, wherein the method comprises the following steps:
(1) Initializing the model definition subsystem (2501);
(2) Selecting a business model element (2502);
(3) Placing the component element on a graphical display (2503);
(4) Incrementing a component element counter (2504);
(5) Determining if the enterprise model is complete, and if not, proceeding to step (2) (2505);
(6) Connecting the process flow in the model (2506);
(7) Extracting lexical elements within the model and populating a symbol table (2507);
(8) Checking for configuration errors in the model (2508);
(9) If errors are not detected, proceeding to step (11) (2509);
(10) Reporting configuration errors to the user and proceeding to step (2) (2510); and
(11) Terminating the method (2511).
   One skilled in the art will recognize that these method steps may be augmented or rearranged without limiting the teachings of the present invention.

### Initialize Model Definition Subsystem Method (2600)

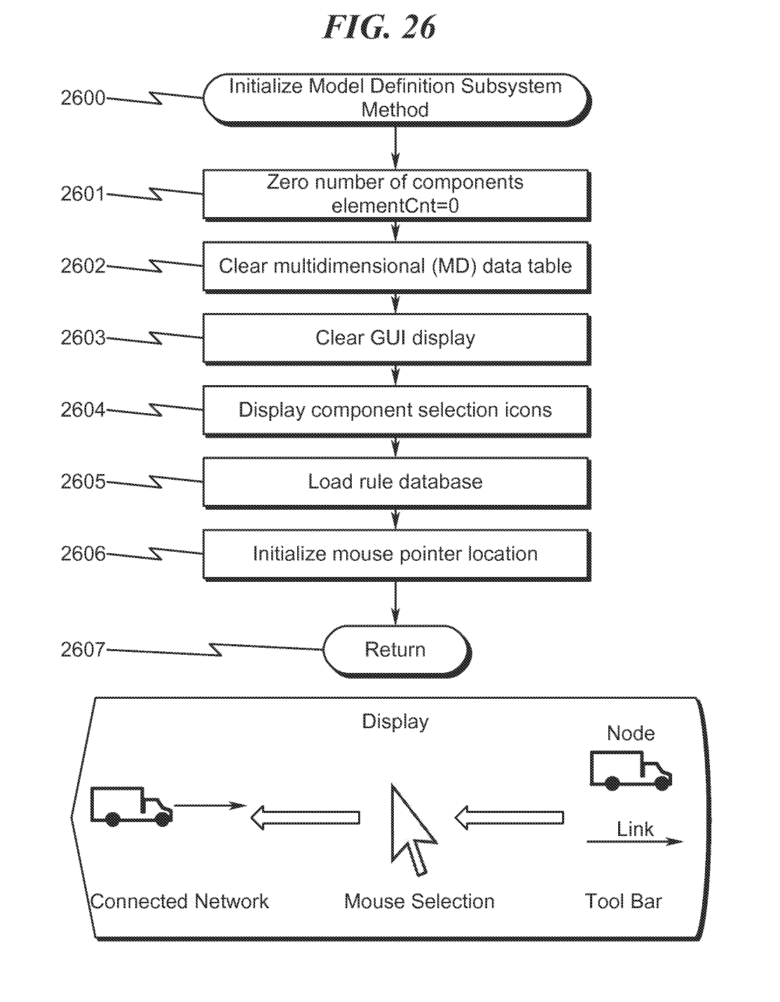

As generally illustrated in FIG. 26 (2600), a preferred exemplary implementation of a model subsystem initialization method is depicted as a flowchart, wherein the method comprises the following steps:
(1) Zeroing the number of model component elements (2601);
(2) Clearing a multidimensional (MD) data structure table (2602);
(3) Clearing the GUI display (2603);
(4) Displaying one or more model component element selection icons (2604);
(5) Loading a rules database to determine the operation of model component elements (2605);
(6) Initializing a mouse/GUI pointer location (2606); and
(7) Terminating the method (2607).
   One skilled in the art will recognize that these method steps may be augmented or rearranged without limiting the teachings of the present invention.

### Select Business Model Component Element Method (2700)

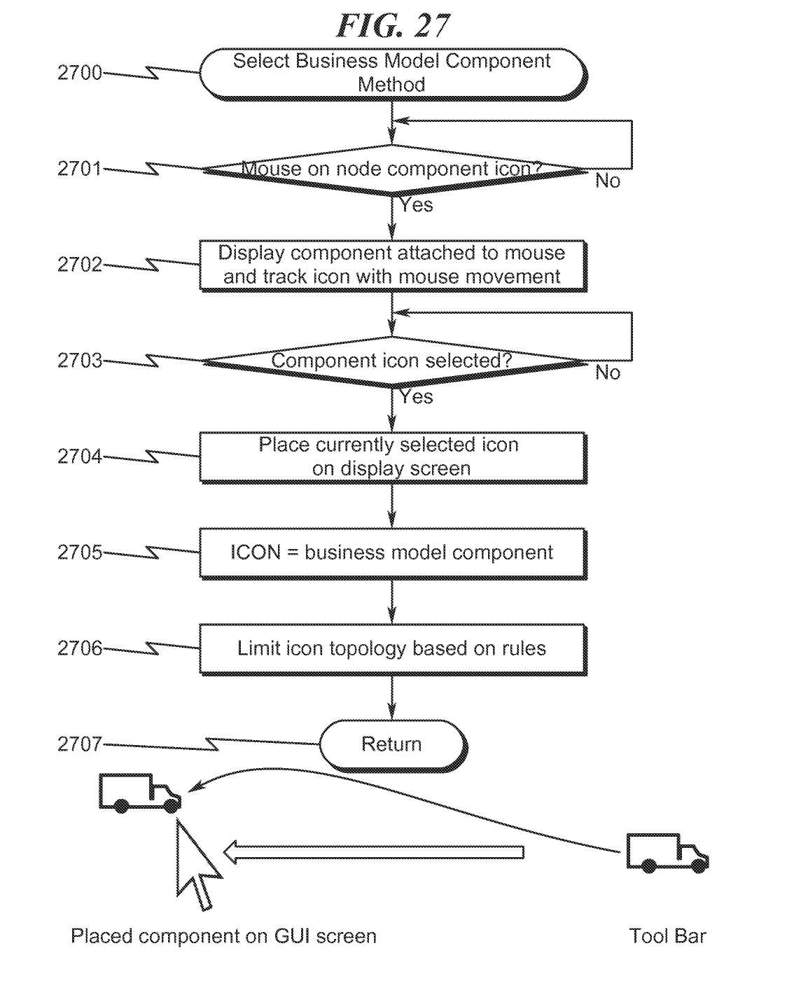

As generally illustrated in FIG. 27 (2700), a preferred exemplary implementation of a model subsystem business model component element selection method is depicted as a flowchart, wherein the method comprises the following steps:
(1) Determining if the mouse/GUI pointer is on a model component element icon, and if not, proceeding to step (1) (2701);
(2) Displaying the model component element attached to the mouse/GUI pointer and tracking the icon with mouse/GUI pointer movement (2702);
(3) If the model component element is not selected, proceeding to step (3) (2703);
(4) Placing the currently selected model component element on the GUI display screen (2704);
(5) Setting the ICON variable to the currently selected business model component element (2705);
(6) Limiting the ICON topology based on a rules database (2706); and
(7) Terminating the method (2707).
   One skilled in the art will recognize that these method steps may be augmented or rearranged without limiting the teachings of the present invention.

### Place Business Model Icon Method (2800, 2900)

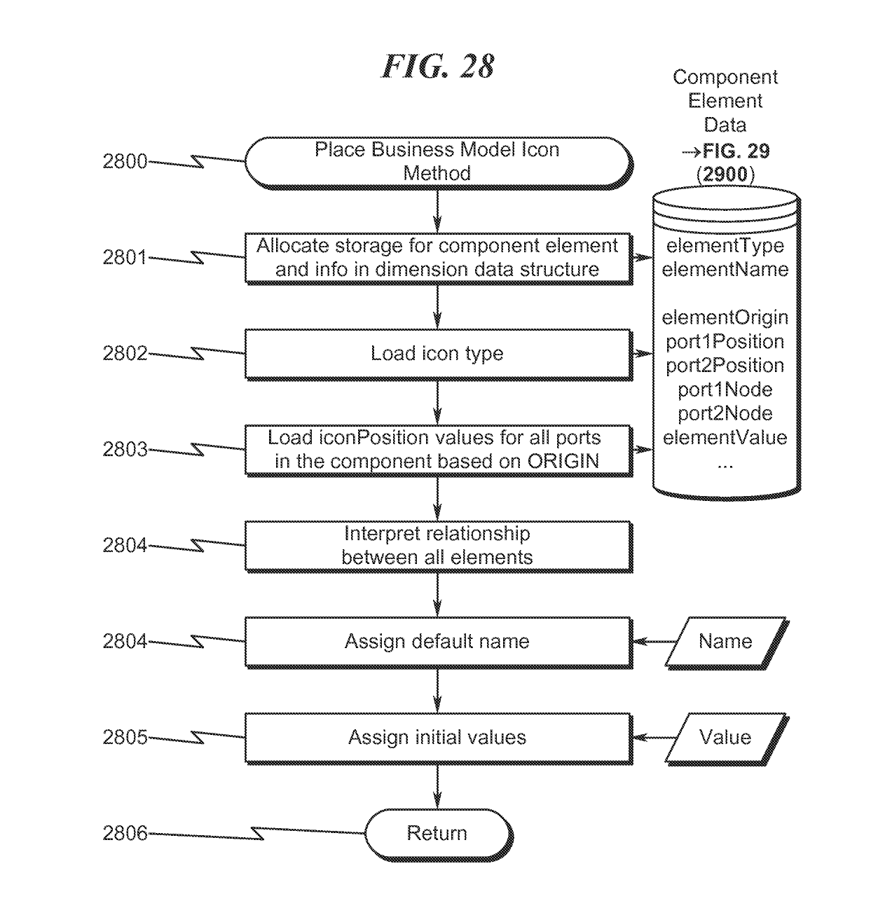

As generally illustrated in FIG. 28 (2800), a preferred exemplary implementation of a business icon placement method is depicted as a flowchart, wherein the method comprises the following steps:
(1) Allocating storage for the model component element and associated information in a dimension data structure (2801);
(2) Loading the icon type (2802);
(3) Loading the icon position values for all ports in the model component element based on the origin of the icon (2803);
(4) Interpreting relationships between all model component elements in the GUI display (2804);
(5) Assigning a default name for the model component element icon (2805);
(6) Assigning initial values for the model component element icon (2806); and
(7) Terminating the method (2807).
   One skilled in the art will recognize that these method steps may be augmented or rearranged without limiting the teachings of the present invention.

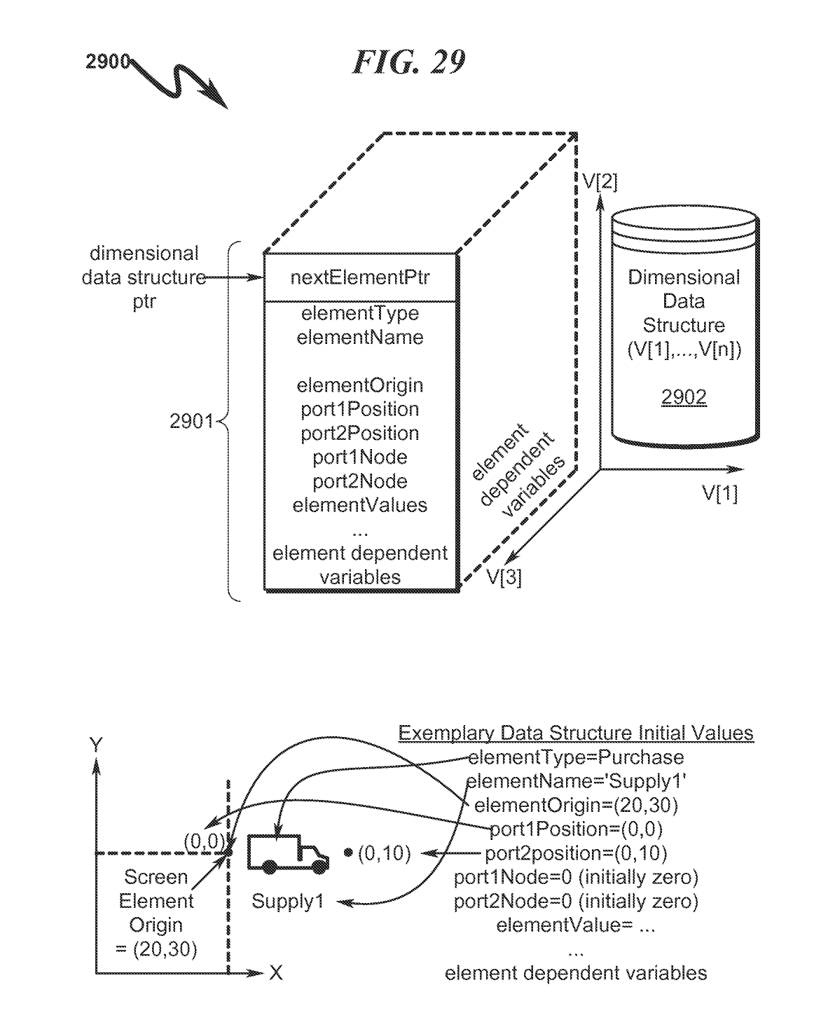

An exemplary data structure in the form of a (multi) dimensional data structure (2901) that may be used to describe the model component element icon is generally illustrated in FIG. 29 (2900). One skilled in the art will recognize that a wide variety of data structures (2902) may be utilized to describe the model component element icon both with respect to the GUI subsystem as well as internal information necessary to define the properties associated with the model component element icon.

### Connect Process Flow Method (3000)

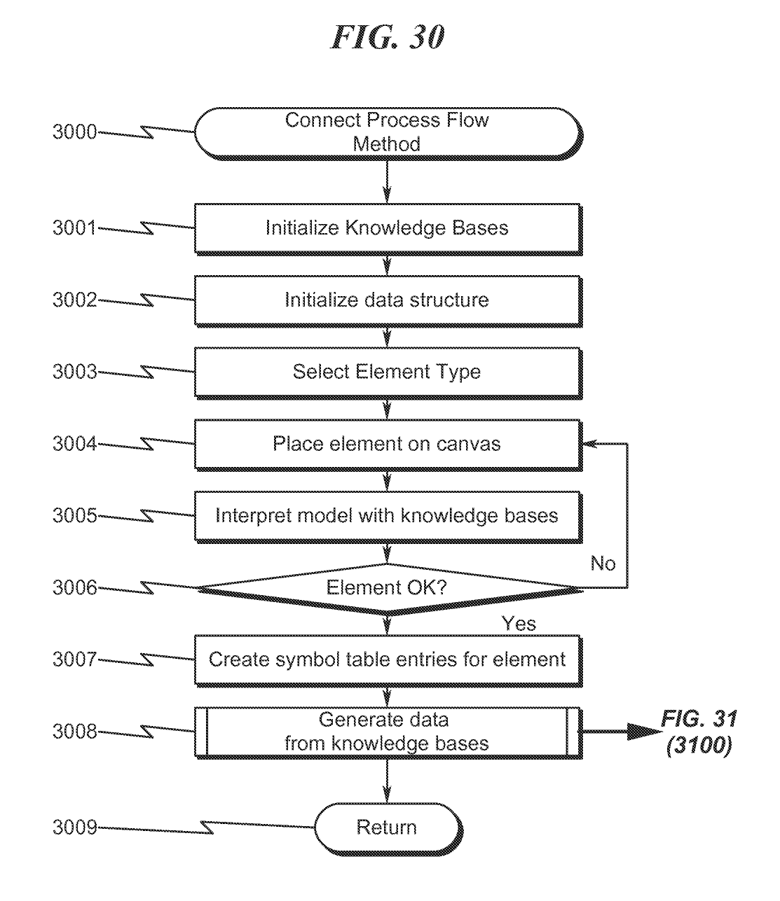

As generally illustrated in FIG. 30 (3000), a preferred exemplary implementation of an enterprise process flow connection method is depicted as a flowchart, wherein the method comprises the following steps:
(1) Initializing knowledge bases from one or more databases that are used to direct the formation of relationships between enterprise model component elements (3001);
(2) Initializing a multidimensional (MD) data structure (3002);
(3) Selecting a model component element type (3003);
(4) Placing the model component element on a canvas (3004);
(5) Interpreting the enterprise model with the knowledge bases (3005);
(6) If there are errors in the model component element or its connectivity, proceeding to step (4) (3006);
(7) Creating a symbol table entry for the model component element (3007);
(8) Generating data from the knowledge bases based on the relationships among the various placed model component elements (3008); and
(9) Terminating the method (3009).
   One skilled in the art will recognize that these method steps may be augmented or rearranged without limiting the teachings of the present invention.

### Knowledge Base Data Generation Method (3100)

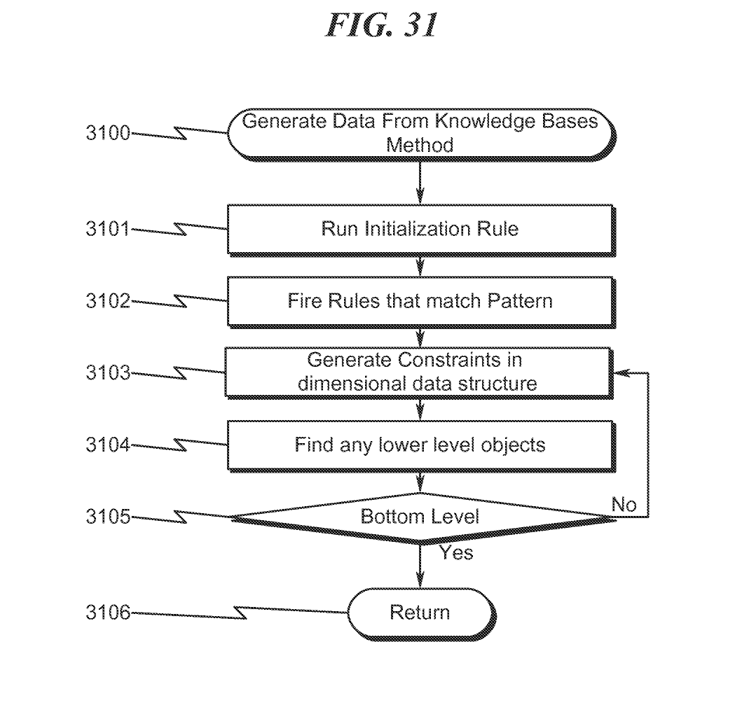

As generally illustrated in FIG. 31 (3100), a preferred exemplary implementation of a knowledge base data generation method is depicted as a flowchart, wherein the method comprises the following steps:
(1) Running an initialization rule (3101);
(2) Firing rules that match a pattern associated with the model component element and its relationships within the GUI display (3102);
(3) Generating constraints within a (multi) dimensional structure (3103);
(4) Finding any lower level objects nested within the model component element (3104);
(5) If the bottom level of model component element has not been reached, proceeding to step (3) (3105); and
(6) Terminating the method (3106).
   One skilled in the art will recognize that these method steps may be augmented or rearranged without limiting the teachings of the present invention.

### Model Processing Subsystem Overview Method (3200)

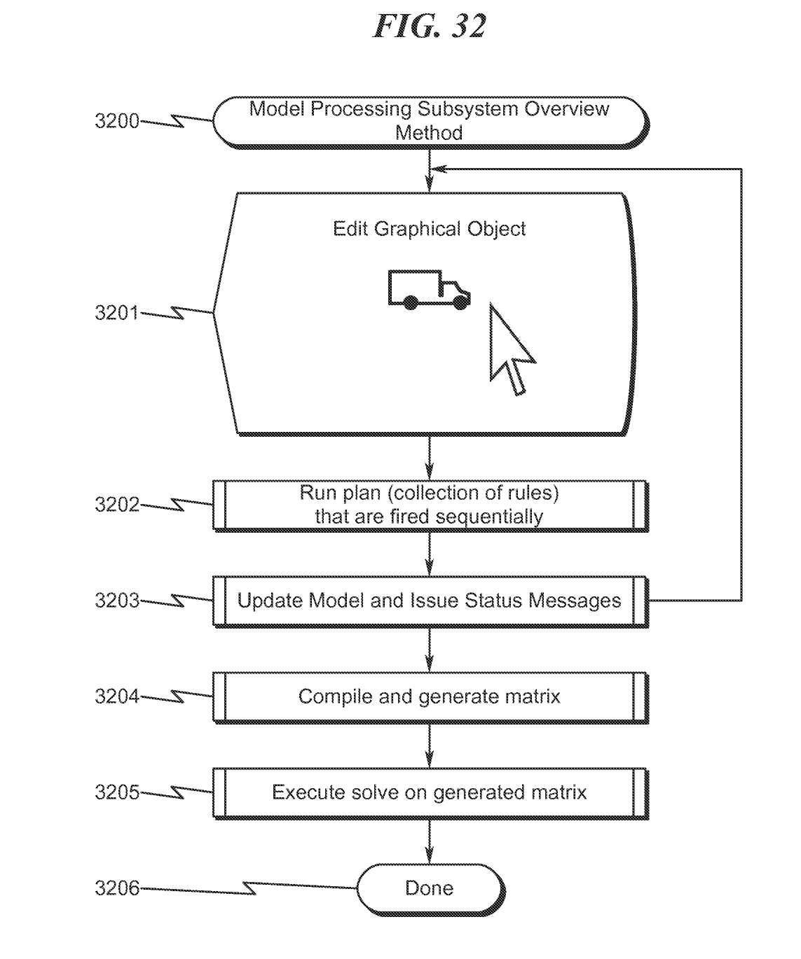

As generally illustrated in FIG. 32 (3200), a preferred exemplary implementation of a model processing subsystem overview method is depicted as a flowchart, wherein the method comprises the following steps:
(1) Editing a graphical object (3201);
(2) Running a plan (collection of sequentially fired rules) on the graphical object and its associated model component element (3202);
(3) Updating the model and issuing status messages based on the results of the plan with optional return to step (1) (3203);
(4) Compiling and generating a matrix for solution (3204);
(5) Executing a solve on the generated matrix to produce an enterprise model solution (3205); and
(6) Terminating the method (3206).
   One skilled in the art will recognize that these method steps may be augmented or rearranged without limiting the teachings of the present invention.

Specific implementation details of this general overview method are provided in subsequent description sections with corresponding references to drawings following FIG. 32 (3200).

### Model Processing Subsystem Method (3300)

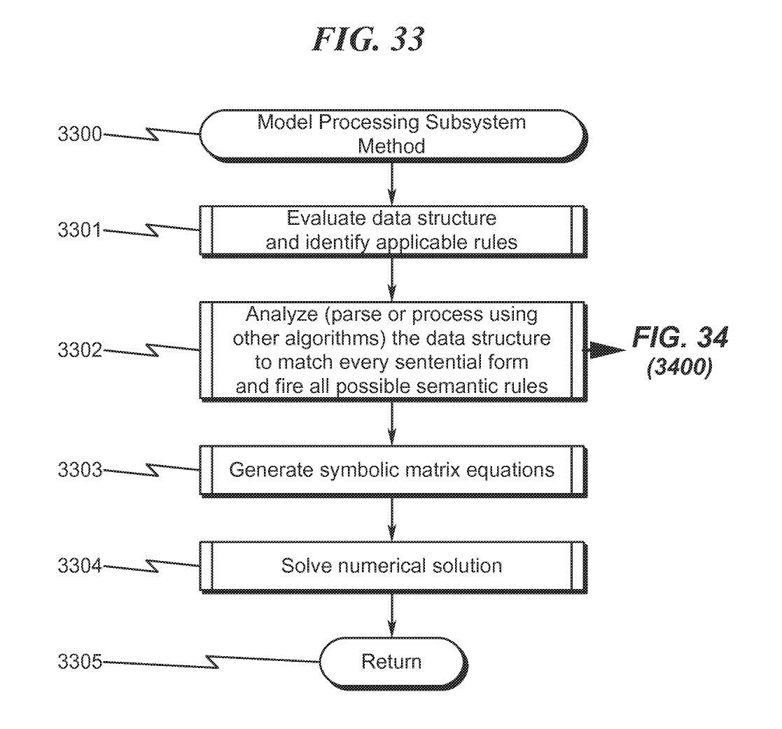

As generally illustrated in FIG. 33 (3300), a preferred exemplary implementation of the present invention enterprise model processing subsystem (FIG. 1 (0100) (0102)) may be implemented as a method, wherein the method comprises the following steps:
(1) Evaluating a data structure associated with the model component element(s) and identifying applicable rules associated with the model component element(s) and their relationships (3301);
(2) Analyzing (parsing or processing using other algorithms) the data structure to match every sentential form and firing all possible semantic rules (3302);
(3) Generating symbolic matrix equations using the results from step (2) (3303);
(4) Solving a numerical solution from the symbolic matrix equations generated in step (3) (3304); and
(5) Terminating the method (3305).
   One skilled in the art will recognize that these method steps may be augmented or rearranged without limiting the teachings of the present invention.

### Parsing Method (3400)

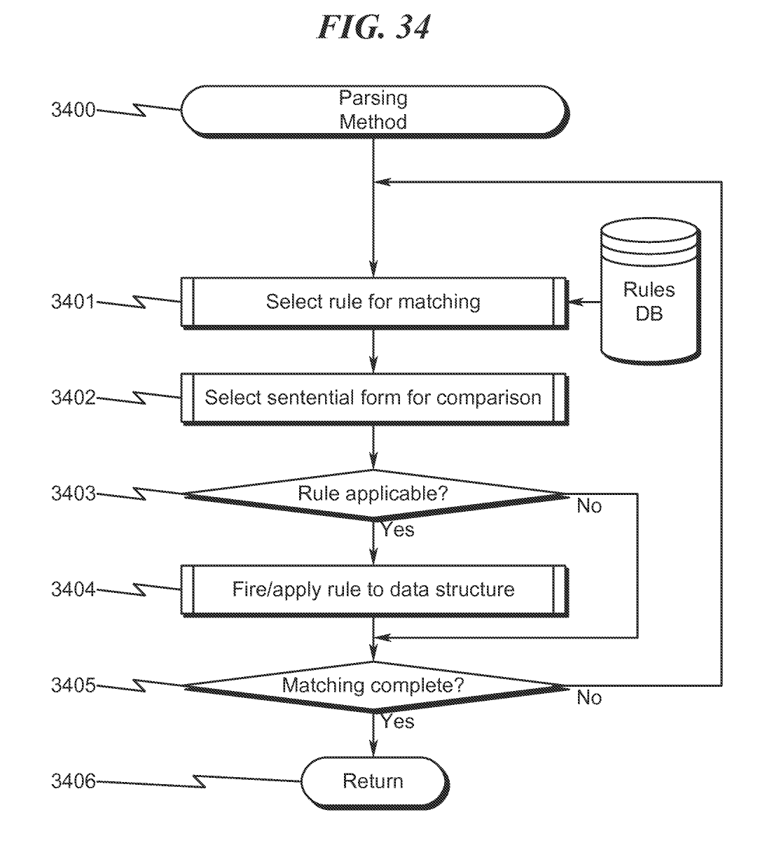

As generally illustrated in FIG. 34 (3400), a preferred exemplary implementation of a model parsing method is depicted as a flowchart, wherein the method comprises the following steps:
(1) Selecting a rule for matching (3401);
(2) Selecting a sentential form for comparison (3402);
(3) If the selected rule is not applicable, proceeding to step (5) (3403);
(4) Firing/applying the rule to the data structure (3404);
(5) Determining if all potential rules have matched, and if not, proceeding to step (1) (3405); and
(6) Terminating the method (3406).
   One skilled in the art will recognize that these method steps may be augmented or rearranged without limiting the teachings of the present invention.

Generally speaking, the present invention anticipates that optimal embodiments of the invention will only fire/apply a given rule to the data structure a maximum of one time.

### Exemplary Chart of Accounts Rule Method (3500)

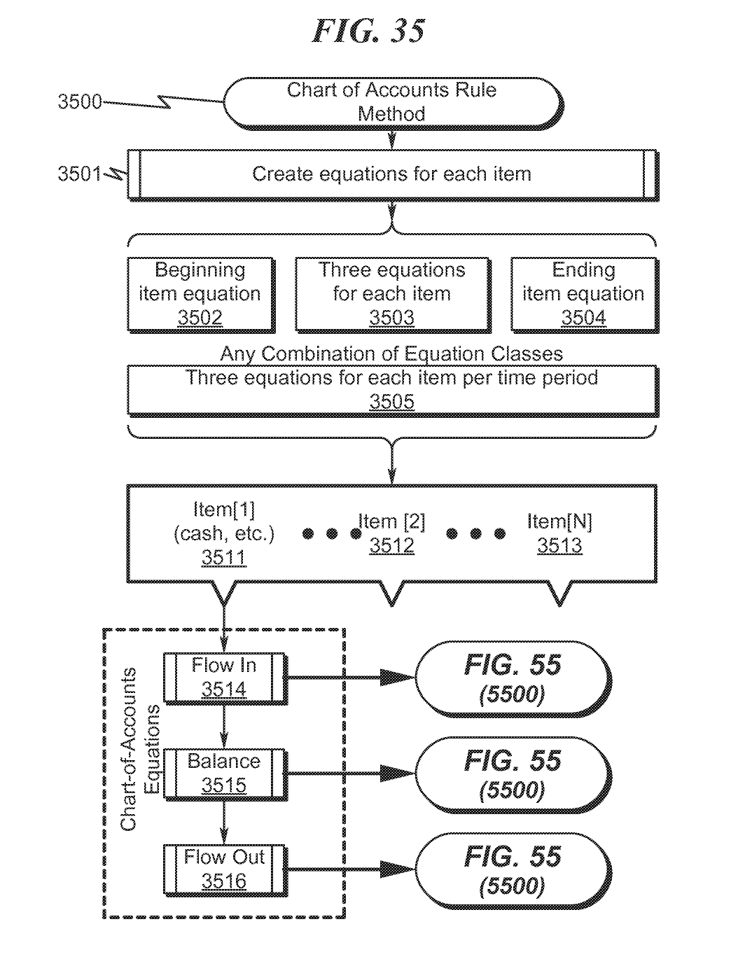

The present invention may incorporate a plurality of rules that are fired/applied to a given model component element configuration. As generally illustrated in FIG. 35 (3500), a preferred exemplary implementation of a chart of accounts (COA) rule method is depicted as a flowchart, wherein the method comprises the following steps:
(1) Creating equations for each item in the chart of accounts (COA) (3501), wherein the equations comprise any combination of the following:
(2) Creating a beginning item equation (3502),
(3) Creating three equations for each item (flow input (3514), balance (3515), and flow output (3516) equations) (3503),
(4) Creating an ending item equation (3504);
(5) Creating three equations for each item per time period (3505);
(6) Terminating the method (3506).
   One skilled in the art will recognize that these method steps may be augmented or rearranged without limiting the teachings of the present invention.

### Multiple Time Period Aging Method (3600)

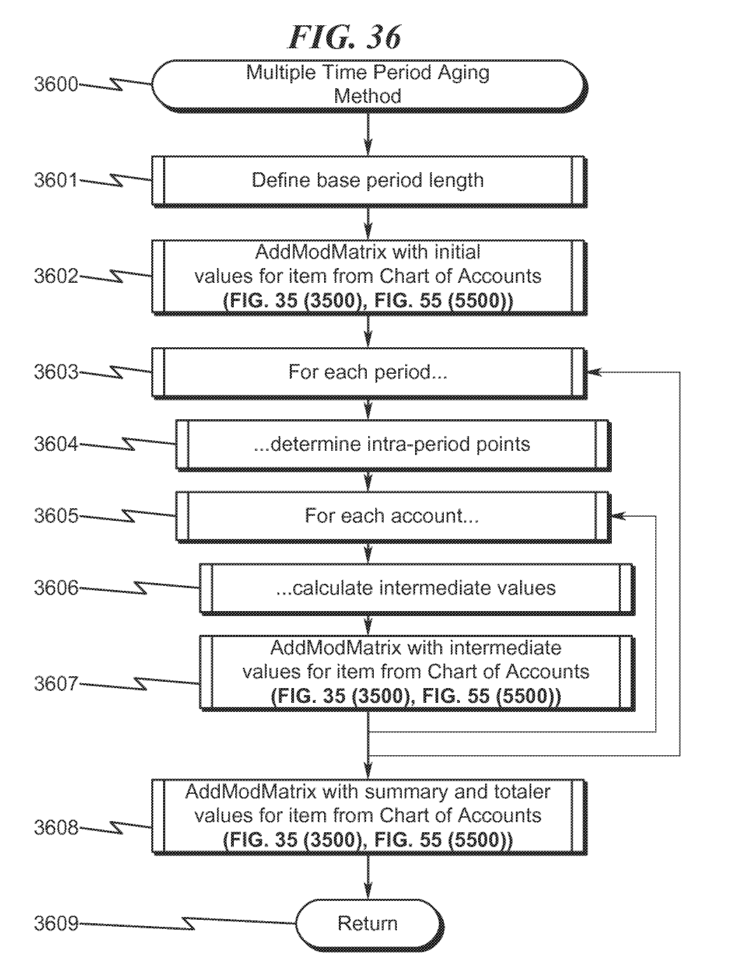

The present invention may be advantageously applied to situations in which multiple time period aging analysis to items within a chart of accounts (COA) is desired. As generally illustrated in FIG. 36 (3600), a preferred exemplary implementation of a chart of accounts (COA) multiple time period aging method is depicted as a flowchart, wherein the method comprises the following steps:
(1) defining a base period length (3601);
(2) modifying a matrix with initial values for an item from a Chart of Accounts (COA) (3602);
(3) for each time period to be evaluated, determining intra-period points (3603);
(4) for each account to be evaluated, calculating intermediate values for the item (3604);
(5) modifying the matrix with the intermediate values for the item from the Chart of Accounts (COA) (3605);
(6) proceeding to step (5) for the each account to be evaluated (3606);
(7) proceeding to step (3) for the each time period to be evaluated; (3607) and
(8) modifying the matrix with summary and totaler values for the item from the Chart of Accounts (COA) (3608).
   One skilled in the art will recognize that these method steps may be augmented or rearranged without limiting the teachings of the present invention.

### Set of Equations Matrix Generation Method (3700)

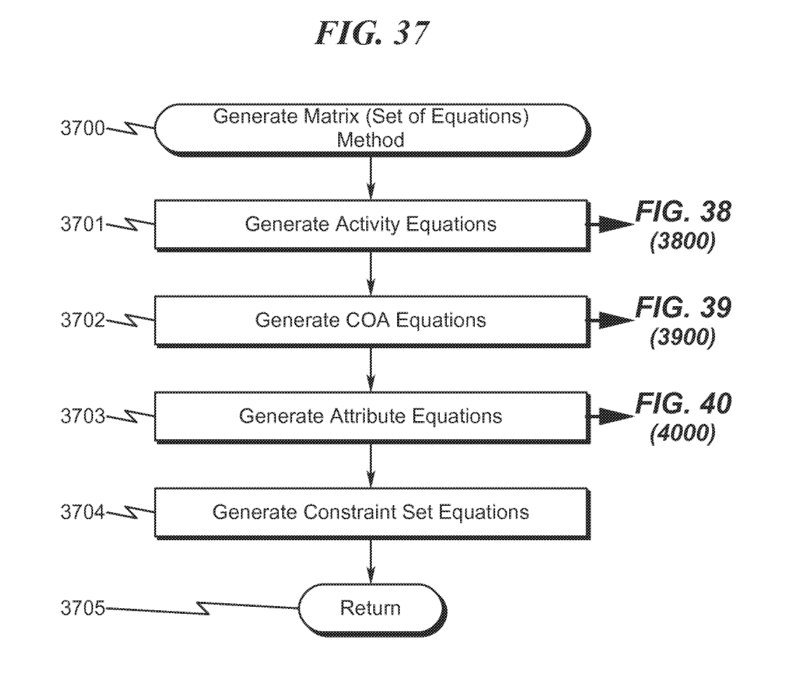

As generally illustrated in FIG. 37 (3700), a preferred exemplary implementation of a model subsystem initialization method is depicted as a flowchart, wherein the method comprises the following steps:
(1) Generating activity equations (3701);
(2) Generate chart-of-account (COA) equations (3702);
(3) Generate attribute equations (3703);
(4) Generate constraint set equations (3704); and
(5) Terminating the method (3705).
   One skilled in the art will recognize that these method steps may be augmented or rearranged without limiting the teachings of the present invention.

### Generate Activity Equations Method (3800)

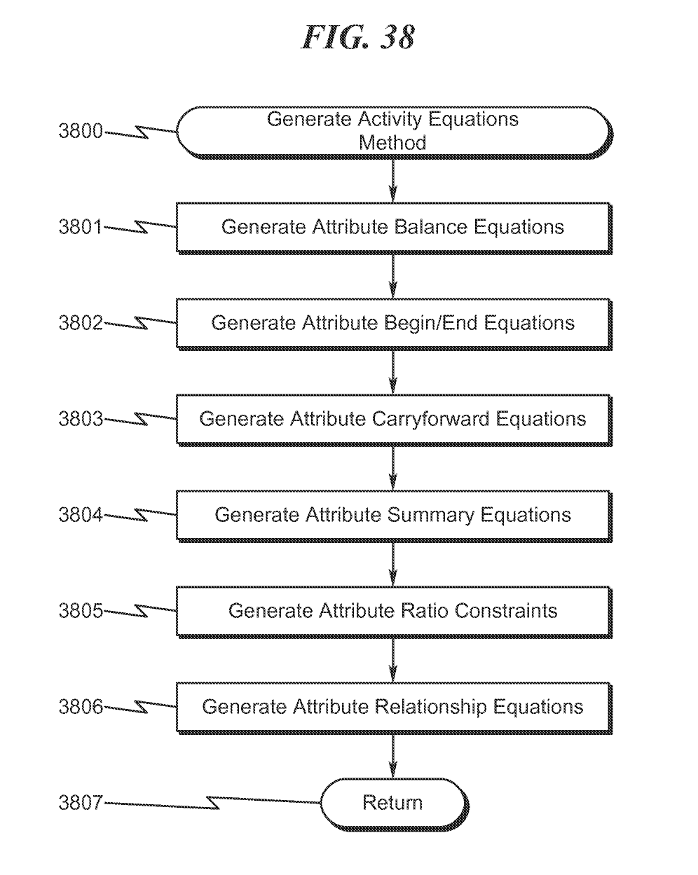

As generally illustrated in FIG. 38 (3800), a preferred exemplary implementation of an activity equations generation method is depicted as a flowchart, wherein the method comprises the following steps:
(1) Generate attribute balance equations (3801);
(2) Generate attribute begin/end equations (3802);
(3) Generate attribute carry forward equations (3803);
(4) Generate attribute summary equations (3804);
(5) Generate attribute ratio constraints (3805);
(6) Generate attribute relationship equations (3806); and
(7) Terminating the method (3807).
   One skilled in the art will recognize that these method steps may be augmented or rearranged without limiting the teachings of the present invention.

### Chart of Accounts Equation Generation Method (3900)

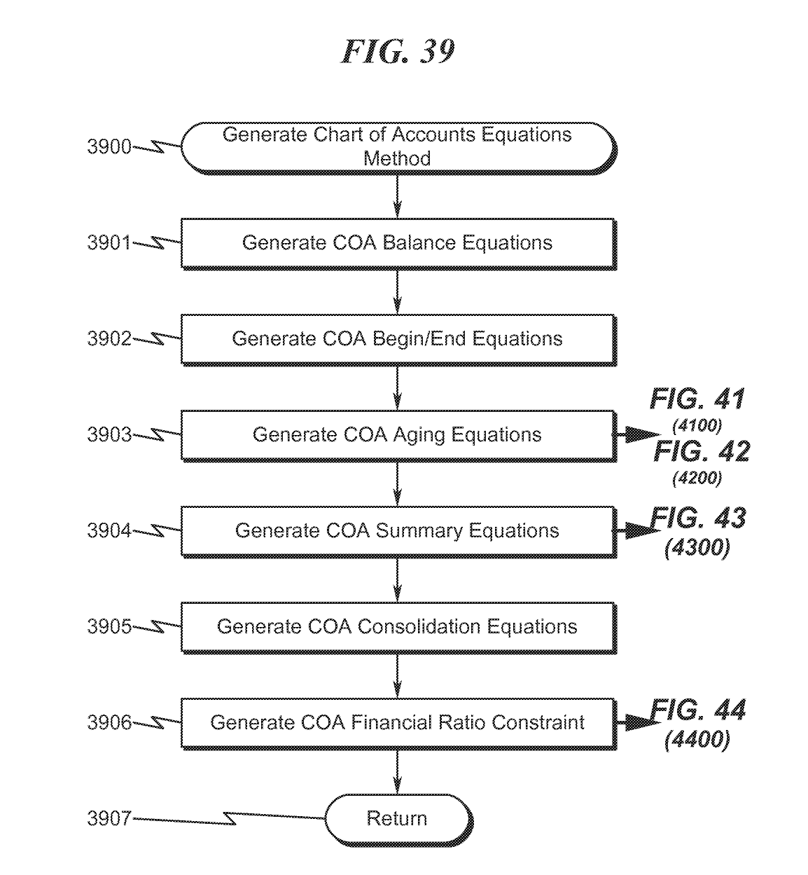

As generally illustrated in FIG. 39 (3900), a preferred exemplary implementation of a chart of accounts (COA) equation generation method is depicted as a flowchart, wherein the method comprises the following steps:
(1) Generate COA balance equations (3901);
(2) Generate COA begin/end equations (3902);
(3) Generate COA aging equations (3903);
(4) Generate COA summary equations (3904);
(5) Generate COA consolidation equations (3905);
(6) Generate COA financial ratio equations (3906);
(7) Generate COA consolidation equations (3907); and
(8) Terminating the method (3908).
   One skilled in the art will recognize that these method steps may be augmented or rearranged without limiting the teachings of the present invention.

### Attribute Equation Generation Method (4000)

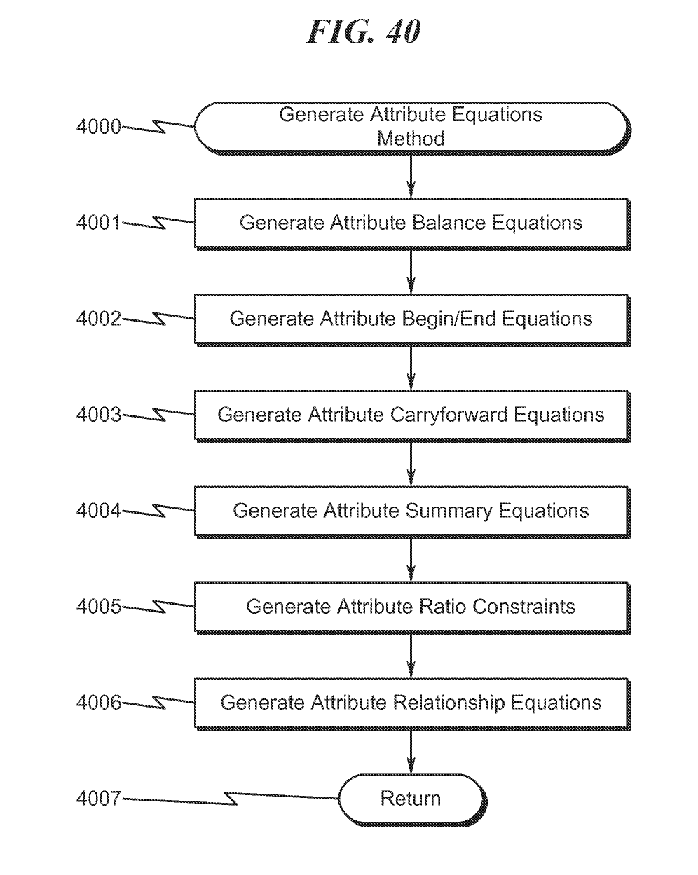

As generally illustrated in FIG. 40 (4000), a preferred exemplary implementation of an attribute equation generation method is depicted as a flowchart, wherein the method comprises the following steps:
(1) Generate attribute balance equations (4001);
(2) Generate attribute begin/end equations (4002);
(3) Generate attribute equations (4003);
(4) Generate attribute carry forward equations (4004);
(5) Generate attribute summary equations (4005);
(6) Generate attribute ratio constraints (4006); and
(7) Terminating the method (4006).
   One skilled in the art will recognize that these method steps may be augmented or rearranged without limiting the teachings of the present invention.

### Account Aging Methodology (4100, 4200, 4300)

### Overview of Account Aging

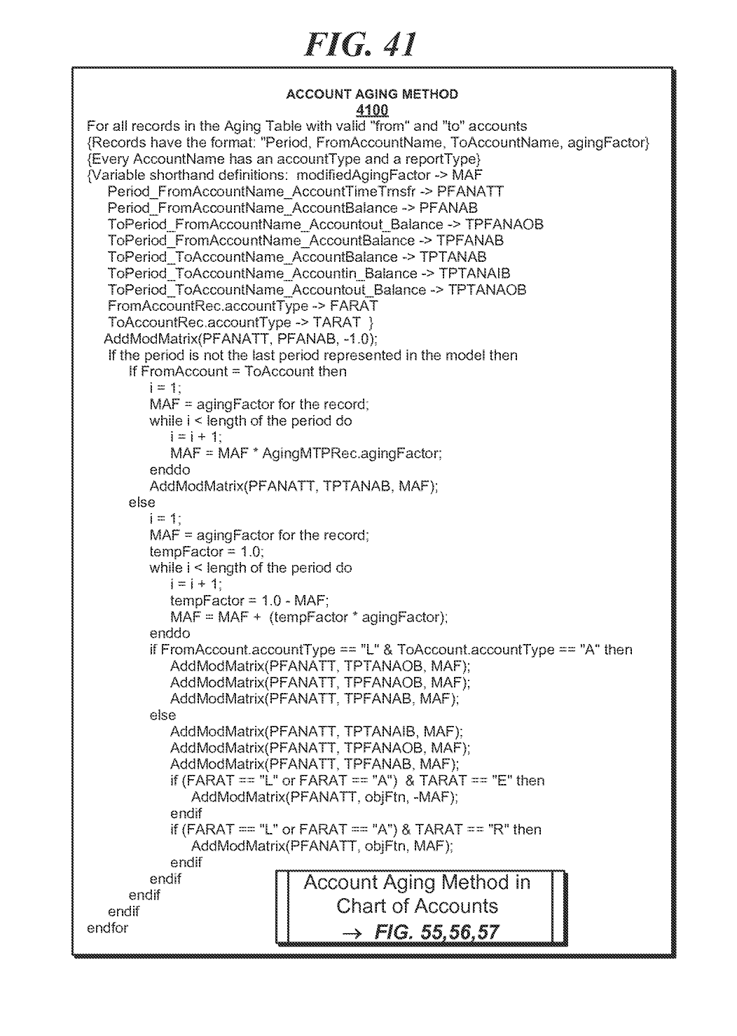

While modeling the financial aspects of an industrial process, it is important to be able to “age” accounts. The present invention allows for a Chart Of Accounts to be generated based on the inputs and constraints of the modeled industrial process. For example, a company will have accounts payable and accounts receivable. It is common practice to provide discounts for early payment of an invoice. Likewise, it is common to accrue expenses for a period of time prior to making cash payments. During the modeling process, a user might choose to model the benefit of making early payments on an invoice or an accrued liability to determine its impact on future cash flow. FIG. 41 (4100) provides illustrative pseudo-code for the aging method.

The present invention in some preferred embodiments allows for the aging of accounts. To obtain accurate results, the user generally provides the number of time periods, the length of each time period, and the account aging rules to be used in the model For instance, an enterprise model intended for use in analyzing investment options may comprise nine time periods; Month1, Month2, Month3, Quarter2, Quarter3, Quarter4, Year2, Year3, Years4 and 5. Periods Month1, Month2 and Month3 have a length of one month, a commonly used period length for analyses involving account aging. Periods Quarter2, Quarter3 and Quarter4 have a length of 3 months each. Year2 and Year3 have a length of 12 months each and period Years-4-and-5 have a length of 24 months. An aging rule for Accounts Receivable might be, “Every month, 20% of Accounts Receivable is aged to Cash and 80% is aged to Accounts Receivable.”

Applying the aging rule for Accounts Receivable in this scenario is problematic. For example, assume that at the beginning of Month1, the balance of Accounts Receivable is $0 and during Month1, sales activity resulted in an Accounts Receivable balance of $100. At the end of the period, the application of the aging rule should result in an increment to the Cash balance of $20 and an Accounts Receivable balance of $80.

To understand one aspect of problematic account aging, now consider Quarter2, which has a length of 3 months. Assume that the beginning balance for Accounts Receivable is $100 and during Quarter2, sales activity has increased this balance by $300, resulting in a $400 balance. At the end of period Quarter2, how should the account aging rule be correctly applied? One possibility would be to repeat the process used for Month1. This would result in an increment to the Cash balance of $80 and an Accounts Receivable balance of $320.

Applying the account aging rule using the same process in Quarter2 as was used in Month1 is clearly incorrect. Since the length of Quarter2 is three months, Quarter2 actually represents three account aging events. If the sales activity in Quarter2 all occurred very early in the period, the $300 added to Accounts Receivable should be aged three times, not once. At the very least, the balance in Accounts Receivable carried over from the previous period should be aged three times. Focusing solely on the $300 incremental increase in Accounts Receivable made during Quarter2, the result of the first account aging process would increase Cash by $60 and leave an Accounts Receivable balance of $240. The result of the second account aging process would increase Cash by $48 and leave an Accounts Receivable balance of $192. The result of the third, and final, account aging process would increase Cash by $38.40 and leave an Accounts Receivable balance of $153.60.

The present invention in some preferred embodiments solves the problematic aspects of account aging by dynamically creating a mathematical representation that extends the explicit specification of model periods by transparently adding “intra-period aging” to represent the correct application of the account aging process within a specified model period that has a length greater than that corresponding to a single aging period.

One benefit of the present invention methodology is that it accurately determines financial account balances, especially balances for Cash accounts, for models incorporating multiple periods where the length of each period varies as per the example above. When analyzing investment options, a commonly used metric is “Net Present Value” or “NPV.” The computation of NPV relies on accurate analysis of financial accounts, especially Cash accounts. Without the use of the present invention, it is not possible to accurately calculate NPV analyses. Furthermore, the present invention is required for analyzes that not only correctly calculate NPV, but that determine the investment strategy that optimizes NPV.

### Account Aging Pseudocode (4100, 4200, 4300)

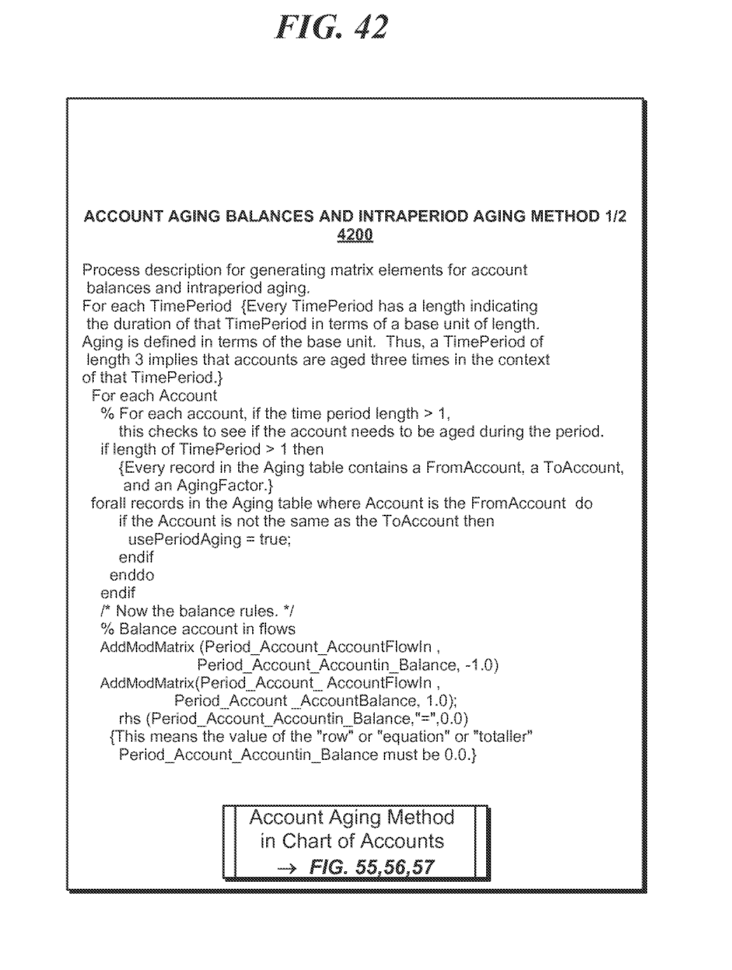

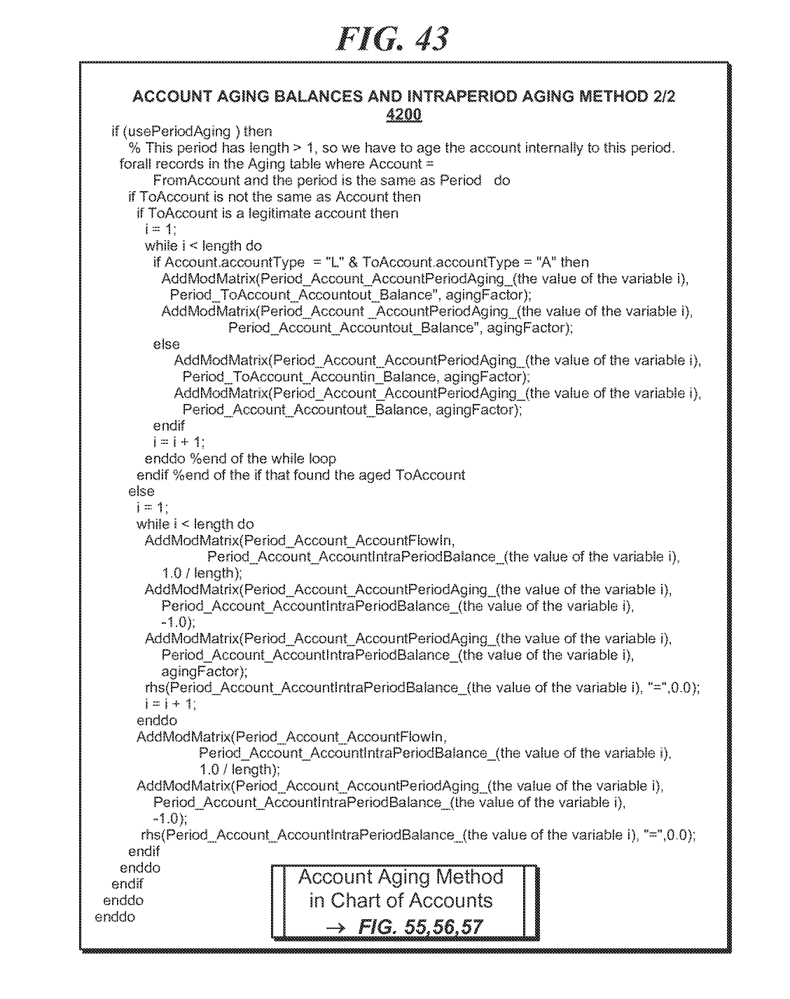

The present invention permits account aging operations to be performed within the enterprise model environment. As generally illustrated by the pseudocode of FIG. 41 (4100), FIG. 42 (4200), and FIG. 43 (4300), these operations coordinate with creation of matrix entries to affect these desired operations.

### Account Aging Matrix Representations (5600, 5700, 5800, 5900, 6000)

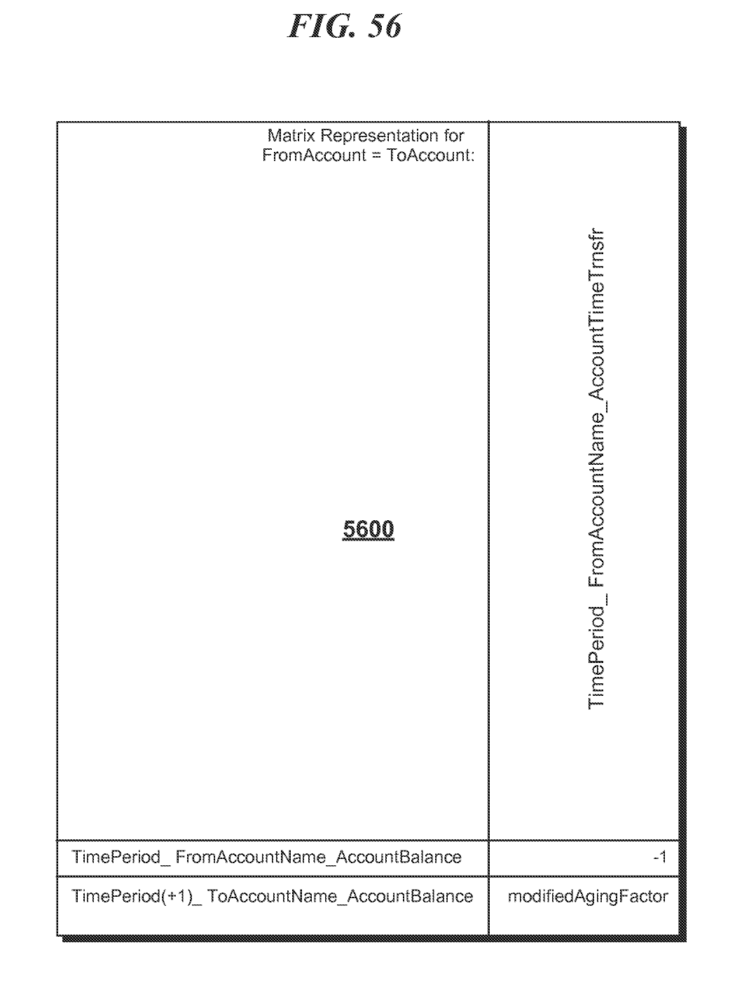

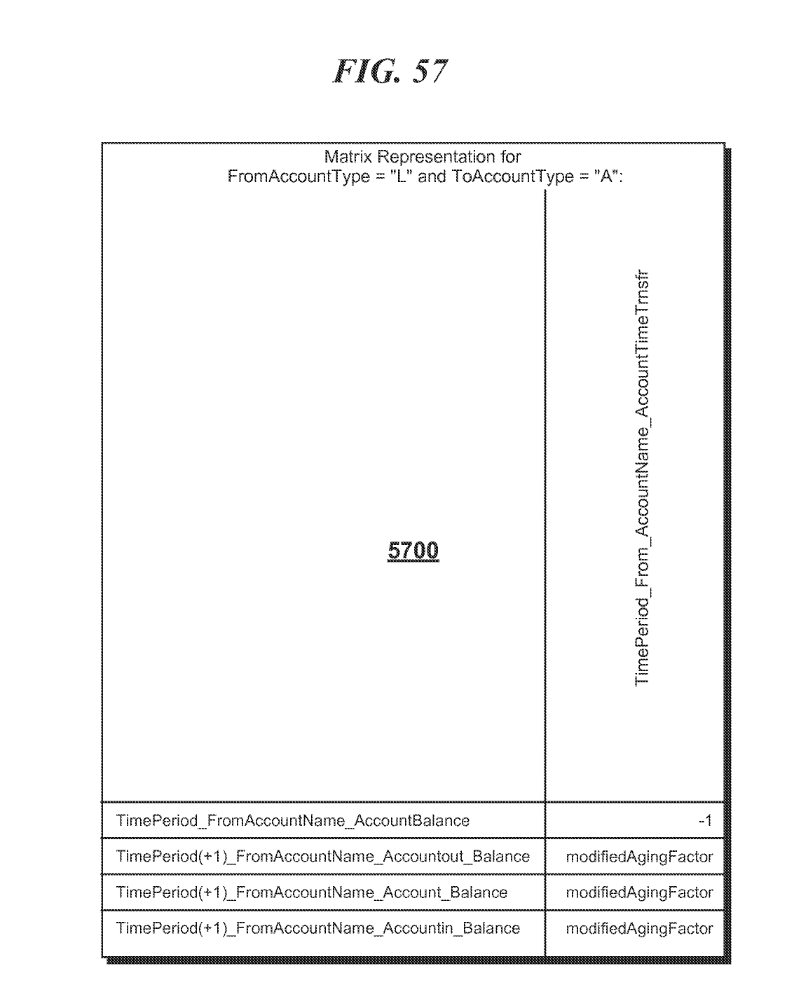

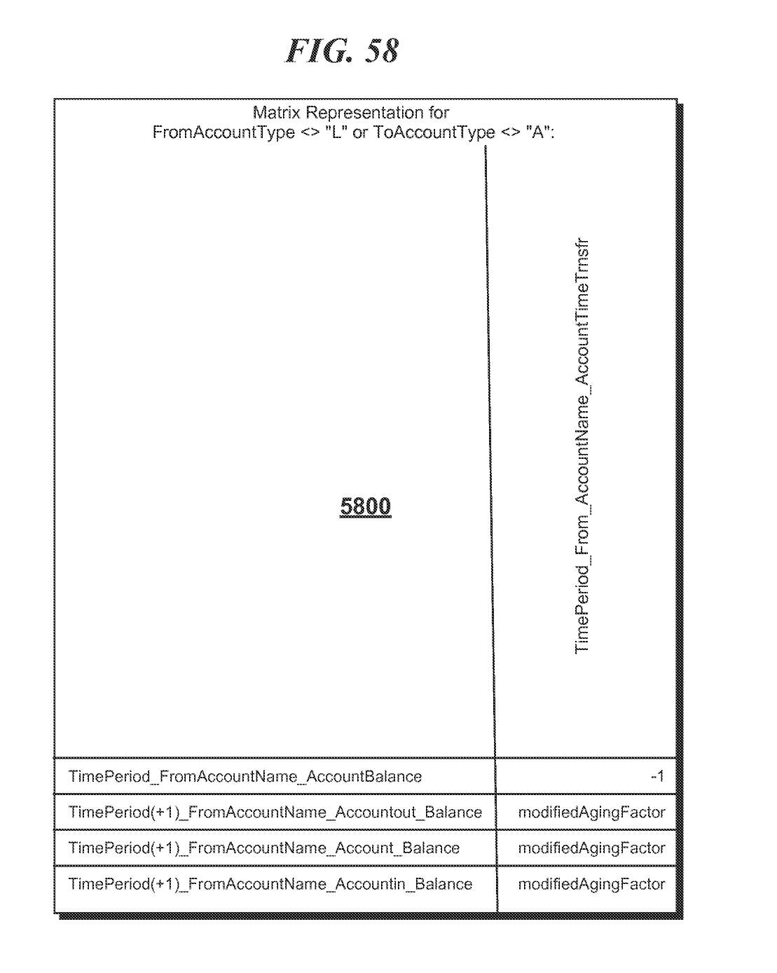

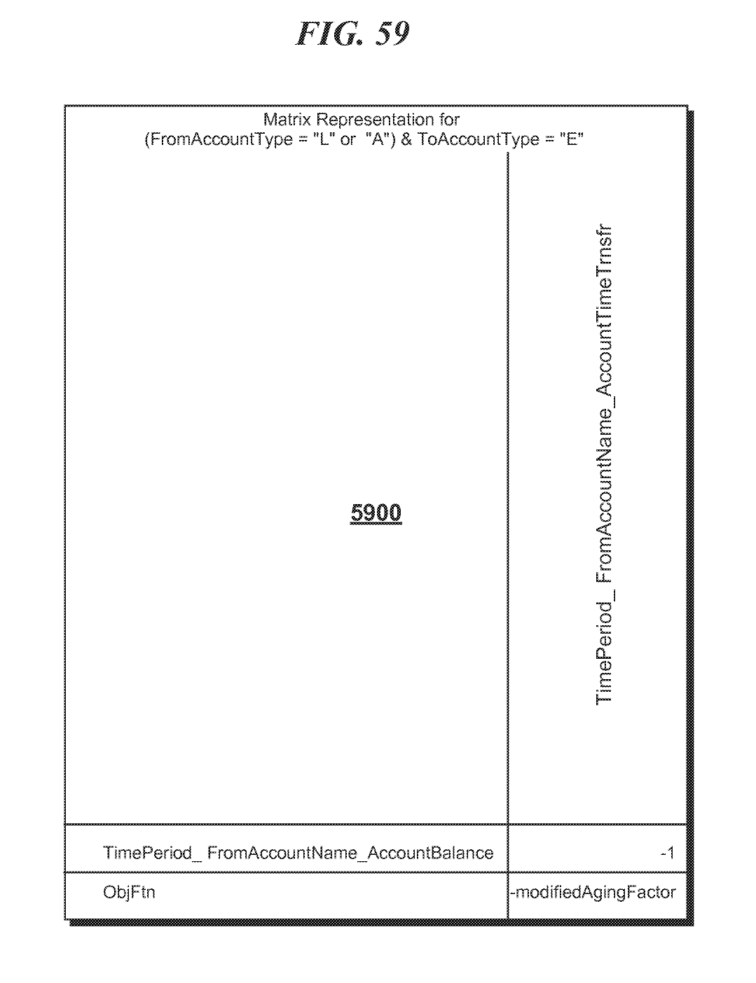

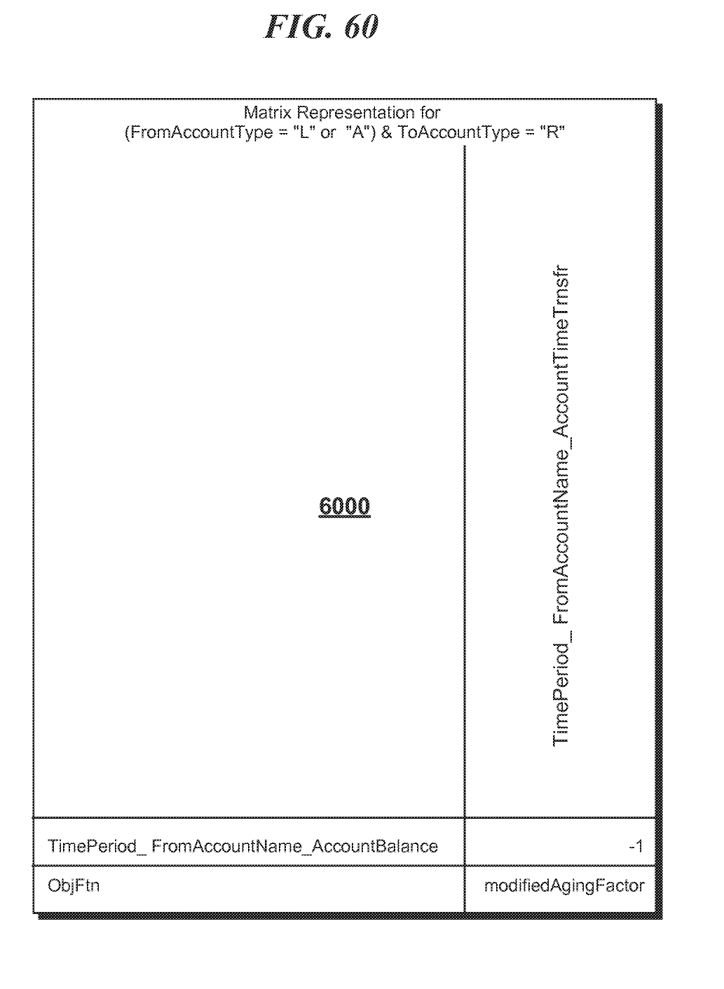

FIG. 56 (5600), FIG. 57 (5700), FIG. 58 (5800), FIG. 59 (5900), and FIG. 60 (6000) depict matrix representations corresponding to the structures created by these methods.

### Account Aging Matrix Intra-Period Analysis Points

Many exemplary embodiments of the present invention may utilize a plethora of intra-period item analysis points to affect fixed and/or variable time period analyses. Within this context, the present invention may integrate matrix elements within the equation matrix in order to evaluate the intra-period item values for a chart of accounts (COA) analysis.

### COA Summary Equations (4400)

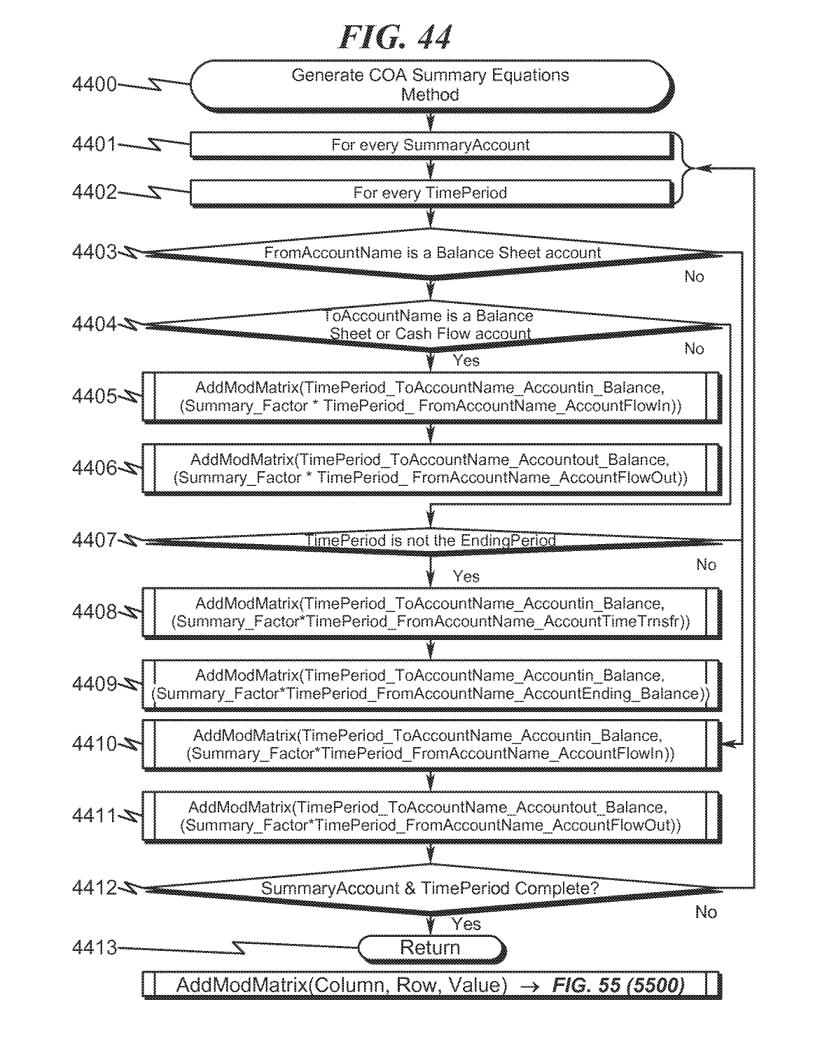

The present invention permits COA summary analysis to be performed within the enterprise model environment. An exemplary methodology by which this is accomplished is illustrated by the flowchart provided in FIG. 44 (4400).

### Ratio Constraint Overview

Ratio constraints are required to accurately analyze and optimize enterprise system/processes. This presents a challenge due to the nature of optimization algorithms which lack the ability to represent ratios using conventional mathematics. Furthermore, real-world ratio constraints are of two distinct forms—Hard Ratio Constraints and Soft Ratio Constraints. A Hard Ratio Constraint defines a relationship between two variables that cannot be violated. The value of the ratio of the variables must be equal to, or greater than, a specified minimum value and equal to, or less than, a maximum value. A Soft Ratio Constraint defines a relationship between two variables such that if the constraint is violated, a penalty is incurred. Thus, the value of the ratio may be less than the specified minimum, or greater than the specified maximum, on the condition that either case causes a penalty to be incurred.

Hard and Soft Ratio Constraints can be combined. The specified minimum value of a ratio may be either a Hard Constraint or a Soft Constraint while at the same time the specified maximum value may similarly be either a Hard Constraint or a Soft Constraint. Thus, a “Hard/Soft” ratio constraint means the specified minimum value is a hard constraint that must be met and the specified maximum value is a soft constraint that can be violated with a penalty of cost. A “Soft/Hard” ratio constraint means the specified minimum value is a soft constraint that can be violated with a penalty cost and the specified maximum value is a hard constraint that must be met.

### Ratio Constraint Methods (4500, 4600, 4700, 4800, 4900, 5000)

The present invention may incorporate a number of ratio constraint equation generation methods within the framework of the overall enterprise modeling system. These ratio constraint equation generation methods are utilized to implement a variety of “hard” and/or “soft” constraints within the modeling process and may be effectively used to perform a wide variety of “what if” analyses within the enterprise modeling framework.

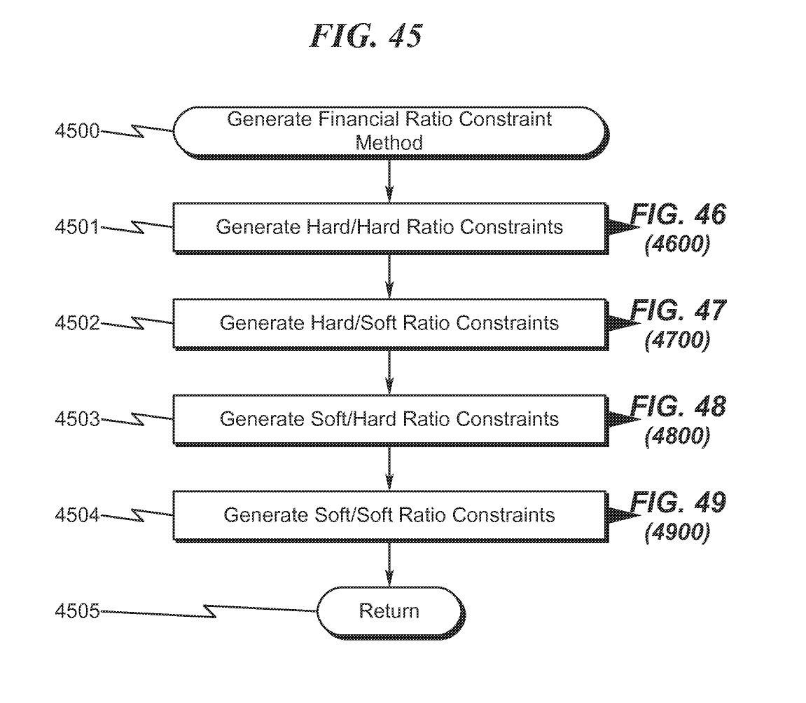

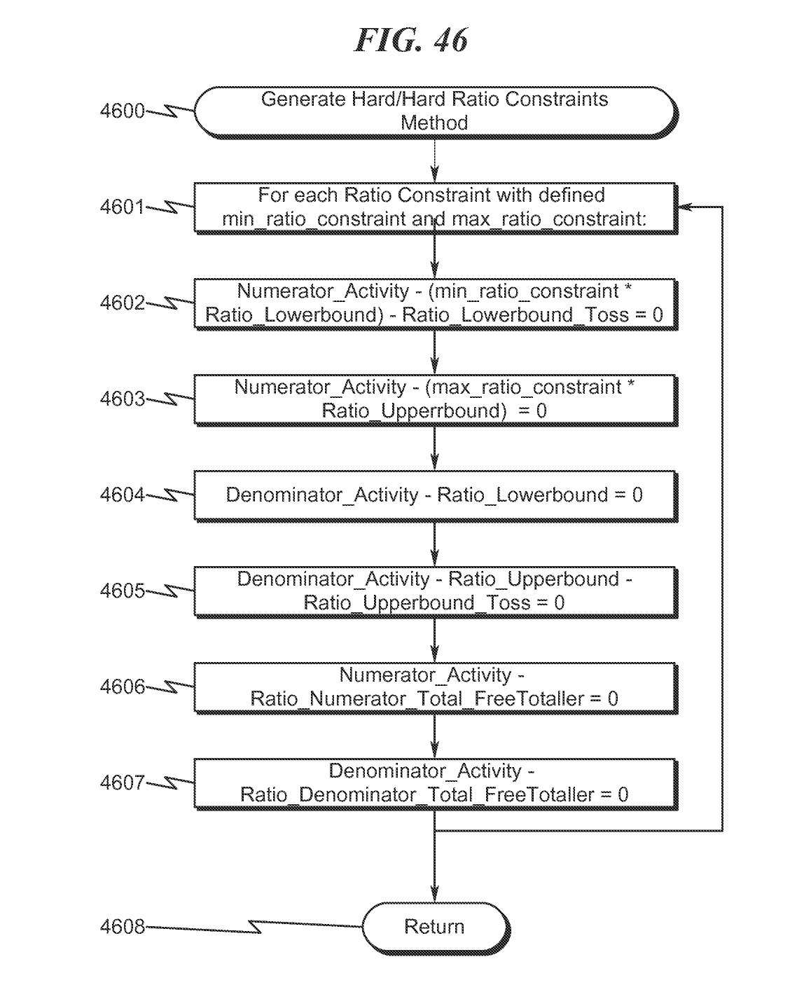

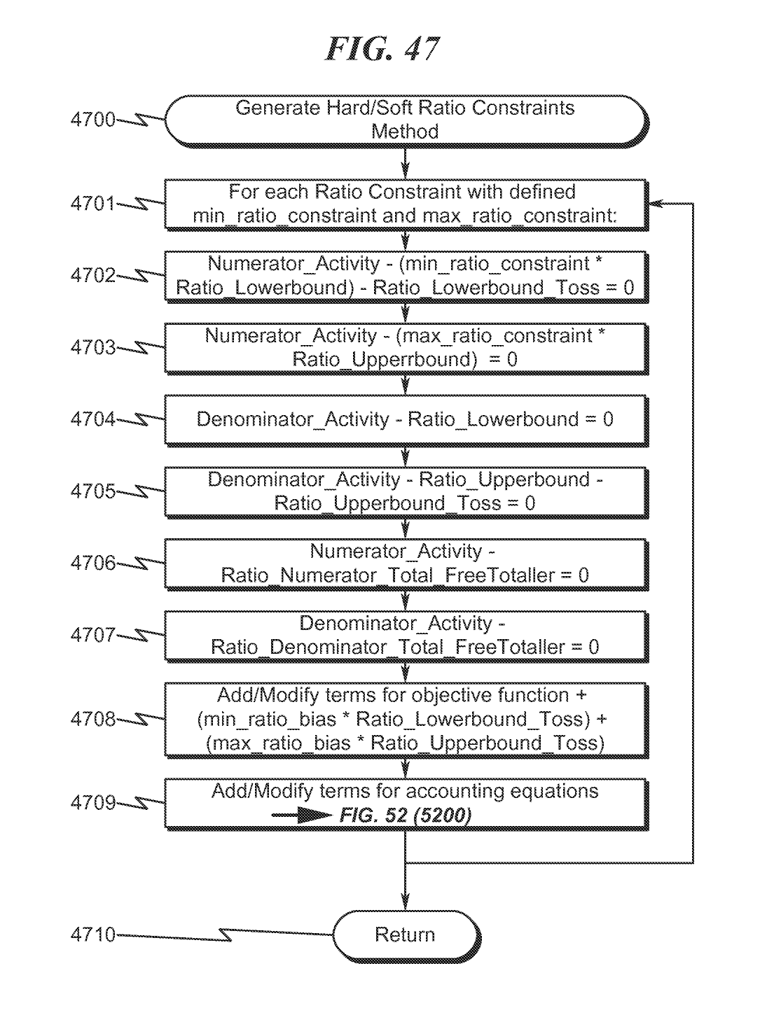

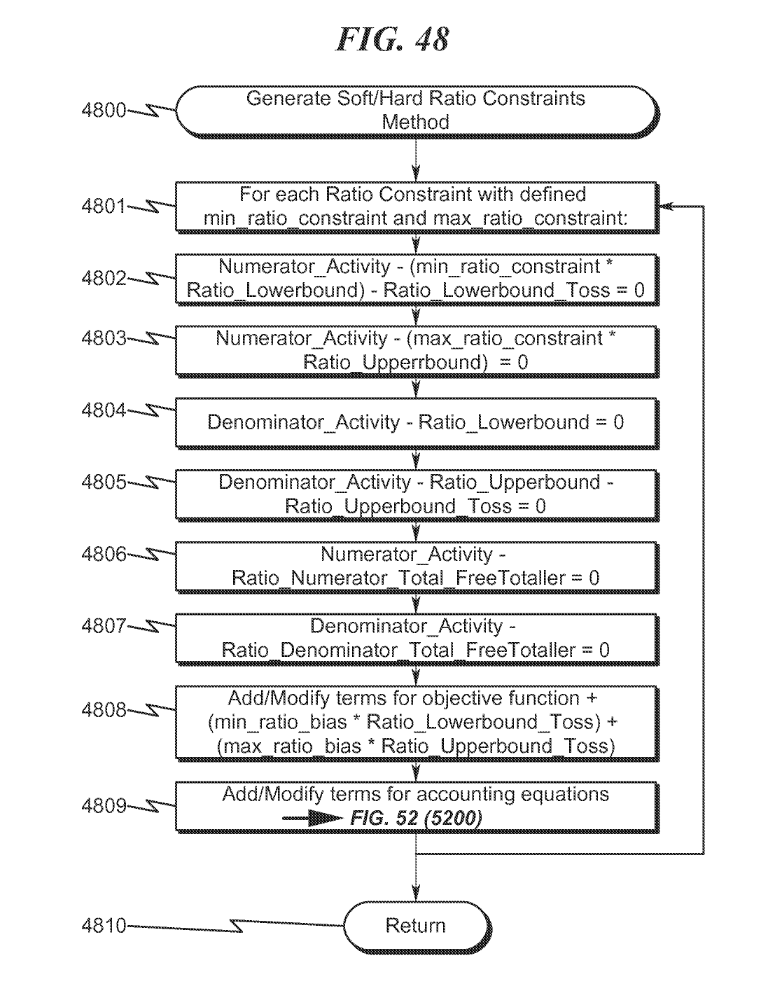

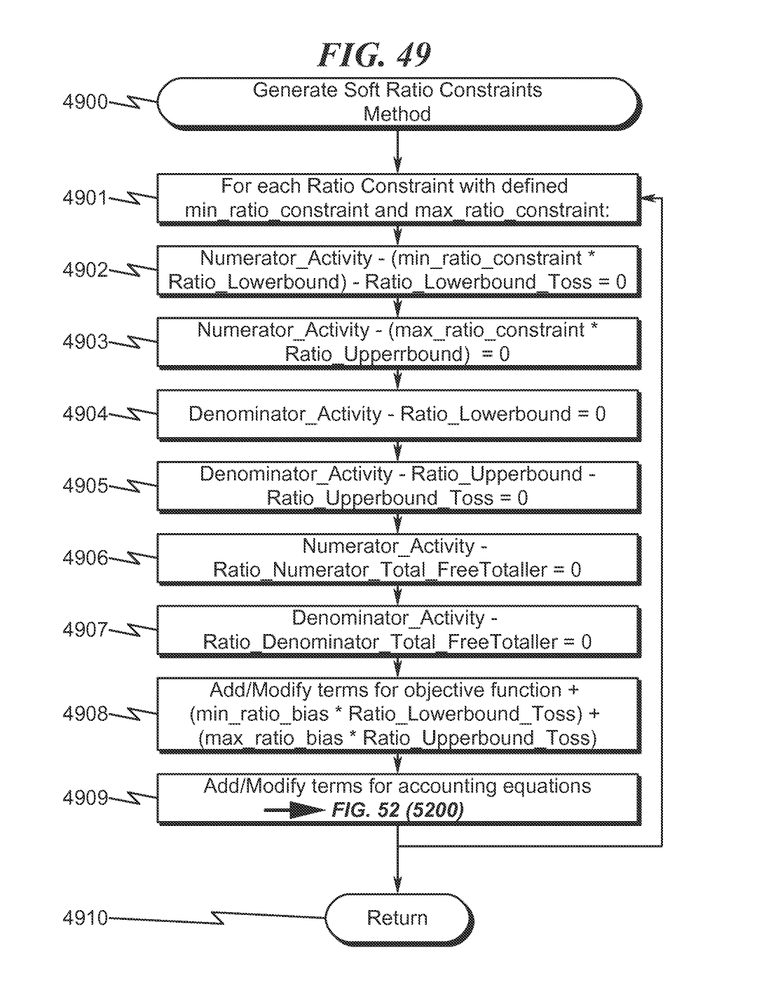

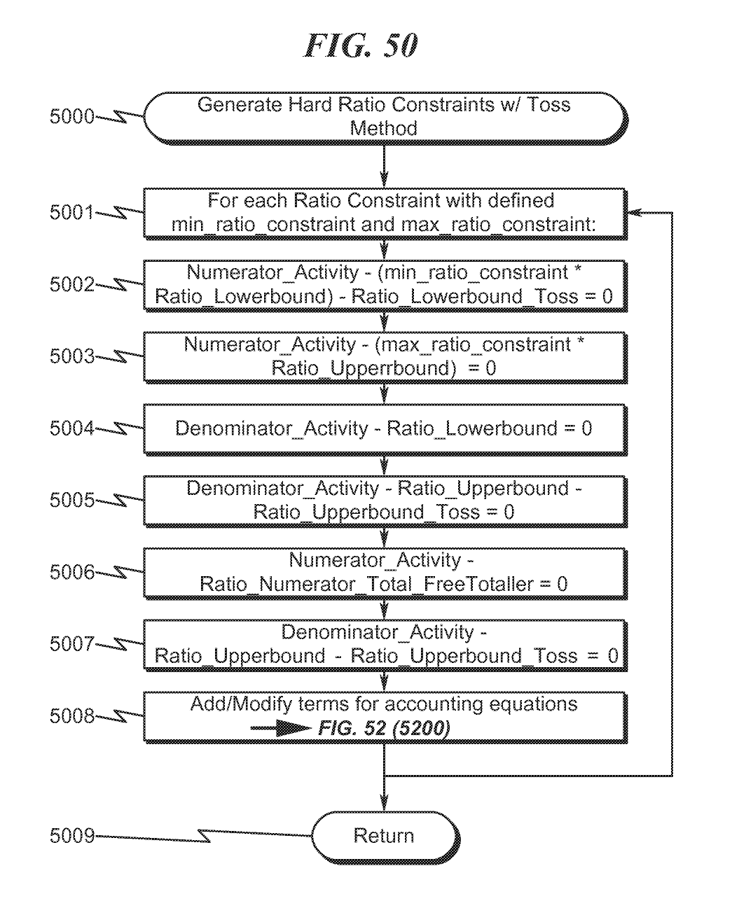

As generally illustrated in FIG. 45 (4500), FIG. 46 (4600), FIG. 47 (4700), FIG. 48 (4800), FIG. 49 (4900), FIG. 50 (5000), a preferred exemplary implementation of several ratio constraint methods are depicted as flowcharts, wherein the method comprises the following steps:
(1) Entering or defining a minimum/maximum ratio constraint;
(2) Entering or defining hard/soft ratio constraint attributes;
(3) Evaluating numerator and denominator activity;
(4) Generating matrix equations that satisfy the minimum/maximum ratio constraints in conjunction with the hard/soft ratio constraint attributes; and
(5) Terminating the method.
   One skilled in the art will recognize that these method steps may be augmented or rearranged without limiting the teachings of the present invention.

### Summary Account Methods (5100)

The present invention may incorporate a number of summary account equation generation methods within the framework of the overall enterprise modeling system. These summary account equation generation methods are utilized to define a variety of relationships between accounts, such as “totaller” accounts, within the modeling process and may be effectively used to perform a wide variety of “what if” analyses within the enterprise modeling framework. In addition, summary account equation generation methods are required to represent financial consolidation relationships required in enterprise modeling.

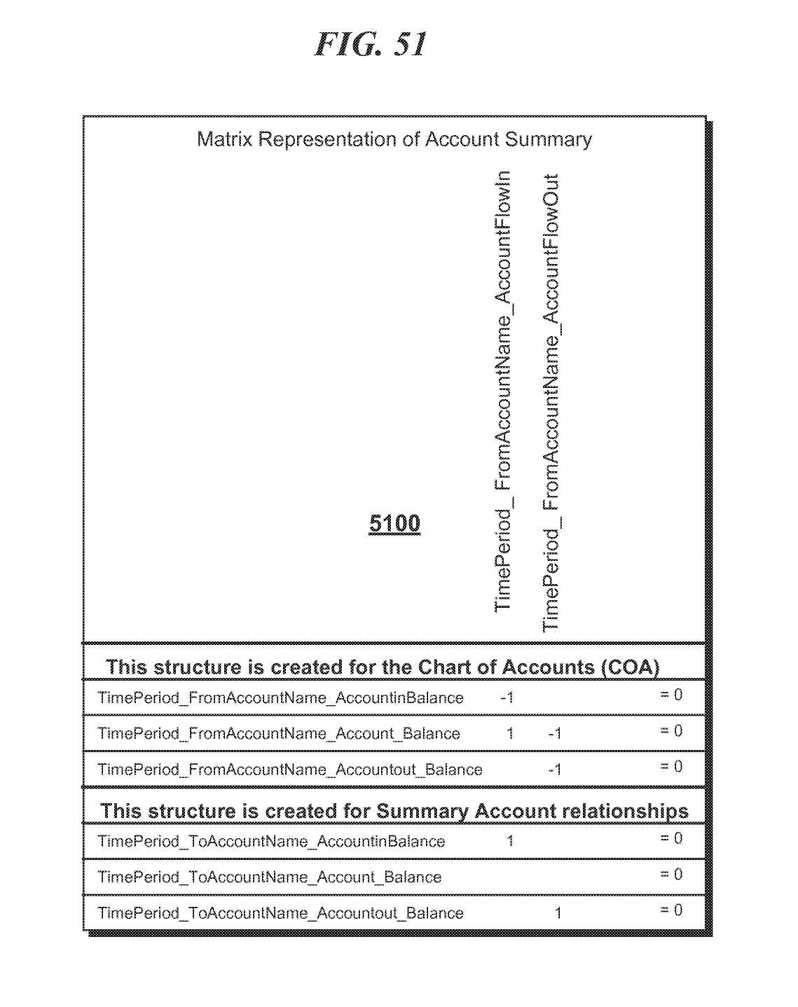

As generally illustrated in FIG. 51 (5100), a preferred exemplary implementation of summary account methods are depicted in the form of a matrix representation, wherein the method comprises the following steps:
1. Entering or defining a “from account” constraint;
2. Entering or defining a “to account” constraint;
3. Entering or defining a factor defining the relationship between the “from account” and the “to account”;
4. Generating matrix equations that link the input and output flows of the “from account” with the input and output flows of the “to account”; and
5. Terminating the method.
   One skilled in the art will recognize that these method steps may be augmented or rearranged without limiting the teachings of the present invention.

### Ratio Constraint Bias Penalties Overview

Within the context of some preferred embodiments of the present invention, the concept of ratio constraint bias penalties may be integrated with SOFT ratio constraint boundaries to permit the SOFT boundary to be violated but with the caveat that the corresponding objective function is “biased” or “penalized” for the SOFT boundary violation. While this biasing penalty may be implemented in a variety of ways, one preferred methodology is to apply a rule such that for each unit of activity that is added/subtracted from the ratio constraint that violates a SOFT boundary, a bias/penalty value is multiplied by this activity value and subtracted from an objective function which represents the desired outcome. This methodology permits overconstrained models to violate SOFT boundaries in search of a possible solution but with the incorporation of penalties that adjust for the real-world impact on these boundary violations.

### Ratio Constraint Bias Methods (5200)

The present invention may incorporate a number of ratio constraint bias methods within the framework of the overall enterprise modeling system. These ratio constraint equation generation methods are utilized to represent a variety of relationships within the context of “hard” and/or “soft” constraints within the modeling process and may be effectively used to perform a wide variety of “what if” analyses within the enterprise modeling framework. For example, ratio bias is required to represent the penalties associated with “soft” ratio constraints or to affect decision processes associated with “hard” ratio constraints such that the desired solution will be as close to the specified minimum or specified maximum constraint.

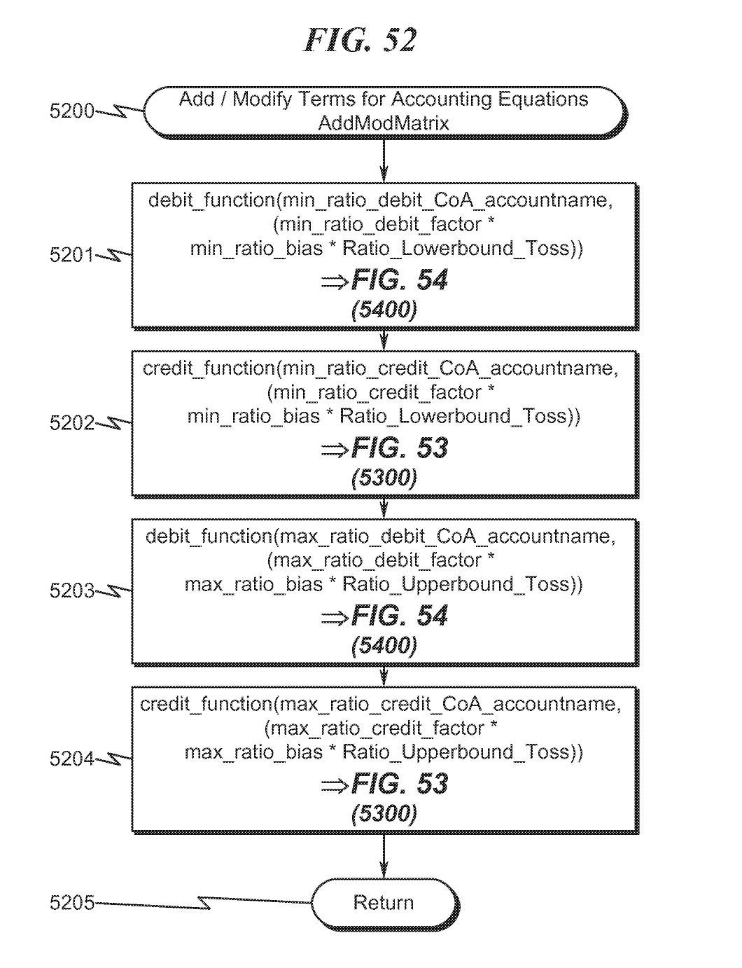

As generally illustrated in FIG. 52 (5200), a preferred exemplary implementation of ratio constraint bias methods are depicted as flowcharts, wherein the method comprises the following steps:
1. Entering or defining a debit for specified minimum ratio constraint (5201);
2. Entering or defining a credit for specified minimum ratio constraint (5202);
3. Entering or defining a debit for specified maximum ratio constraint (5203);
4. Entering or defining a credit for specified maximum ratio constraint (5204); and
5. Terminating the method (5205).

One skilled in the art will recognize that these method steps may be augmented or rearranged without limiting the teachings of the present invention.

### Account Debit and Credit Methods (5300, 5400)

The present invention may incorporate equation generation methods corresponding to debit and credit accounting functions within the framework of the overall enterprise modeling system. Debit and credit equation generation methods are utilized to define a variety of relationships between accounts and activities, in particular, the affect a specified activity has on an account from a financial perspective. Debit and credit methods are required to properly represent the consequences of activities on an enterprise from a financial perspective and they are necessary in order to perform a wide variety of “what if” analyses within the enterprise modeling framework. In addition, debit and credit equation generation methods are required to represent financial consolidation relationships required in enterprise modeling.

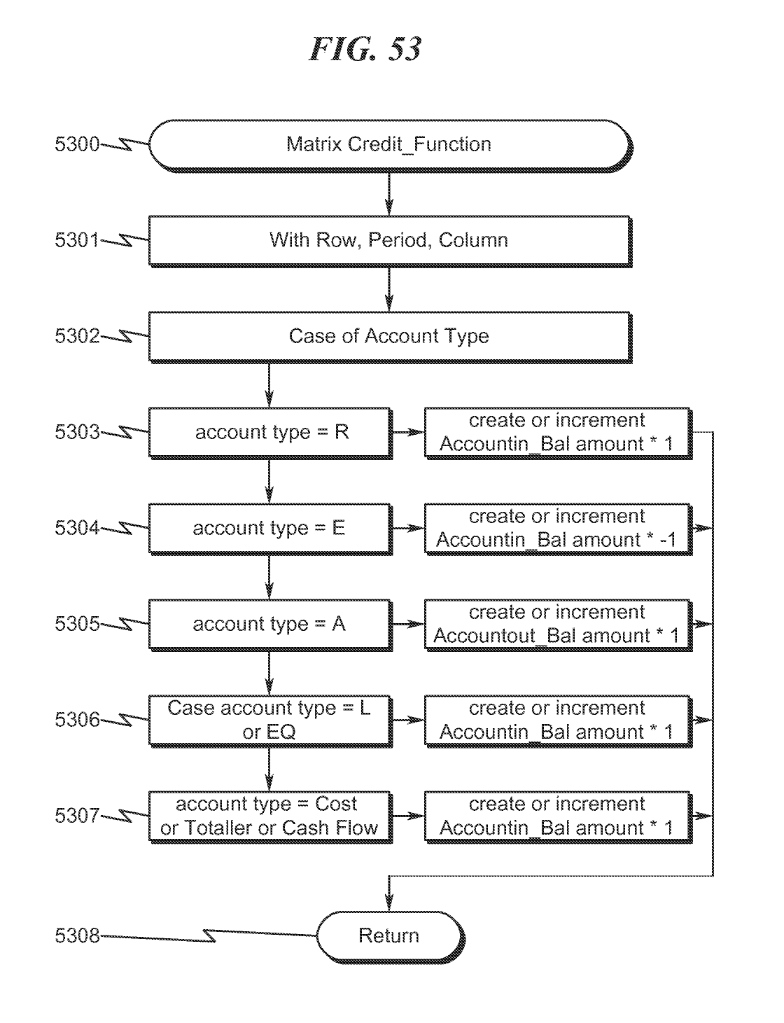

As generally illustrated in FIG. 53 (5300), a preferred exemplary implementation of credit equation generation methods are depicted in the form of a flowchart, wherein the method comprises the following steps:
1. Entering or defining an equation element in terms of “row,” “period,” and “column” (5301);
2. Entering or defining an “account type” (5302);
3. If the account type corresponds to a revenue account (“R”), then modify, or create, the equation element defined for the “accountIn” row and the specified column by adding the credit factor to the term (5303);
4. If the account type corresponds to an expense account (“E”), then modify, or create, the equation element defined for the “accountIn” row and the specified column by subtracting the credit factor from the term (5304);
5. If the account type corresponds to an asset account (“A”), then modify, or create, the equation element defined for the “accountOut” row and the specified column by adding the credit factor to the term (5305);
6. If the account type corresponds to a liability account (“L”) or an equity account (“EQ”), then modify, or create, the equation element defined for the “accountIn” row and the specified column by adding the credit factor to the term (5306);
7. If the account type corresponds to a “Cost,” “Totaller,” or “Cash Flow” account, then modify, or create, the equation element defined for the “accountIn” row and the specified column by adding the credit factor to the term (5307); and
8. Terminating the method (5308).

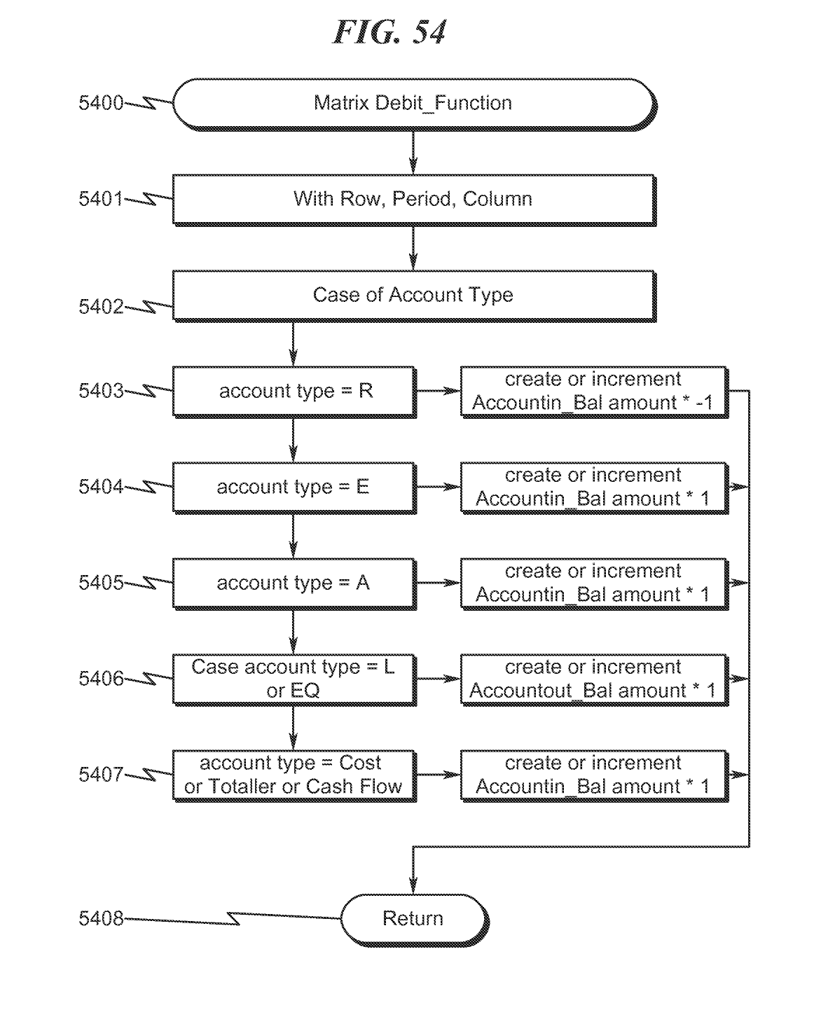

As generally illustrated in FIG. 54 (5400), a preferred exemplary implementation of debit equation generation methods are depicted in the form of a flowchart, wherein the method comprises the following steps:
1. Entering or defining an equation element in terms of “row,” “period,” and “column” (5401);
2. Entering or defining an “account type” (5402);
3. If the account type corresponds to a revenue account (“R”), then modify, or create, the equation element defined for the “accountIn” row and the specified column by subtracting the debit factor from the term (5403);
4. If the account type corresponds to an expense account (“E”), then modify, or create, the equation element defined for the “accountIn” row and the specified column by adding the debit factor to the term (5404);
5. If the account type corresponds to an asset account (“A”), then modify, or create, the equation element defined for the “accountIn” row and the specified column by adding the debit factor to the term (5405);
6. If the account type corresponds to a liability account (“L”) or an equity account (“EQ”), then modify, or create, the equation element defined for the “accountOut” row and the specified column by adding the debit factor to the term (5406);
7. If the account type corresponds to a “Cost,” “Totaller,” or “Cash Flow” account, then modify, or create, the equation element defined for the “accountIn” row and the specified column by adding the debit factor to the term (5407); and
8. Terminating the method (5408).
   One skilled in the art will recognize that these method steps may be augmented or rearranged without limiting the teachings of the present invention.

### Add/Modify Term in a Matrix of Equations Methods (5500)

The present invention may incorporate methods for creating a system, or set, of simultaneous equations, also referred to as a “Matrix,” within the framework of the overall enterprise modeling system. These methods allow the Matrix to be specified incrementally in a manner that can result in significant reductions in computational cost.

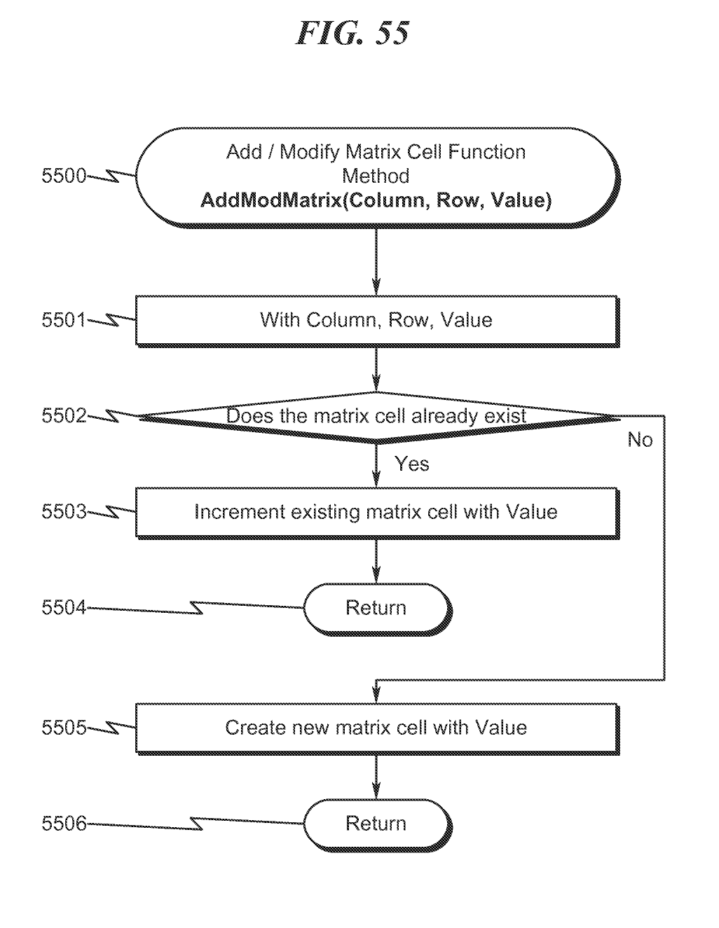

As generally illustrated in FIG. 55 (5500), a preferred exemplary implementation of add/modify term methods are depicted as flowcharts, wherein the method comprises the following steps:
1. Entering or defining the column, or variable, and the row, or equation, of the term to be added or modified as well as the value to be added/amount to modify the existing term by (5501);
2. Determining if the term already exists (5502);
3. If the term already exists, then add the value to the existing term (5503);
4. If the term does not already exist, create the term and set its initial value to the specified value (5504); and
5. Terminating the method (5505).

One skilled in the art will recognize that these method steps may be augmented or rearranged without limiting the teachings of the present invention.

### Matrix Loading Optimization Using Intermediate Format

The present invention in its various embodiments may make use of a variety of techniques to optimize the loading of the equation matrix for solution by one or more solvers.

Within this context the use of an intermediate format comprising tuples or another data structure format may be used to significantly decrease the computational complexity required to create the equation matrix for solution. This matrix loading procedure optimization may make a significant difference in the overall performance and responsiveness of the enterprise system/process modeling system/method. Some discussion of this methodology and contrast to the prior art is in order and follows.

### Prior Art Matrix Loading Data Flow (6100)

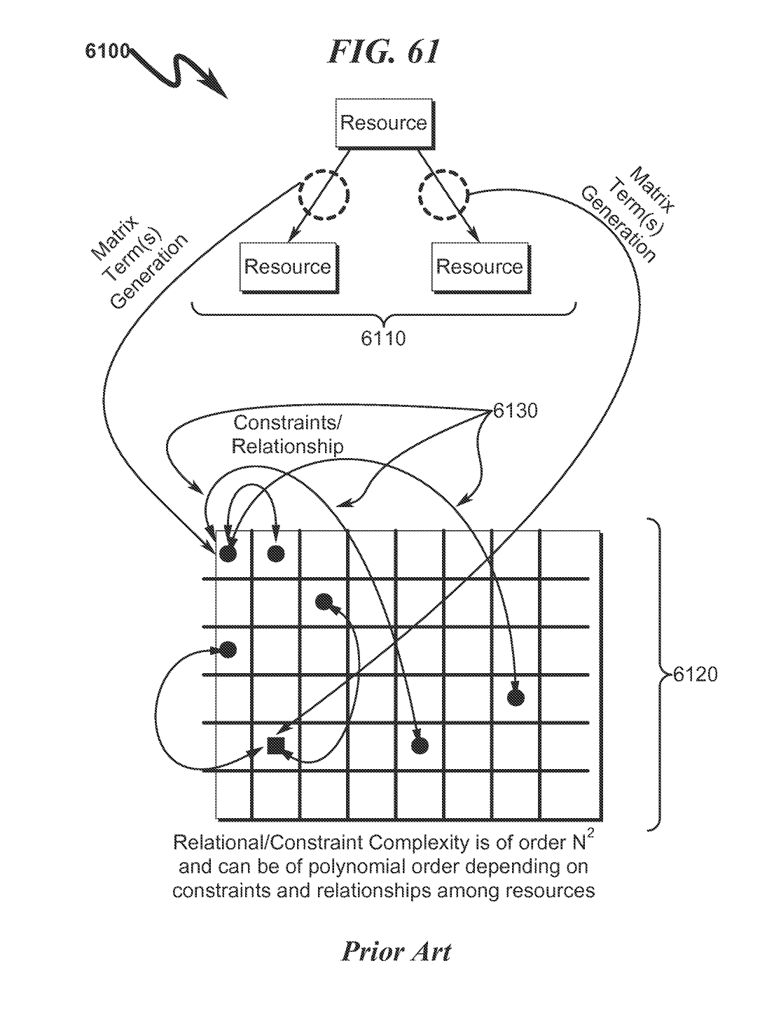

FIG. 61 (6100) illustrates the general flow of matrix loading as taught by the prior art. In this example a number of resources and relationships are defined (6110) and then individually used to load elements within the matrix (6120) rows and columns. Individual relationships (6130) between the equation terms are accounted for by making comparisons between various matrix equation terms to see if the inter-relationships should be accounted for either by additional equations or modification of terms within each equation.

### Prior Art Matrix Loading Method Flowchart (6200)

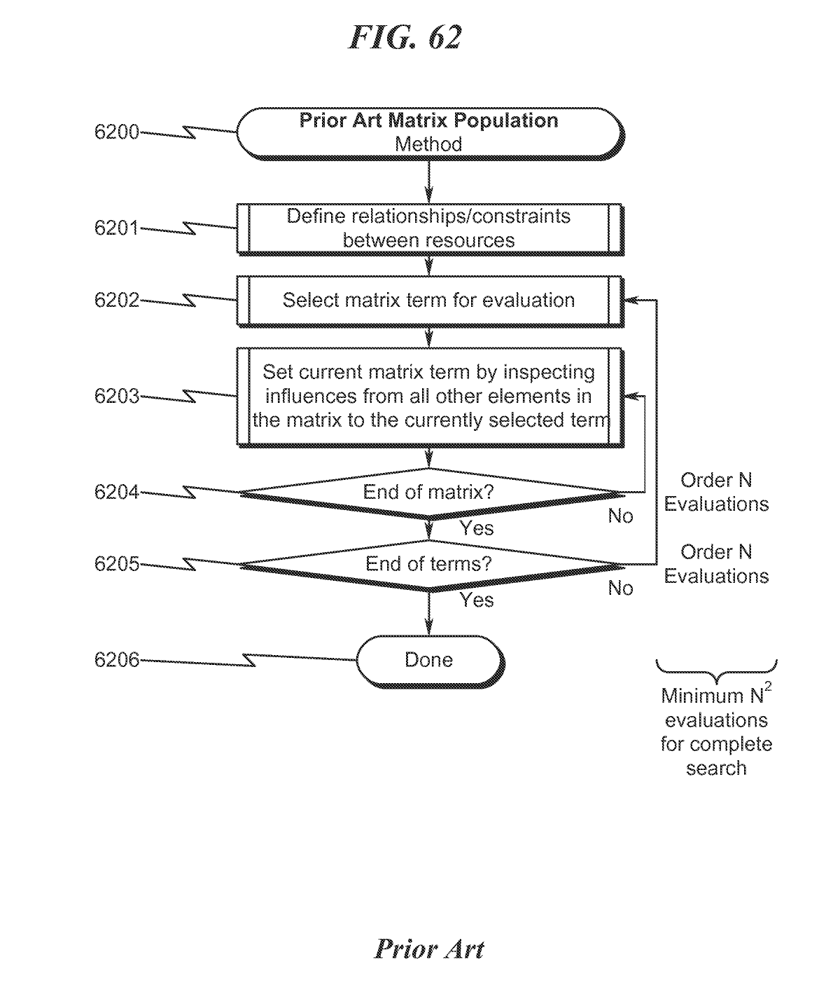

The prior art method generally associated with the data flow of FIG. 61 (6100) is generally illustrated in FIG. 62 (6200), wherein the key performance bottleneck is depicted in the order N-squared complexity of most relationship interactions as generally illustrated in step 4 (6204) and step 5 (6205). Here it can be seen that in even the simplest of cases a robust relationship evaluation within the matrix requires that each matrix term be related to all other matrix term elements, yielding an N-squared complexity problem for solution. Given that the matrices in most large enterprise system models are of large order, this N-squared computational complexity factor makes complete evaluation of inter-matrix relationships computationally intractable. This computational complexity constraint generally forces prior art enterprise modeling systems to limit the scope of inter-matrix relationship evaluations.

### Present Invention Exemplary Embodiment Matrix Loading Data Flow (6300)

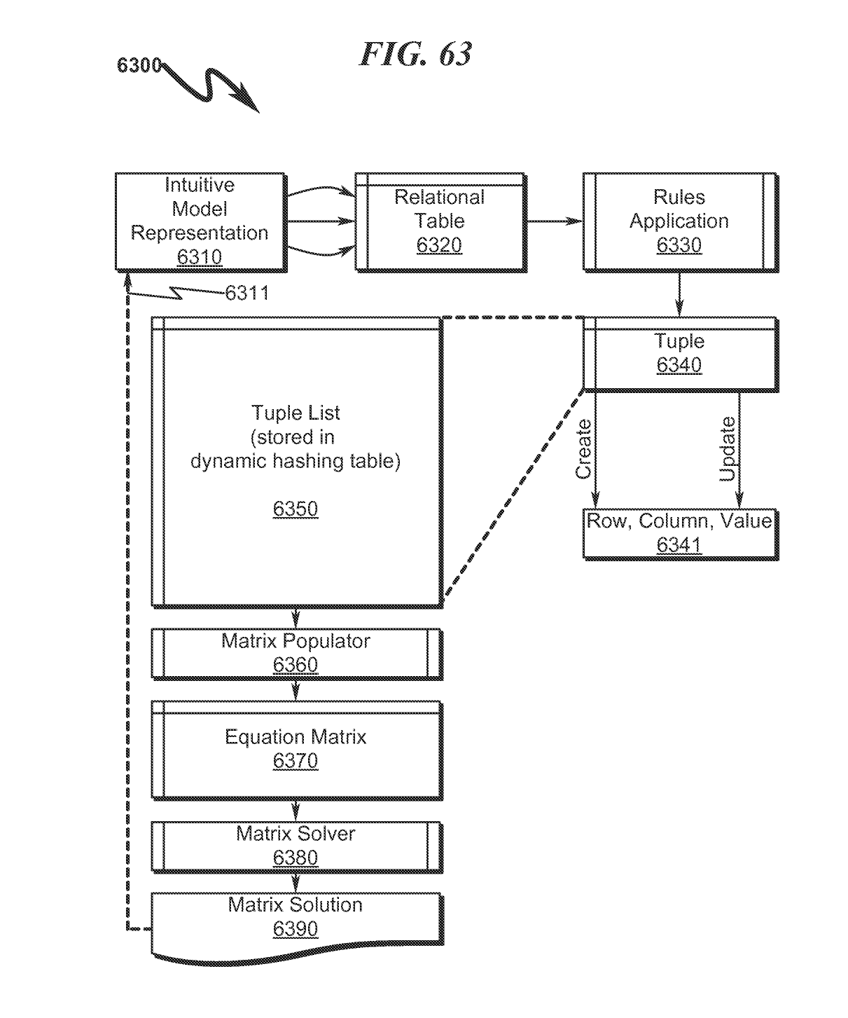

The present invention may in some preferred embodiments utilize a matrix loading data flow as depicted generally in FIG. 63 (6300), wherein the intuitive model representation (6310) (typically obtained via a GUI interface on a computer system running appropriate method-enabling software) creates a relational table (6320) describing the enterprise model. This relational table (6320) is then traversed with a rules application process (6330) that creates tuples (6340) describing the location and value within the equation matrix that should be created/modified/updated. These tuples (6340) typically comprise a (row, column, value) (6341) set and are placed in a tuple list (6350) optimally stored in a dynamic hashing table. The tuple list (6350) is processed by a matrix populator (6360) that takes the tuple sets (6341) and places them into a matrix (6370) that is then evaluated by a matrix solver (6380) to produce a matrix solution (6390) which is a solution for the enterprise model described by the intuitive model representation (6310) previously captured. Feedback from the matrix solution (6390) may be optionally fed back (6311) to the enterprise model described by the intuitive model representation (6310).

### Present Invention Exemplary Embodiment Matrix Loading Method (6400)

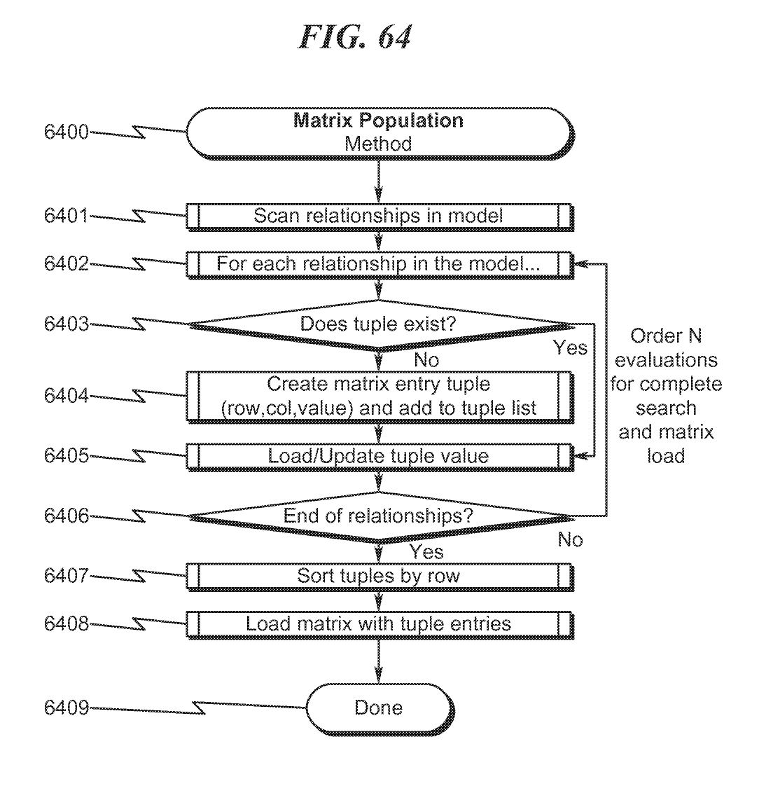

The present invention may incorporate in some preferred embodiments a method generally associated with the data flow of FIG. 63 (6300) as generally illustrated in FIG. 64 (6400), wherein the method comprises the following steps:
(1) Scanning the relationships in the enterprise model (6401);
(2) For each relationship in the enterprise model, executing steps (3) through (6) (6402);
(3) If a tuple for the matrix entry affected by the relationship exists, proceeding to step (5) (6403);
(4) Creating a matrix entry tuple (row, column, value) and adding it to a tuple list (typically stored using a dynamic hash table function) (6404);
(5) Loading/updating the tuple value in the current tuple entry (6405);
(6) Determining if all relationships have been processed, and if not, proceeding to step (2) (6406);
(7) Sorting the tuple list by matrix row (6407);
(8) Loading the matrix with the tuple entries (6408);
(9) Terminating the matrix population method (6409).
   One skilled in the art will recognize that these method steps may be augmented or rearranged without limiting the teachings of the present invention.

### System Summary

### General Scope

The present invention system anticipates a wide variety of variations in the basic theme of construction, but can be generalized as an enterprise system/process modeling system comprising:
(a) enterprise model definition subsystem;
(b) enterprise model processing subsystem; and
(c) enterprise model reporting subsystem;
wherein
the enterprise system/process model definition subsystem allows an operator to specify a set of interacting processes, resources, constraints, and objectives to describe an enterprise system/process in terms of an enterprise system/process model;
the enterprise system/process model defines processes, resources, constraints, and objectives to describe the enterprise system/process to be analyzed and the various boundaries within which the analysis is to take place;
the enterprise system/process model is transformed into an intermediate format by a translation subsystem for use in generating one or more mathematical representations of the enterprise system/process model;
the one or more mathematical representations are solved and/or analyzed by the enterprise model processing subsystem to produce a mathematical solution;
the mathematical solution is presented for review by the enterprise model reporting subsystem; and
the enterprise model definition subsystem, enterprise model processing subsystem, and enterprise model reporting subsystem operate within the context of one or more computer systems running software read from a computer readable medium.

This general system summary may be augmented by the various elements described herein to produce a wide variety of invention embodiments consistent with this overall design description.

### Knowledge Driven Modeling System

The above general invention scope may also incorporate a knowledge driven modeling component that integrates a knowledge base into the modeling process. The resulting system may be described as an enterprise system/process modeling system comprising:
(a) computer system operating under control of software retrieved from a computer readable medium;
(b) enterprise system/process diagram modeling interface incorporating a graphical user interface (GUI);
(c) enterprise system/process model database;
(d) translator engine; and
(e) knowledge database;

wherein
the GUI permits a model describing the enterprise system/process to be generated and stored in the model database;
the translator engine transforms the contents of the model database into a dynamic mathematical representation based on input from the knowledge database;
the dynamic mathematical representation is transformed into one or more mathematical representations;
the one or more mathematical representations are solved by a solver to produce an enterprise solution;
the enterprise solution is used to generate reports by a report generation subsystem; and
the enterprise system/process diagram modeling interface and the translator engine operate within the context of the computer system.

This general system summary may be augmented by the various elements described herein to produce a wide variety of invention embodiments consistent with this overall design description.

### Method Summary

### General Scope

The present invention method anticipates a wide variety of variations in the basic theme of implementation, but can be generalized as an enterprise system/process modeling method wherein the method comprises:
(1) Generating, defining, and/or modifying a enterprise system/process model that functionally describes the operation of the enterprise system/process;
(2) Integrating constraints within the model equation matrix to define relationships between resources contained within the enterprise system/model;
(3) Solving the enterprise model equation matrix to generate an optimal enterprise solution state space;
(4) Generating reports based on the optimal enterprise solution;
(5) Determining if user and/or enterprise optimization objectives have been met, and if not, proceeding to step (1); and
(6) Terminating the enterprise system/process modeling method.

This general method summary may be augmented by the various elements described herein to produce a wide variety of invention embodiments consistent with this overall design description.

### Rule-Based Enterprise Solution Generation

The present invention method may incorporate a rule-based enterprise solution generation process, which can be generalized as an enterprise system/process modeling method wherein the method comprises:
(1) evaluating a data structure describing an enterprise model and identifying applicable rules to apply to the data structure;
(2) analyzing the data structure to fire substantially all possible rules;
(3) generating matrix equations based on the contents of the data structure;
(4) generating a numerical solution for the matrix equations; and
(5) generating a financial report of the numerical solution;
wherein
the method operates within the context of one or more computer systems running software read from a computer readable medium.

This general method summary may be augmented by the various elements described herein to produce a wide variety of invention embodiments consistent with this overall design description.

### COR Variant

The present invention may expand the above methodology to incorporate COR functionality, with this variant method generalized as an enterprise system/process Constraint Oriented Reasoning (COR) modeling method comprising:
(1) capturing an enterprise system/process domain expert knowledge database, the database containing information on the functionality and relationships within and across elements of the enterprise system/process domain;
(2) decomposing the captured knowledge within the domain expert knowledge database into primitive component elements, and associating properties with the primitive elements;
(3) performing a self-consistency check across the knowledge database and modifying the database as necessary to validate the knowledge database contents;
(4) determining if the capture of the domain expert knowledge database is complete, and if not, proceeding to the step (1);
(5) embedding the collected domain expert knowledge database into the enterprise system/process model primitives associated with a graphical user interface (GUI) enterprise system/process modeling subsystem;
(6) capturing an enterprise system/process model
(further comprising processes, resources, relationships, constraints, and/or objectives) via the GUI and evaluating solutions for the captured enterprise system/process model using one or more mathematical representations generated from the captured enterprise system/process model; and
(7) terminating the enterprise system/process constraint oriented reasoning method.

This general method summary may be augmented by the various elements described herein to produce a wide variety of invention embodiments consistent with this overall design description.

### Chart Of Accounts Alternate Embodiment

The present invention method may incorporate a Chart of Account (COA) analysis capability which can be generalized as an enterprise system/process modeling method wherein the method comprises:
(1) evaluating a data structure describing an enterprise model and identifying applicable chart of account rules to apply to the data structure;
(2) analyzing the data structure to fire substantially all possible rules;
(3) generating matrix equations based on the contents of the data structure;
(4) generating a numerical solution for the matrix equations; and
(5) generating a financial report of the numerical solution;
wherein
the matrix equations comprise at least three equations for each item in the chart of accounts (COA);
the at least three equations comprise flow input, current balance, and flow output equations;
the matrix equations are defined for one or more time periods for each of the chart of accounts (COA) items;
the method operates within the context of one or more computer systems running software read from a computer readable medium.

This general method summary may be augmented by the various elements described herein to produce a wide variety of invention embodiments consistent with this overall design description.

### Chart of Accounts Aging Alternate Embodiment

The present invention method may incorporate a Chart of Account (COA) analysis capability with aging which can be generalized as an enterprise system/process modeling method wherein the method comprises:
(1) defining a base period length;
(2) modifying a matrix with initial values for an item from a Chart of Accounts (COA);
(3) for each time period to be evaluated, determining intra-period points;
(4) for each account to be evaluated, calculating intermediate values for the item;
(5) modifying the matrix with the intermediate values for the item from the Chart of Accounts (COA);
(6) proceeding to step (5) for the each account to be evaluated;
(7) proceeding to step (3) for the each time period to be evaluated; and
(8) modifying the matrix with summary and totaler values for the item from the Chart of Accounts (COA).

This general method summary may be augmented by the various elements described herein to produce a wide variety of invention embodiments consistent with this overall design description.

### Ratio Constraint Analysis Alternate Embodiment

The present invention method may incorporate a ratio constraint analysis capability which can be generalized as an enterprise system/process modeling method wherein the method comprises:
(1) evaluating a data structure describing an enterprise model and identifying applicable ratio constraint rules to apply to the data structure;
(2) analyzing the data structure to fire substantially all possible rules;
(3) generating matrix equations based on the contents of the data structure;
(4) generating a numerical solution for the matrix equations; and
(5) generating a financial report of the numerical solution;

wherein

the ratio constraint rules comprise entering or defining a minimum/maximum ratio constraint;
the ratio constraint rules comprise entering or defining ratio constraint attributes;
the ratio constraint rules comprise evaluating numerator and denominator activity associated with the ratio constraint;
the ratio constraint rules comprise generating matrix equations that satisfy the minimum/maximum ratio constraints in conjunction with the ratio constraint attributes; and
the method operates within the context of one or more computer systems running software read from a computer readable medium.

This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and its associated method may be augmented with a variety of ancillary embodiments, including but not limited to:
An embodiment wherein the enterprise model processing subsystem generates a representation of the enterprise system/process model that integrates operational and financial information describing the enterprise system/process, the representation being translated into the intermediate format and then the intermediate format translated into one or more mathematical representations.
An embodiment wherein the enterprise model processing subsystem generates a representation of the enterprise system/process model that incorporates financial balance sheet information describing the enterprise system/process, the representation being translated into the intermediate format and then the intermediate format translated into one or more mathematical representations.
An embodiment wherein the enterprise model processing subsystem generates a representation of the enterprise system/process model that incorporates financial net income information describing the enterprise system/process, the representation being translated into the optimized format and then the intermediate format translated into one or more mathematical representations.
An embodiment wherein the enterprise model processing subsystem permits one or more mathematical representations to be optimally solved for both equation variables and equation coefficients associated with the enterprise system/process model.
An embodiment wherein the enterprise model processing subsystem optimizes the solution for the one or more mathematical representations to solve for the Opportunity Value associated with one or more equation variables and/or equation coefficients associated with the enterprise system/process model.
An embodiment wherein the constraints are assigned a property selected from a group consisting of OFF, HARD, HARD/SOFT, SOFT, and SOFT/HARD.
An embodiment wherein the description incorporates a FACTOR/ADD data structure to modify the characteristics of the constraints.
An embodiment wherein the description incorporates domain constraints, the domain constraints selected from a group consisting of Pooling Constraints, Ratio Constraints, Attributes, Attribute Relationships, Constraint Sets, Customized Variable Types, and Non-Linear Response Functions.
An embodiment wherein the one or more mathematical representations are solved using one or more solvers selected from a group consisting of LP, NLP, MIP, MILP (quadratic solver), simulation, network analysis, constraint propagation, and scenario analysis.
An embodiment wherein the enterprise model definition subsystem retrieves system/process modeling templates for the enterprise system/process model from a remote database over the Internet.
An embodiment wherein the enterprise model definition subsystem retrieves enterprise modeling templates for the enterprise system/process model from a remote database over the Internet.
An embodiment wherein the enterprise model definition subsystem retrieves model analysis templates for the enterprise system/process model from a remote database over the Internet.
An embodiment wherein the enterprise model reporting subsystem retrieves report generation templates for use in generating predefined reports from a remote database over the Internet.
An embodiment wherein the enterprise model processing subsystem maintains the optimal results for a base case, previous solution, and current solution.
An embodiment wherein analyzing the data structure comprises parsing the data structure.
An embodiment wherein analyzing the data structure comprises matching every sentential form within the data structure.
An embodiment wherein all the possible semantic rules are fired exactly one time.
An embodiment wherein the matrix equations produce summary totalers that are later included in the financial report.
An embodiment wherein the chart of accounts (COA) method further comprises generating an equation for the beginning value of the item.
An embodiment wherein the chart of accounts (COA) method further comprises generating an equation for the ending value of the item.
An embodiment wherein the chart of accounts (COA) method further comprises generating the at least three equations for each time period in which the item is to be solved.
An embodiment wherein the chart of accounts (COA) method further comprises generating an equation for the beginning value of the item, an equation for the ending value of the item, and the at least three equations for each time period in which the item is to be solved, the chart of accounts (COA) method and the at least three equations calculate summary and total values in models with multiple time periods.
An embodiment wherein the time period may be fixed or variable.
An embodiment wherein the model is over-constrained and wherein the ratio constraint comprises a SOFT ratio constraint attribute which generates a mathematical solution that assigns a penalty when the SOFT ratio constraint is violated.

One skilled in the art will recognize that other embodiments are possible based on combinations of elements taught within the above invention description.

### Generalized Computer Usable Medium

As generally illustrated in FIG. 1 (0100), the system embodiments of the present invention can incorporate a variety of computer readable media (0112) that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention.

An example of this computer readable medium as applied to the scope of the present invention includes but is not limited to a computer usable medium having computer-readable program code means comprising an enterprise system/process modeling method wherein the method controls an enterprise system/process modeling system comprising:
(a) enterprise model definition subsystem;
(b) enterprise model processing subsystem; and
(c) enterprise model reporting subsystem;
wherein
the enterprise system/process model definition subsystem allows an operator to specify a set of interacting processes, resources, constraints, and objectives to describe an enterprise system/process in terms of an enterprise system/process model;
the enterprise system/process model defines processes, resources, constraints, and objectives to describe the enterprise system/process to be analyzed and the various boundaries within which the analysis is to take place;
the enterprise system/process model is translated into an intermediate format by a translation subsystem for use in generating one or more mathematical representations of the enterprise system/process model;
the one or more mathematical representations are solved and/or analyzed by the enterprise model processing subsystem to produce a mathematical solution;
the mathematical solution is presented for review by the enterprise model reporting subsystem; and
the enterprise model definition subsystem, enterprise model processing subsystem, and enterprise model reporting subsystem operate within the context of one or more computer systems running software read from a computer readable medium;
with the method comprising the steps of:
(1) generating, defining, and/or modifying an enterprise system/process model that functionally describes the operation of the enterprise system/process;
(2) transforming an enterprise model into one or more mathematical representations to represent and define relationships between processes and resources contained within the enterprise system/model;
(3) solving the one or more mathematical representations to produce one or more mathematical representations;
(4) generating reports based on the solutions; and
(5) determining if user and/or enterprise optimization objectives have been met, and if not, proceeding to the step (1).
   One skilled in the art will recognize that these steps may be augmented or rearranged without limiting the teachings of the present invention.

### CONCLUSION

An enterprise system/process modeling (ESPO) system and method that permits efficient representation of enterprise systems/processes (ESP) and calculation of global solutions to models associated with these ESPs has been disclosed. The system/method incorporates an enterprise system/process modeling definition subsystem (ESPD) in which an interconnected processes, resources, constraints, and objectives may be defined to describe a global enterprise system/process model (ESPO). This ESPO describes the enterprise to be modeled and the various boundaries within which enterprise modeling is to take place. This ESPO is translated and transformed into an intermediate indexed format by an enterprise global modeling subsystem (EGMS) for use in generating the coefficients of an equation matrix. The equation matrix is solved for a solution state space conforming to desired enterprise objectives and the results are presented for review by an enterprise model reporting subsystem (FSPR).

1. An enterprise system/process modeling system comprising:
(a) enterprise model definition subsystem;
(b) enterprise model processing subsystem; and
(c) enterprise model reporting subsystem;
wherein
said enterprise system/process model definition subsystem allows an operator to specify a set of interacting processes, resources, constraints, and objectives to describe an enterprise system/process in terms of an enterprise system/process model;
said enterprise system/process model defines processes, resources, constraints, and objectives to describe said enterprise system/process to be analyzed and the various boundaries within which said analysis is to take place;
said enterprise system/process model is transformed into an intermediate format by a translation subsystem for use in generating one or more mathematical representations of said enterprise system/process model;
said one or more mathematical representations are solved and/or analyzed by said enterprise model processing subsystem to produce a mathematical solution;
said mathematical solution is presented for review by said enterprise model reporting subsystem; and
said enterprise model definition subsystem, enterprise model processing subsystem, and enterprise model reporting subsystem operate within the context of one or more computer systems running software read from a computer readable medium.

2. The enterprise system/process modeling system of claim 1 wherein said enterprise model processing subsystem generates a representation of said enterprise system/process model that integrates operational and financial information describing said enterprise system/process, said representation being transformed into said intermediate format and then said intermediate format translated into one or more mathematical representations.

3. The enterprise system/process modeling system of claim 1 wherein said enterprise model processing subsystem generates a representation of said enterprise system/process model that incorporates financial balance sheet information describing said enterprise system/process, said representation being transformed into said intermediate format and then said intermediate format translated into one or more mathematical representations.

4. The enterprise system/process modeling system of claim 1 wherein said enterprise model processing subsystem generates a representation of said enterprise system/process model that incorporates financial net income information describing said enterprise system/process, said representation being transformed into said intermediate format and then said intermediate format translated into one or more mathematical representations.

5. The enterprise system/process modeling system of claim 1 wherein said enterprise model processing subsystem permits one or more mathematical representations to be optimally solved for both equation variables and equation coefficients associated with said enterprise system/process model.

6. The enterprise system/process modeling system of claim 1 wherein said enterprise model processing subsystem optimizes the solution for said one or more mathematical representations to solve for the objective function associated with one or more equation variables associated with said enterprise system/process model.

7. The enterprise system/process modeling system of claim 1 wherein said constraints are assigned a property selected from a group consisting of OFF, HARD/HARD, HARD/SOFT, SOFT/HARD, and SOFT/SOFT.

8. The enterprise system/process modeling system of claim 1 wherein said description incorporates domain constraints, said domain constraints comprising Ratio Constraints.

9. The enterprise system/process modeling system of claim 1 wherein said enterprise model definition subsystem retrieves system/process modeling templates for said enterprise system/process model from a remote database over the Internet.

10. The enterprise system/process modeling system of claim 1 wherein said enterprise model definition subsystem retrieves enterprise modeling templates for said enterprise system/process model from a remote database over the Internet.

11. The enterprise system/process modeling system of claim 1 wherein said enterprise model definition subsystem retrieves model analysis templates for said enterprise system/process model from a remote database over the Internet.

12. The enterprise system/process modeling system of claim 1 wherein said enterprise model reporting subsystem retrieves report generation templates for use in generating predefined reports from a remote database over the Internet.

13. The enterprise system/process modeling system of claim 1 wherein said enterprise model processing subsystem maintains said mathematical solution for a base case, a previous solution, and a current solution.

14. The enterprise system/process modeling system of claim 1 said model is over-constrained and further comprises a SOFT ratio constraint attribute which generates a mathematical solution that assigns a penalty when said SOFT ratio constraint is violated.

15. An enterprise system/process modeling method comprising:
(1) evaluating a data structure describing an enterprise model and identifying applicable rules to apply to said data structure;
analyzing said data structure to fire substantially all possible rules;
(3) generating matrix equations based on the contents of said data structure;
(4) generating a numerical solution for said matrix equations; and
(5) generating a financial report of said numerical solution;
wherein
said method operates within the context of one or more computer systems running software read from a computer readable medium.

16. The enterprise system/process modeling method of claim 15 wherein said analyzing said data structure comprises parsing said data structure.

17. The enterprise system/process modeling method of claim 15 wherein said analyzing said data structure comprises matching every sentential form within said data structure.

18. The enterprise system/process modeling method of claim 15 wherein all said possible semantic rules are fired exactly one time.

19. The enterprise system/process modeling method of claim 15 wherein said matrix equations produce summary totalers that are later included in said financial report.

20. An enterprise system/process modeling method comprising:
(1) evaluating a data structure describing an enterprise model and identifying applicable chart of account rules to apply to said data structure;
(2) analyzing said data structure to fire substantially all possible rules;
(3) generating matrix equations based on the contents of said data structure;
(4) generating a numerical solution for said matrix equations; and
(5) generating a financial report of said numerical solution;
wherein
said matrix equations comprise at least three equations for each item in said chart of accounts (COA);
said at least three equations comprise flow input, current balance, and flow output equations;
said matrix equations are defined for one or more time periods for each of said chart of accounts (COA) items;
said method operates within the context of one or more computer systems running software read from a computer readable medium.

21. The enterprise system/process modeling method of claim 20 wherein said chart of accounts (COA) method further comprises generating an equation for the beginning value of said item.

22. The enterprise system/process modeling method of claim 20 wherein said chart of accounts (COA) method further comprises generating an equation for the ending value of said item.

23. The enterprise system/process modeling method of claim 20 wherein said chart of accounts (COA) method further comprises generating said at least three equations for each time period in which said item is to be solved.

24. The enterprise system/process modeling method of claim 20 wherein said chart of accounts (COA) method further comprises generating an equation for the beginning value of said item, an equation for the ending value of said item, and said at least three equations for each time period in which said item is to be solved, said chart of accounts (COA) method and said at least three equations calculate summary and total values in models with multiple time periods.

25. The enterprise system/process modeling method of claim 20 wherein said method further comprises an aging method comprising:
(1) defining a base period length;
(2) modifying a matrix with initial values for an item from a Chart of Accounts (COA);
(3) for each time period to be evaluated, determining intra-period points;
(4) for each account to be evaluated, calculating intermediate values for said item;
(5) modifying said matrix with said intermediate values for said item from said Chart of Accounts (COA);
(6) proceeding to said step (5) for said each account to be evaluated;
(7) proceeding to said step (3) for said each time period to be evaluated; and
(8) modifying said matrix with summary and totaler values for said item from said Chart of Accounts (COA).

26. The enterprise system/process modeling method of claim 25 wherein said time period may be fixed or variable.

27. An enterprise system/process modeling method comprising:
(1) evaluating a data structure describing an enterprise model and identifying applicable ratio constraint rates to apply to said data structure;
(2) analyzing said data structure to fire substantially all possible rules;
(3) generating matrix equations based on the contents of said data structure;
(4) generating a numerical solution for said matrix equations; and
(5) generating a financial report of said numerical solution;
wherein
said ratio constraint rules comprise entering or defining a minimum/maximum ratio constraint;
said ratio constraint rules comprise entering or defining ratio constraint attributes;
said ratio constraint rules comprise evaluating numerator and denominator activity associated with said ratio constraint;
said ratio constraint rules comprise generating matrix equations that satisfy said minimum/maximum ratio constraints in conjunction with said ratio constraint attributes; and
said method operates within the context of one or more computer systems running software read from a computer readable medium.

28. The enterprise system/process modeling method of claim 27 wherein said ratio constraint attributes are selected from a group consisting of HARD/HARD, HARD/SOFT, SOFT/HARD, and SOFT/SOFT.

29. The enterprise system/process modeling method of claim 27 wherein said ratio constraint is disabled.

30. The enterprise system/process modeling method of claim 27 wherein said model is over-constrained and wherein said ratio constraint comprises a SOFT ratio constraint attribute which generates a mathematical solution that assigns a penalty when said SOFT ratio constraint is violated.
